(19) United States
(12) Patent Application Publication
(10) Pub. No.: US 2023/0006976 A1
(43) Pub. Date: Jan. 5, 2023

(54) Systems and Method for Providing Security Against Deception and Abuse in Distributed and Tokenized Environments

(71) Applicant: Artema Labs, Inc, Los Angeles, CA (US)

(72) Inventors: Bjorn Markus Jakobsson, Portola Valley, CA (US); Stephen C. Gerber, Austin, TX (US); Andrew B. Solmssen, Santa Monica, CA (US); Sven Stefan Dufva, Stockholm (SE); Keir Finlow-Bates, Eura (FI); Guy Stewart, Olympia, WA (US)

(73) Assignee: Artema Labs, Inc, Los Angeles, CA (US)

(21) Appl. No.: 17/810,741

(22) Filed: Jul. 5, 2022

Related U.S. Application Data
(60) Provisional application No. 63/365,936, filed on Jun. 6, 2022.
(60) Provisional application No. 63/365,464, filed on May 27, 2022.
(60) Provisional application No. 63/362,511, filed on Apr. 5, 2022.
(60) Provisional application No. 63/218,342, filed on Jul. 4, 2021.

(51) Int. Cl. H04L 9/40; H04L 9/00

(52) U.S. Cl. CPC H04L 63/0428; H04L 9/50

(57) ABSTRACT

Systems and methods for providing security in distributed and tokenized environments in accordance with various embodiments of the invention are described. A method for bridging between blockchains, includes: bridging an entry from a first blockchain to a second blockchain, where the entry is associated with an event; determining a classification of the entry, where the classification is one of confirmed, delayed, and blocked; performing an action based on the classification of the entry; where the action includes at least one action selected from a group including: determining the classification is confirmed and recording (130) on the second blockchain the entry and removing the entry from several entries, determining the classification is blocked and removing the entry from the several entries, and determining the classification is delayed and keeping the entry for an additional time period.

### CROSS-REFERENCE TO RELATED APPLICATION

This application claims benefit of and priority under 35 U.S.C. 119(e) to U.S. Provisional Patent Application No. 63/365,936 entitled “Using Watchful Bridging for Blockchain Fraud Prevention” by Jakobsson et al., filed Jun. 6, 2022, U.S. Provisional Patent Application No. 63/365,464 entitled “Safeguarding Ownership Transfer Against Abuse” by Jakobsson, filed May 27, 2022, U.S. Provisional Patent Application No. 63/362,511 entitled “Methods for Resolving NFT Fraud and Theft” by Jakobsson et al., filed Apr. 5, 2022, and U.S. Provisional Patent Application No. 63/218,342 entitled “Security Against Deception and Abuse in Distributed and Tokenized Environments” by Jakobsson et al., filed Jul. 4, 2021, the disclosures of which are hereby incorporated by reference in their entirety for all purposes.

### BACKGROUND

In traditional settings, phishing and business email compromise pose risks to consumers and enterprises by impersonation. In a phishing attack, an organization, such as a financial institution, is impersonated, typically both in the context of an email message and in terms of an associated webpage. Whereas phishing defense is a long-tail problem, the absolute majority of attacks are impersonations of a very small number of brands, with the top-10 most targeted brands corresponding to a majority of the volume. This facilitates the development of defense mechanisms looking for indications that emails, webpages or domain names exhibit similarities to commonly phished brands.

In a business email compromise (BEC) attack, a message (e.g., an email) is sent to an intended victim, with the sender appearing as a trusted colleague of the recipient, and typically one associated with power in the victim's organization. Typically, the CEO of the organization is impersonated. Almost all impersonations are of a very small set of people. While these people are different from each organization that can be attacked, defense mechanisms that are configured specific to a given protected organization can be created, where these defenses detect senders that resemble one of the commonly impersonated people for the given organization.

For both phishing attacks and BEC attacks, there are also common keywords associated with attacks. For phishing, such keywords include terms and phrases such as “compromised”, “blocked”, “log in” and terms indicating urgency; for BEC attacks, common keywords include “at your desk”, “favor to ask”, “transfer” and “gift cards”. This, in combination with the identity-based scrutiny, helps detect such attacks.

It is known that most passwords that are stolen in phishing attacks never get used (due to the thefts becoming known and the passwords changed). Financial institutions are collaborating with each other, and with Internet security organizations, to block financial transfers and freeze accounts used for the collection of funds stolen in BEC attacks. Therefore, these attacks also have limited success in terms of the rate at which criminals manage to cash out based on a successful deception.

The trading of tokens, such as Fungible Tokens and Non-Fungible Tokens (NFT) is becoming increasingly common. An NFT may be used for assigning a digital representation of ownership for digital items, such as images, but also other physical items. The current holder of the NFT is typically provided asset usage rights for the underlying NFT asset. Different tokens may be associated with different values, wherein some tokens, e.g., some NFTs, may be associated with very high values and some tokens may be associated with more moderate value. There are many criminals trying to illegally gain ownership of different tokens, often by very sophisticated methods, which may be difficult for owners to identify.

### SUMMARY OF THE INVENTION

Systems and method for providing security against deception and abuse in distributed and tokenized environments in accordance with various embodiments of the invention are described. A method for bridging between blockchains in accordance with an embodiment of the invention includes: bridging at least one entry from several entries from a first blockchain to a second blockchain, where the at least one entry is associated with an event; determining a classification of the at least one entry, where the classification includes at least one of confirmed, delayed, and blocked; performing an action based on the classification of the entry; wherein the action includes at least one action selected from a group comprising: determining the classification is confirmed and recording (130) on the second blockchain the at least one entry and removing the at least one entry from the several entries, determining the classification is blocked and removing the at least one entry from the several entries, and determining the classification is delayed and keeping the at least one entry for an additional time period.

In a further embodiment, the method further includes determining the classification indicates that the at least one entry is blocked and setting a flag associated with the entry to a value representing that the at least one entry is blocked.

In a further embodiment still, the method further includes determining the classification indicates that the at least one entry is blocked and logging data related to a reason for determining the classification of the at least one entry is blocked.

In another embodiment, the method further includes determining the classification indicates that the at least one entry is delayed and transferring (150) the at least one entry to a third blockchain, the third blockchain being of a same level as the first blockchain.

In still another embodiment, the method further includes determining the classification indicates that the at least one entry is delayed and identifying the at least one entry and an entry that is to remain on the first blockchain and to be bridged to the second blockchain at a later point in time.

In still another embodiment, the determining of the classification is based information received from the second blockchain.

In still another embodiment, the method further includes determining the classification indicates that the at least one entry is confirmed after a predetermined amount of time has elapsed since the entry was recorded on the first blockchain.

In still another embodiment, the method further includes obtaining a vote between a plurality of entities regarding the classification of the at least one entry.

In still another embodiment, the second block chain has a different security protections that provide greater security than the first block chain.

In still another embodiment, the method further includes determining the classification is delayed and re-recording the at least one entry on the first block chain with a time stamp associated with an original time that the at least one entry was record on the first blockchain.

In a further embodiment, the action includes determining the classification is delayed and recording the at least one entry on a new third block chain.

In still a further embodiment, the method further includes setting, for each entry of the several entries of the first blockchain, a flag to generate a flag array that determines entries that are bridged on the first blockchain and entries that are bridged on the second blockchain.

In still a further embodiment, the method further includes concatenating the several entries together; appending the flag array to the concatenated several entries to generate a string; hashing the string; and recording the hash on the second blockchain.

A security platform in accordance with an embodiment of the invention includes: a network interface; memory; and a processor, the processor configured to: obtain a request for a transaction regarding a non-fungible token (NFT); determine a risk associated with the transaction based on a verification of the request, where the verification includes analyzing data associated with at least one user related to the request and data related to the token; and based on the risk, perform an action regarding the transaction.

In a further embodiment, the transaction is a sale of the NFT between different users and the verification includes using identity tokens to verify the identities of at least one user, where an identity token is tied to an identity of a person and includes biometrics to verify the identity of the person.

In still a further embodiment, the verification includes determining the identity of the at least one user using data from at least one category selected from the group consisting of data regarding look-alike identities, data regarding reputation scores, data regarding marketplace recognition, data regarding transaction histories, data regarding complaint scores, data regarding IP addresses, and data regarding hardware fingerprints.

In yet a further embodiment, the verification incldues authenticating the NFT, where the authentication includes using at least one metric selected from the group consisting of a Fast Fourier Transform (FFT) of the NFT, a cryptographic hash of the NFT, a fuzzy hash of the NFT, a spectrometry representation of the NFT, a duration of the NFT, and a description of the principal frames of the NFT.

In a further embodiment, the security platform further includes: a registry of NFTs that includes several entries, each entry including several metrics; and where the verification includes authenticating the NFT using the registry of NFTs by comparing the NFT to the entries in the registry of NFTs.

In a further embodiment, the verification includes verifying the NFT across several different NFT registries using several different metrics.

In a further embodiment, the NFT is associated with a certification token, wherein the verification includes authenticating the NFT using the certification token associated with the NFT, where the certification token includes information about entities involved in the assessment, a score of the assessment, and a date of the assessment.

In still a further embodiment, the certification token is registered on a ledger and associated with a time-stamp.

In still a further embodiment again, performing the action regarding the transaction includes determining the risk is above a threshold and performing at least one action selected from the group consisting of: generating a warning to the user, blocking the transaction, delaying the transaction, and undoing the transaction.

In still a further embodiment, performing the action regarding the transaction incldues determining the risk is below a threshold and allowing the transaction to proceed.

In still a further embodiment, the NFT is associated with an access right token that identifies access rights of the user to an entity, where the verification includes analyzing the access right token associated with the user.

In still a further embodiment, the verification includes verifying the NFT across several certification chains using several certification tokens associated with the NFT.

A system for performing a security service in accordance with an embodiment of the invention includes a first processing unit and a second processing unit, the first processing unit associated with a different execution environment than the second processing unit, where: the first processing unit takes as input a first token and generates a second token including an encrypted element; the second processing unit takes as input the second token and performs an action that results in the encrypted element being decrypted; the second processing unit generates a third token, where the third token is associated with a lower security requirement than the second token; and where at least one of the first processing unit and the second processing unit performs a verification to authenticate at least one of the first token and the second token using a similarity aspect associated with the first token and the second token.

In a further embodiment, the different execution environment is a different physical execution environment.

In yet a further embodiment, the different execution environment is a different logical execution environment.

In still a further embodiment, the similarity aspect corresponds to an equality comparison.

In still a further embodiment again, the similarity aspect corresponds to a verification of textual similarity.

In still a further embodiment still, the similarity aspect corresponds to a verification of visual similarity.

In still a further embodiment again, the similarity aspect corresponds to a verification of audio similarity.

In still another embodiment, the similarity aspect is determined by a rule-based comparison.

In still another embodiment again, the similarity aspect is determined by generation of a similarity score and the comparison of the similarity score with a threshold value.

In further embodiment again, the first token incldues additional information that is more sensitive than information comprised in the second token.

In another additional embodiment, the third token includes an encrypted component.

In a further embodiment, the system further includes performing by at least one of the first processing unit and the second processing computations that include verifying at least two certifications.

In a further embodiment, at least two certifications are determined to be associated with different originators of certifications.

In still a further embodiment, the system further includes performing at least one reputation evaluation for each of the originators of the certifications.

In still a further embodiment, each of the at least two certifications comprises a token mesh.

In still a further embodiment, each of the token meshes associated with each of the at least two certifications is assessed to determine a potential risk.

A security platform in accordance with an embodiment of the invention includes: a network interface; memory; and a processor, the processor configured to: detect abuse of a digital asset; and modify the digital asset, wherein a modification is at least one of: degrading the digital asset, destroying the digital asset, stopping further resale of the digital asset, changing a URI of the digital asset, changing metadata of the digital asset to point to an empty valueless digital asset, and suspending use of the digital asset until a rectifying action is taken.

In a further embodiment, the processor is further configured to restore the digital asset, where the restoring includes at least one of minting a replacement asset for a selected holder and replacing the digital asset with a similar digital asset.

In still a further embodiment, the processor is further configured to determine a certainty level related to the abuse of the digital asset, where the modifying of the digital asset is performed based on the determined certainty-level.

In still a further embodiment again, the certainty level meets a threshold indicating that the certainty level is classified as near-certain detection of abuse and the modifying of the digital asset includes re-generating a copy of the same digital asset and assigning the copy of the same digital asset to a user.

In yet a further embodiment, the detecting the abuse of the digital asset is performed by using at least one process selected from the group consisting of: using a set of heuristic rules, using a machine-learning modeled trained to detect abuse, and receiving a report from a user associated with the digital asset.

In yet a further embodiment again, the digital asset is associated with a set of rules specified by a creator of the digital asset, where modifying the digital asset is based on the set of rules.

In yet a further embodiment still, modifying the digital asset includes performing different modifications to the digital assed based on a security policy.

In still a further embodiment, the detecting the abuse of the digital asset includes detecting a breach of a smart contract.

A method for safeguarding ownership transfer of a digital asset against abuse in accordance with an embodiment of the invention includes, receiving a request related to verifying a transfer of ownership of a digital asset; performing at least one verification; determining a result from several results of the at least one verification, where the several results includes approving a transfer of ownership and blocking a transfer of ownership; performing an action based on the result, wherein a status is approved and approving the transfer of ownership, and where a status is disapproved and blocking the transfer of ownership.

In a further embodiment, the request includes a digital signature on a message that specifies the transfer request.

In still a further embodiment, the performing of the at least one verification including at least one verification selected from the group consisting of: (a) scanning at least one blockchain for transactions associated with a buyer of the digital asset, (b) obtaining complaints from users, the complaints being associated with the buyer of the digital asset, (c) detecting inconsistencies associated with the transfer (d) analyzing at least one database to verify that a plurality of types of information regarding at least one party to the transaction, (f) displaying a message to an owner of the digital asset, wherein the message identifies the transfer request and at least some of the terms of the transfer and receiving a response thereto from the owner, (g) determining a discrepancy between a value of the digital asset and an offered price for the digital asset, (h) starting a timer of a predetermined length where the transfer status is determined input from a party to the transaction.

In a further embodiment still, the performing of the at least one verification includes determining a risk score, where the performing the action is based on the determined risk score.

In yet a further embodiment, the risk score satisfies a threshold and the transfer of ownership is approved.

In yet a further embodiment still, the risk score does not satisfy a threshold and the transfer of ownership is blocked.

In a further embodiment again, the risk score is within a particular threshold and obtaining input from a party to the transaction.

In a further embodiment still, the determining of the risk score is performed using at least one process selected from the group consisting of using heuristic methods and machine learning (ML).

In another embodiment, the ML employs a pre-trained model to predict the risk score based on properties of the transaction, associated digital wallets and wallet histories.

In still another embodiment, the ML employs a model that is dynamically trained and updated to reflect activities of a plurality of wallets connected to the parties to the transaction.

In another embodiment again, the performing of the at least one verification includes obtaining an approval from a party to the transaction that is selling the digital asset, where the approval includes at least one approval selected from the group consisting of: providing the party to the transaction an image thumbnail requesting approval, (II) providing the party to the transaction an audio message requesting approval, (III) providing an electronic message to the party to the transaction requesting approval; and where the party to the transaction approves the transaction using biometric data.

In still a further embodiment, the method further includes performing at least one action selected from the group consisting of: generating a log, charging an account of at least one party to the transaction, providing a notification to a security service provider, providing a notification to a tax collecting authority, and providing a notification to a royalty tracking entity.

In still a further embodiment, the digital asset is associated with an electronic compliance statement, wherein the electronic compliance statement sets for a set of requirements on the transfer of ownership of the digital asset, where the performing the at least one verification includes determining that the set of requirements are fulfilled.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The description and claims will be more fully understood with reference to the following figures and data graphs, which are presented as exemplary embodiments of the invention and should not be construed as a complete recitation of the scope of the invention.

FIG. 1 is a conceptual diagram of an NFT platform in accordance with an embodiment of the invention.

FIG. 2 is a network architecture diagram of an NFT platform in accordance with an embodiment of the invention.

FIG. 3 is a conceptual diagram of a permissioned blockchain in accordance with an embodiment of the invention.

FIG. 4 is a conceptual diagram of a permissionless blockchain in accordance with an embodiment of the invention.

FIGS. 5A-5B are diagrams of a dual blockchain in accordance with a number of embodiments of the invention.

FIG. 6 conceptually illustrates a process followed by a Proof of Work consensus mechanism in accordance with an embodiment of the invention.

FIG. 7 conceptually illustrates a process followed by a Proof of Space consensus mechanism in accordance with an embodiment of the invention.

FIG. 8 illustrates a dual proof consensus mechanism configuration in accordance with an embodiment of the invention.

FIG. 9 illustrates a process followed by a Trusted Execution Environment-based consensus mechanism in accordance with some embodiments of the invention

FIGS. 10-12 depicts various devices that can be utilized alongside an NFT platform in accordance with various embodiments of the invention.

FIGS. 13 depicts a media wallet application configuration in accordance with an embodiment of the invention.

FIGS. 14A-14C depicts user interfaces of various media wallet applications in accordance with a number of embodiments of the invention.

FIG. 15 illustrates an NFT ledger entry corresponding to an NFT identifier.

FIGS. 16A-16B illustrate an NFT arrangement relationship with corresponding physical content in accordance with an embodiment of the invention.

FIG. 17 illustrates a process for establishing a relationship between an NFT and corresponding physical content.

FIG. 18 illustrates an architecture of a deception detector to detect illegal copies of a token in accordance with an embodiment of the invention.

FIG. 19 illustrates a meta-token that includes several tokens with different computational capabilities in accordance with an embodiment of the invention.

FIG. 20 illustrates an example token-mesh of certification tokens to authenticate a token in accordance with an embodiment of the invention.

FIG. 21 illustrates an example token-mesh of certification tokens with a weak link in accordance with an embodiment of the invention.

FIG. 22 illustrates management and generation logs in accordance with an embodiment of the invention.

FIG. 23 illustrates a process for mitigating abuse of a digital asset in accordance with an embodiment of the invention.

FIG. 24 illustrates a security device for mitigating abuse of a digital asset in accordance with an embodiment of the invention.

FIG. 25 illustrates a process illustrating detecting theft of an NFT that is stolen from its rightful owner in accordance with an embodiment of the invention.

FIG. 26 illustrates a process for bridging from a first blockchain to a second blockchain using a watchful bridge in accordance with an embodiment of the invention.

FIG. 27 illustrates a block diagram of a watchful bridge in accordance with an embodiment of the invention.

FIG. 28 illustrates a process for bridging between a layer-1 and layer 2 block chain in accordance with an embodiment of the invention.

FIG. 29 illustrates an example in which several entities communicate with each other based on voting to determine whether to record entries on a blockchain in accordance with an embodiment of the invention.

FIG. 30 illustrates a transfer of ownership of a token from different wallets in accordance with an embodiment of the invention.

FIG. 31 illustrates a process for safeguarding ownership transfer of a digital asset against abuse in accordance with an embodiment of the invention.

FIG. 32 illustrates a circuit architecture of a device for safeguarding ownership transfer of a digital asset against abuse in accordance with an embodiment of the invention.

### DETAILED DESCRIPTION

### Overview

Turning now to the drawings, systems and methods for implementing blockchain-based Non-Fungible Token (NFT) in accordance with various embodiments of the invention are illustrated. In several embodiments, a blockchain-based NFT platforms is provided that includes a security platforms that enables content creators to issue, mint, and transfer Non-Fungible Tokens (NFTs) directed to content including, but not limited to, rich media content while minimizing potential for fraud, theft, counterfeiting, among various other abuses.

In a number of embodiments, content creators can issue NFTs to users within the NFT platforms. NFTs can be created around a large range of real-world media content and intellectual property. Movie studios can mint digital collectibles for their movies, characters, notable scenes and/or notable objects. Record labels can mint digital collectibles for artists, bands, albums and/or songs. Similarly, official digital trading cards can be made from likeness of celebrities, cartoon characters and/or gaming avatars.

Various security features can be provided to protect purchasers of NFTs, including authenticating identities of sellers, among other protective measures to minimize hacking and other forms of criminal activity. Many embodiments of the NFT platforms can include a security platforms that can utilize identity tokens that can be used to prevent impersonation of people, prevent illegal copies of NFTs, among other types of criminal activity. In many embodiments, an identity token can be associated with a person and/or an organization and can be linked to other types of data to help authenticate the token. In particular, an identity token can be linked to a biometric identifier associated with another token, and that can be used in combination to provide the authenticity of a person associated with the token.

The security platforms in accordance with several embodiments can minimize fraud by analyzing various types of information related to a transaction and performing an appropriate action regarding the transaction. In particular, many embodiments of the security platforms can use different types of information to assess risks associated with a transaction, including (but not limited to) reputation scores, complaint scores, transaction history, seller identity, transaction values, historic transactions, among other types of information in order to prevent fraudulent transactions.

With respect to counterfeiting, many embodiments of the security platforms can authenticate NFTs and/or prevent illegal copies of NFTs using various types of analysis between an authenticate NFT and an illegal copy. The types of analysis can include (but are not limited to) using various metrics, including a Fast Fourier Transform (FFT) of an NFT, a cryptographic hash of the NFT, a fuzzy hash related to the NFT, a spectrometry representation of NFT among others. If an NFT is not a visual art piece, but an audio element, then the metrics may include a duration of the associated art piece, the FFT of the NFT, among various other types of analysis as appropriate to the particular situation.

Several embodiments of the security platforms can use several different registries and/or certification authorities to maintain NFT records, which can be used to prevent counterfeiting, authenticate new NFTs and/or to facilitate the sale and/or licensing of existing NFTs. Described are various different fraud detection and prevention mechanisms to help minimize potential problems that can arise in relation to NFT activities.

Certain embodiments of the security platforms can be used to resolve NFT fraud and theft. In particular, many embodiments of the security platforms can mitigate the abuse of a digital asset by making a determination that an abuse of a digital asset has occurred or is ongoing, and subsequently, modifying the digital asset (e.g., degrading the digital asset, destroying the digital asset, stopping further reselling of the digital asset, among various other modifications) to prevent and/or resolve the abuse of the digital asset.

Security platforms in accordance with a variety of embodiments of the invention can perform different levels of security actions based on computed risk scores for different types of activities and/or perform actions based on a risk level associated with the scores. In many embodiments, the risk levels can include a near-certainty of fraud, whereby the security platforms can destroy the digital asset; a risk above a medium threshold, whereby the security platforms can block further ownership transfers; and a certainty level below a threshold, whereby the security platforms can perform further analysis and/or request user input to perform future actions.

In many embodiments, security platforms can use any of a variety of computational techniques to analyze activity, including (but not limited to) using heuristic rules, using machine learning that has been trained to detect theft and/or other abuse, among numerous other techniques as appropriate for the particular digital assets being transferred and the particular platforms being used.

In certain embodiments of the security platforms, an owner/creator or other party to an NFT may specify contractual conditions, such as in a smart contract or associated metadata, under which an NFT may change ownership. Accordingly, a transaction can be automatically blocked if conditions in the smart contract are violated or allowed if the conditions are satisfied.

Security platforms in accordance with some embodiments of the invention can include protecting against malware attached associated with malware that could cause the fraudulent transfer of assets. In many embodiments, this can be achieved by “wrapping” cryptofunds in NFTs, which can protect the transfer of NFTs by allowing a party to reverse a transaction.

With respect to addressing counterfeiting, security platforms in accordance with a number of embodiments of the invention can include a registry in which content owners can register indications of content and ownership and/or complaints of abuse. NFTs can be assessed based on an analysis of the information in the registries and actions can be taken accordingly.

Many embodiments of the security platforms can include a watchful bridge for blockchain fraud prevention. In particular, the watchful bridge can facilitate bridging in a multi-layer blockchain, where the bridge is the connection between a layer-1 blockchain and a layer-2 blockchain. In a number of embodiments, the layer-2 protocol may operate with a lesser degree of security than the layer-1 to reduce operational costs of blockchain systems. Accordingly, many embodiments of the security platforms address an array of security problems by watchful bridging between a layer-1 blockchain and a layer-2 blockchain.

In many embodiments, to implement many security features, a bridge can be watchful in that it selectively identifies what entries on the layer-2 chain to cause to be registered on the layer-1 chain, or conversely, what entries to block. Blocking entries can cause associated events to be canceled, thereby enabling a useful “undo” feature. Watchful bridges in accordance with various embodiments of the invention can delay the registering of events for further determination of the security decision.

Accordingly, the watchful bridge in accordance with several embodiments can confirm, block, and/or delay the recording of layer-2 events on the layer-1 chain. In many embodiments, the watchful bridge can obtain feedback for one or more entries, including (but not limited to) from bounty hunters, oracles, agents, and/or smart contracts, and make an appropriate security decision based on the feedback.

In many embodiments, the watchful bridge can include a decision component and a logging component, where the decision component can make security assessments regarding given entries and the logging component can record reasons for blocking entries and other decision information. Log records in accordance with many embodiments of the invention can include timestamps among other information.

In many embodiments, the watchful bridge can utilize machine learning (ML) or artificial intelligence (AI) to assess inputs and perform classifications or other analysis. The analysis in accordance with numerous embodiments of the invention can generate a risk level for entries and appropriate actions regarding blocking, allowing, and/or delaying the entries from being recorded between the different layers of the blockchain.

Many embodiments of the security platforms can be utilized to safeguard ownership transfers between users and/or digital wallets. Many embodiments of the security platforms can perform various different processes P to monitor and permit ownership changes.

In many embodiments, the verification performed by a process P of the security platforms can include making a determination of whether a pending transaction is safe, unsafe or undetermined in terms of safety. A safe transaction may be automatically approved by P, without the use of a user-facing verification. An unsafe transaction may be automatically blocked by P, also without the use of a user-facing verification. P may perform a user-facing verification if the automated verification step results in an assessment that corresponds to being undetermined in terms of safety. This may correspond to having a risk score/level that exceeds a threshold value. The score/level may be generated using a combination of methods, including heuristic methods, rule-based methods, Artificial Intelligence (AI) methods and Machine Learning (ML) methods.

In several embodiments, security platforms process P is a third-party service, e.g., implemented using a web server, receiving requests from a wallet to transfer ownership of one or more tokens, performing a verification and, conditional on the outcome of the verification, determining whether to approve the ownership transfer.

In many embodiments of the security platforms, the process of performing a verification/approval can include one or more of (a) scanning blockchain(s) for transactions associated with a buyer or smart contract of the digital asset, (b) obtaining complaints from bounty hunters, the complaints being associated with the buyer or smart contract of the digital asset, (c) detecting inconsistencies associated with the transfer, such as an offer of a token for sale by a first party different from a second party that the content service understands to be the proper owner, (d) querying one or more databases in order to determine whether or not any smart contract is listed in a database as being malicious or “legitimate”, (e) querying one or more databases in order to determine whether or not the buyer has been involved in dubious transactions of digital assets, (f) displaying a message to a current owner of the digital asset, wherein the message identifies the transfer request and at least some of the terms of the transfer and receiving a response thereto from the current owner, (g) determining a discrepancy between a value of the digital asset and an offered price for the digital asset, (h) starting a timer of a predetermined lengths, wherein the transfer is either approved or disapproved based on a received or omitted input from the seller.

In many embodiments of the security platforms, the process P can compute a security level score and compare that with several different thresholds that can determine the appropriate action to take. The safety or risk level/score can be computed using one or more of heuristic methods, rule-based method, Artificial Intelligence, AI, and Machine Learning, ML, among other computational techniques.

In many embodiments of the security platforms, when ML is used for determining of the safety or risk level/score the ML can employ a model trained, refined, or updated to reflect the activities of the owning wallet and/or user, such as reflecting a history of transactions that are typical or atypical for this user in its computation of risk.

Security platforms for protecting against abuse on NFT platforms in accordance with various embodiments of the invention are described below. While security platforms are not limited to use in blockchain-based non-fungible (NFT) platforms, blockchain-based non-fungible (NFT) platforms that can include security platforms are introduced below as an illustrative example of the manner in which security platforms in accordance with various embodiments of the invention can be implemented within blockchain-based systems.

### Non-Fungible Token (NFT) Platforms

Turning now to the drawings, systems and methods for implementing blockchain-based Non-Fungible Token (NFT) platforms in accordance with various embodiments of the invention are illustrated. In several embodiments, blockchain-based NFT platforms are platforms which enable content creators to issue, mint, and transfer Non-Fungible Tokens (NFTs) directed to content including, but not limited to, rich media content.

In a number of embodiments, content creators can issue NFTs to users within the NFT platform. NFTs can be created around a large range of real-world media content and intellectual property. Movie studios can mint digital collectibles for their movies, characters, notable scenes and/or notable objects. Record labels can mint digital collectibles for artists, bands, albums and/or songs. Similarly, official digital trading cards can be made from likeness of celebrities, cartoon characters and/or gaming avatars.

NFTs minted using NFT platforms in accordance with various embodiments of the invention can have multifunctional programmable use cases including rewards, private access to premium content and experiences, as discounts toward the purchase of goods, among many other value-added use cases.

In many embodiments, each NFT can have a set of attributes that define its unique properties. NFTs may therefore be classified based on which attributes are emphasized. Possible classifications may address, but are not limited to: NFTs as identifying entities, NFTs output by other NFTs, NFTs as content creation assets, and NFTs as evaluating entities. NFTs can be interpreted differently by various platforms in order to create platform-specific user experiences. The metadata associated with an NFT may also include digital media assets such as (but not limited to) images, videos about the specific NFT, and the context in which it was created (studio, film, band, company song etc.).

In many embodiments, NFT storage may be facilitated through mechanisms for the transfer of payment from users to one or more service providers. Through these mechanisms, a payment system for NFT maintenance can allow for incremental payment and ongoing asset protection. NFT storage may be additionally self-regulated through willing participants disclosing unsatisfactory NFT management in exchange for rewards.

In many embodiments, the NFT platform can include media wallet applications that enable users to securely store NFTs and/or other tokens on their devices. Furthermore, media wallets (also referred to as “digital wallets”) can enable users to obtain NFTs that prove purchase of rights to access a particular piece of media content on one platform and use the NFT to gain access to the purchased content on another platform. The consumption of such content may be governed by content classification directed to visual user interface systems.

In several embodiments, users can download and install media wallet applications to store NFTs on the same computing devices used to consume streamed and/or downloaded content. Media wallet applications and NFTs can disseminate data concerning media consumption on the computing devices on which the media wallet applications are installed and/or based upon observations indicative of media consumption independently of the device. Media consumption data may include, but is not limited to, data reporting the occurrence of NFT transactions, data reporting the occurrence of NFT event interactions data reporting the content of NFT transactions, data reporting the content of media wallet interactions, and/or data reporting the occurrence of media wallet interactions.

While various aspects of NFT platforms, NFTs, media wallets, blockchain configurations, reporting structures, and maintenance systems are discussed above, NFT platforms and different components that can be utilized within NFT platforms in accordance with various embodiments of the invention are discussed further below.

### NFT Platforms

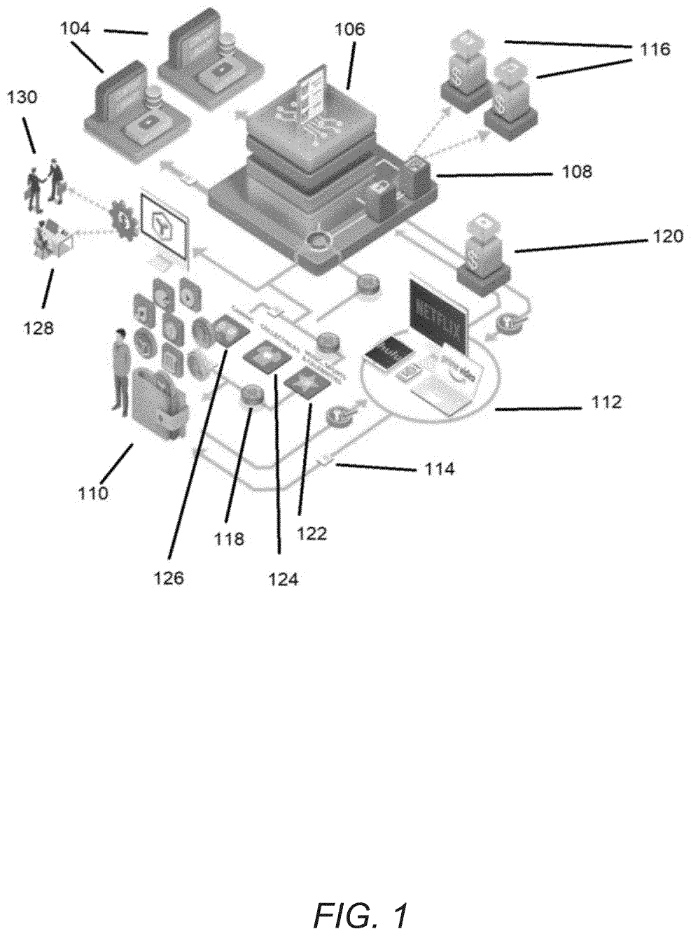

An NFT platform in accordance with an embodiment of the invention is illustrated in FIG. 1. The NFT platform 100 utilizes one or more immutable ledgers (e.g. one or more blockchains) to enable a number of verified content creators 104 to access an NFT registry service to mint NFTs 106 in a variety of forms including (but not limited to) celebrity NFTs 122, character NFTs from games 126, NFTs that are redeemable within games 126, NFTs that contain and/or enable access to collectibles 124, and NFTs that have evolutionary capabilities representative of the change from one NFT state to another NFT state.

Issuance of NFTs 106 via the NFT platform 100 enables verification of the authenticity of NFTs independently of the content creator 104 by confirming that transactions written to one or more of the immutable ledgers are consistent with the smart contracts 108 underlying the NFTs.

As is discussed further below, content creators 104 can provide the NFTs 106 to users to reward and/or incentivize engagement with particular pieces of content and/or other user behavior including (but not limited to) the sharing of user personal information (e.g. contact information or user ID information on particular services), demographic information, and/or media consumption data with the content creator and/or other entities. In addition, the smart contracts 108 underlying the NFTs can cause payments of residual royalties 116 when users engage in specific transactions involving NFTs (e.g. transfer of ownership of the NFT).

In a number of embodiments, users utilize media wallet applications 110 on their devices to store NFTs 106 distributed using the NFT platform 100. Users can use media wallet applications 110 to obtain and/or transfer NFTs 106. In facilitating the retention or transfer of NFTs 106, media wallet applications may utilize wallet user interfaces that engage in transactional restrictions through either uniform or personalized settings. Media wallet applications 110 in accordance with some embodiments may incorporate NFT filtering systems to avoid unrequested NFT assignment. Methods for increased wallet privacy may also operate through multiple associated wallets with varying capabilities. As can readily be appreciated, NFTs 106 that are implemented using smart contracts 108 having interfaces that comply with open standards are not limited to being stored within media wallets and can be stored in any of a variety of wallet applications as appropriate to the requirements of a given application. Furthermore, a number of embodiments of the invention support movement of NFTs 106 between different immutable ledgers. Processes for moving NFTs between multiple immutable ledgers in accordance with various embodiments of the invention are discussed further below.

In several embodiments, content creators 104 can incentivize users to grant access to media consumption data using offers including (but not limited to) offers of fungible tokens 118 and/or NFTs 106. In this way, the ability of the content creators to mint NFTs enables consumers to engage directly with the content creators and can be utilized to incentivize users to share with content creators' data concerning user interactions with additional content. The permissions granted by individual users may enable the content creators 104 to directly access data written to an immutable ledger. In many embodiments, the permissions granted by individual users enable authorized computing systems to access data within an immutable ledger and content creators 104 can query the authorized computing systems to obtain aggregated information. Numerous other example functions for content creators 104 are possible, some of which are discussed below.

NFT blockchains in accordance with various embodiments of the invention enable issuance of NFTs by verified users. In many embodiments, the verified users can be content creators that are vetted by an administrator of networks that may be responsible for deploying and maintaining the NFT blockchain. Once the NFTs are minted, users can obtain and conduct transactions with the NFTs. In several embodiments, the NFTs may be redeemable for items or services in the real world such as (but not limited to) admission to movie screenings, concerts, and/or merchandise.

As illustrated in FIG. 1, users can install the media wallet application 110 onto their devices and use the media wallet application 110 to purchase fungible tokens. The media wallet application could also be provided by a browser, or by a dedicated hardware unit executing instructions provided by a wallet manufacturer. The different types of wallets may have slightly different security profiles and may offer different features, but would all be able to be used to initiate the change of ownership of tokens, such as NFTs. In many embodiments, the fungible tokens can be fully converted into fiat currency and/or other cryptocurrency. In several embodiments, the fungible tokens are implemented using split blockchain models in which the fungible tokens can be issued to multiple blockchains (e.g. Ethereum). As can readily be appreciated, the fungible tokens and/or NFTs utilized within an NFT platform in accordance with various embodiments of the invention are largely dependent upon the requirements of a given application.

In several embodiments, the media wallet application is capable of accessing multiple blockchains by deriving accounts from each of the various immutable ledgers used within an NFT platform. For each of these blockchains, the media wallet application can automatically provide simplified views whereby fungible tokens and NFTs across multiple accounts and/or multiple blockchains can be rendered as single user profiles and/or wallets. In many embodiments, the single view can be achieved using deep-indexing of the relevant blockchains and API services that can rapidly provide information to media wallet applications in response to user interactions. In certain embodiments, the accounts across the multiple blockchains can be derived using BIP32 deterministic wallet key. In other embodiments, any of a variety of techniques can be utilized by the media wallet application to access one or more immutable ledgers as appropriate to the requirements of a given application.

NFTs can be purchased by way of exchanges 130 and/or from other users. In addition, content creators can directly issue NFTs to the media wallets of specific users (e.g. by way of push download or AirDrop). In many embodiments, the NFTs are digital collectibles such as celebrity NFTs 122, character NFTs from games 126, NFTs that are redeemable within games 126, and/or NFTs that contain and/or enable access to collectibles 124. It should be appreciated that a variety of NFTs are described throughout the discussion of the various embodiments described herein and can be utilized in any NFT platform and/or with any media wallet application.

While the NFTs are shown as static in the illustrated embodiment, content creators can utilize users' ownership of NFTs to engage in additional interactions with the user. In this way, the relationship between users and particular pieces of content and/or particular content creators can evolve over time around interactions driven by NFTs. In a number of embodiments, collection of NFTs can be gamified to enable unlocking of additional NFTs. In addition, leaderboards can be established with respect to particular content and/or franchises based upon users' aggregation of NFTs. As is discussed further below, NFTs and/or fungible tokens can also be utilized by content creators to incentivize users to share data.

NFTs minted in accordance with several embodiments of the invention may incorporate a series of instances of digital content elements in order to represent the evolution of the digital content over time. Each one of these digital elements can have multiple numbered copies, just like a lithograph, and each such version can have a serial number associated with it, and/or digital signatures authenticating its validity. The digital signature can associate the corresponding image to an identity, such as the identity of the artist. The evolution of digital content may correspond to the transition from one representation to another representation. This evolution may be triggered by the artist, by an event associated with the owner of the artwork, by an external event measured by platforms associated with the content, and/or by specific combinations or sequences of event triggers. Some such NFTs may also have corresponding series of physical embodiments. These may be physical and numbered images that are identical to the digital instances described above. They may also be physical representations of another type, e.g., clay figures or statues, whereas the digital representations may be drawings. The physical embodiments may further be of different aspects that relate to the digital series. Evolution in compliance with some embodiments may also be used to spawn additional content, for example, one NFT directly creating one or more secondary NFTs.

When the user wishes to purchase an NFT using fungible tokens, media wallet applications can request authentication of the NFT directly based upon the public key of the content creator and/or indirectly based upon transaction records within the NFT blockchain. As discussed above, minted NFTs can be signed by content creators and administrators of the NFT blockchain. In addition, users can verify the authenticity of particular NFTs without the assistance of entities that minted the NFT by verifying that the transaction records involving the NFT within the NFT blockchain are consistent with the various royalty payment transactions required to occur in conjunction with transfer of ownership of the NFT by the smart contract underlying the NFT.

Applications and methods in accordance with various embodiments of the invention are not limited to media wallet applications or use within NFT platforms. Accordingly, it should be appreciated that the data collection capabilities of any media wallet application described herein can also be implemented outside the context of an NFT platform and/or in a dedicated application and/or in an application unrelated to the storage of fungible tokens and/or NFTs. Various systems and methods for implementing NFT platforms and media wallet applications in accordance with various embodiments of the invention are discussed further below.

### NFT Platforms Network Architectures

NFT platforms in accordance with many embodiments of the invention utilize public blockchains and permissioned blockchains. In several embodiments, the public blockchain is decentralized and universally accessible. Additionally, in a number of embodiments, private/permissioned blockchains are closed systems that are limited to publicly inaccessible transactions. In many embodiments, the permissioned blockchain can be in the form of distributed ledgers, while the blockchain may alternatively be centralized in a single entity.

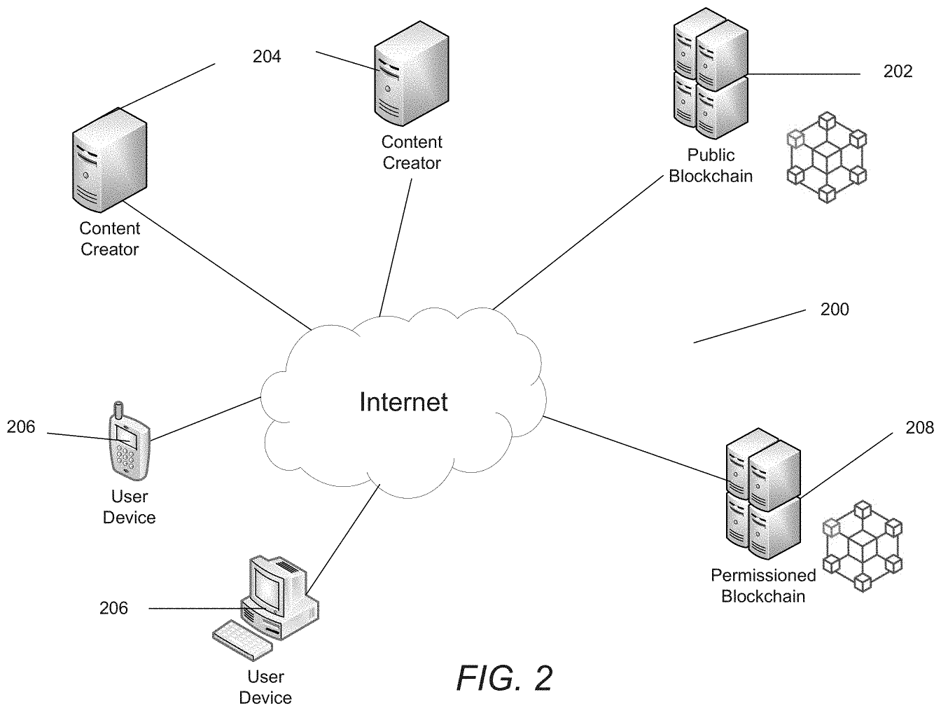

An example of network architecture that can be utilized to implement an NFT platform including a public blockchain and a permissioned blockchain in accordance with several embodiments of the invention is illustrated in FIG. 2. The NFT platform 200 utilizes computer systems implementing a public blockchain 202 such as (but not limited to) Ethereum and Solana. A benefit of supporting interactions with public blockchains 202 is that the NFT platform 200 can support minting of standards based NFTs that can be utilized in an interchangeable manner with NFTs minted by sources outside of the NFT platform on the public blockchain. In this way, the NFT platform 200 and the NFTs minted within the NFT platform are not part of a walled garden, but are instead part of a broader blockchain-based ecosystem. The ability of holders of NFTs minted within the NFT platform 200 to transact via the public blockchain 202 increases the likelihood that individuals acquiring NFTs will become users of the NFT platform. Initial NFTs minted outside the NFT platform can also be developed through later minted NFTs, with the initial NFTs being used to further identify and interact with the user based upon their ownership of both NFTs. Various systems and methods for facilitating the relationships between NFTs, both outside and within the NFT platform are discussed further below.

Users can utilize user devices configured with appropriate applications including (but not limited to) media wallet applications to obtain NFTs. In many embodiments, media wallets are smart device enabled, front-end applications for fans and/or consumers, central to all user activity on an NFT platform. As is discussed in detail below, different embodiments of media wallet applications can provide any of a variety of functionality that can be determined as appropriate to the requirements of a given application. In the illustrated embodiment, the user devices 206 are shown as mobile phones and personal computers. As can readily be appreciated user devices can be implemented using any class of consumer electronics device including (but not limited to) tablet computers, laptop computers, televisions, game consoles, virtual reality headsets, mixed reality headsets, augmented reality headsets, media extenders, and/or set top boxes as appropriate to the requirements of a given application.

In many embodiments, NFT transaction data entries in the permissioned blockchain 208 are encrypted using users' public keys so that the NFT transaction data can be accessed by the media wallet application. In this way, users control access to entries in the permissioned blockchain 208 describing the user's NFT transaction. In several embodiments, users can authorize content creators 204 to access NFT transaction data recorded within the permissioned blockchain 208 using one of a number of appropriate mechanisms including (but not limited to) compound identities where the user is the owner of the data and the user can authorize other entities as guests that can also access the data. As can readily be appreciated, particular content creators' access to the data can be revoked by revoking their status as guests within the compound entity authorized to access the NFT transaction data within the permissioned blockchain 208. In certain embodiments, compound identities are implemented by writing authorized access records to the permissioned blockchain using the user's public key and the public keys of the other members of the compound entity.

When content creators wish to access particular pieces of data stored within the permissioned blockchain 208, they can make a request to a data access service. The data access service may grant access to data stored using the permissioned blockchain 208 when the content creators' public keys correspond to public keys of guests. In a number of embodiments, guests may be defined within a compound identity. The access record for the compound entity may also authorize the compound entity to access the particular piece of data. In this way, the user has complete control over access to their data at any time by admitting or revoking content creators to a compound entity, and/or modifying the access policies defined within the permissioned blockchain 208 for the compound entity. In several embodiments, the permissioned blockchain 208 supports access control lists and users can utilize a media wallet application to modify permissions granted by way of the access control list. In many embodiments, the manner in which access permissions are defined enables different restrictions to be placed on particular pieces of information within a particular NFT transaction data record within the permissioned blockchain 208. As can readily be appreciated, the manner in which NFT platforms and/or immutable ledgers provide fine-grained data access permissions largely depends upon the requirements of a given application.

In many embodiments, storage nodes within the permissioned blockchain 208 do not provide content creators with access to entire NFT transaction histories. Instead, the storage nodes simply provide access to encrypted records. In several embodiments, the hash of the collection of records from the permissioned blockchain is broadcast. Therefore, the record is verifiably immutable and each result includes the hash of the record and the previous/next hashes. As noted above, the use of compound identities and/or access control lists can enable users to grant permission to decrypt certain pieces of information or individual records within the permissioned blockchain. In several embodiments, the access to the data is determined by computer systems that implement permission-based data access services.

In many embodiments, the permissioned blockchain 208 can be implemented using any blockchain technology appropriate to the requirements of a given application. As noted above, the information and processes described herein are not limited to data written to permissioned blockchains 208, and NFT transaction data simply provides an example. Systems and methods in accordance with various embodiments of the invention can be utilized to enable applications to provide fine-grained permission to any of a variety of different types of data stored in an immutable ledger as appropriate to the requirements of a given application in accordance with various embodiments of the invention.

While various implementations of NFT platforms are described above with reference to FIG. 2, NFT platforms can be implemented using any number of immutable and pseudo-immutable ledgers as appropriate to the requirements of specific applications in accordance with various embodiments of the invention. Blockchain databases in accordance with various embodiments of the invention may be managed autonomously using peer-to-peer networks and distributed timestamping servers. In some embodiments, any of a variety of consensus mechanisms may be used by public blockchains, including but not limited to Proof of Space mechanisms, Proof of Work mechanisms, Proof of Stake mechanisms, and hybrid mechanisms.

NFT platforms in accordance with many embodiments of the invention may benefit from the oversight and increased security of private blockchains. As can readily be appreciated, a variety of approaches can be taken to the writing of data to permissioned blockchains and the particular approach is largely determined by the requirements of particular applications. As such, computer systems in accordance with various embodiments of the invention can have the capacity to create verified NFT entries written to permissioned blockchains.

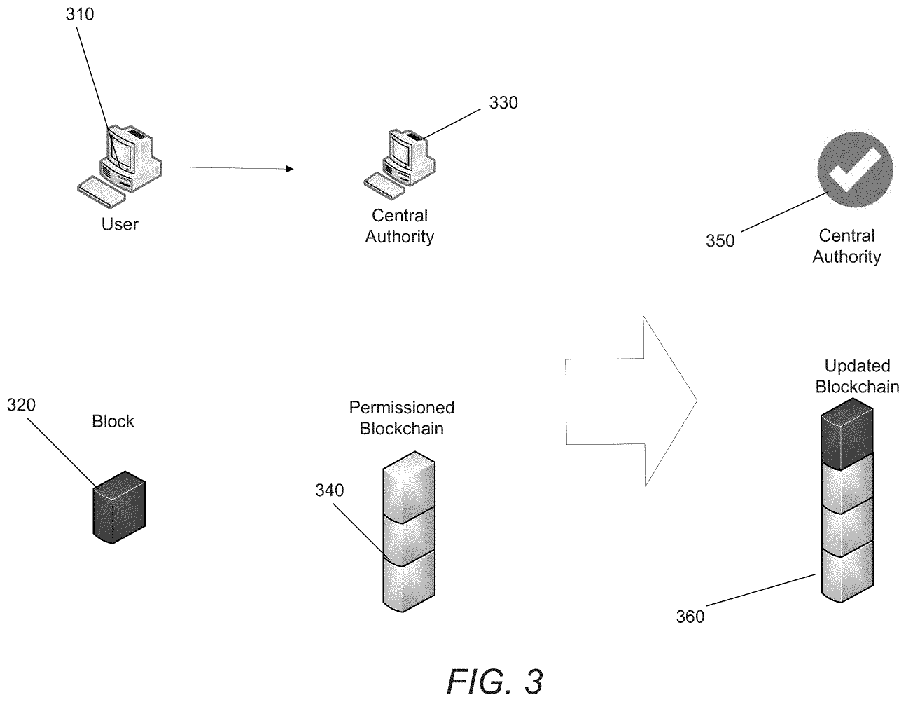

An implementation of permissioned (or private) blockchains in accordance with some embodiments of the invention is illustrated in FIG. 3. Permissioned blockchains 340 can typically function as closed computing systems in which each participant is well defined. In several embodiments, private blockchain networks may require invitations. In a number of embodiments, entries, or blocks 320, to private blockchains can be validated. In some embodiments, the validation may come from central authorities 330. Private blockchains can allow an organization or a consortium of organizations to efficiently exchange information and record transactions. Specifically, in a permissioned blockchain, a preapproved central authority 330 (which should be understood as potentially encompassing multiple distinct authorized authorities) can approve a change to the blockchain. In a number of embodiments, approval may come without the use of a consensus mechanism involving multiple authorities. As such, through a direct request from users 310 to the central authority 330, the determination of whether blocks 320 can be allowed access to the permissioned blockchain 340 can be determined. Blocks 320 needing to be added, eliminated, relocated, and/or prevented from access may be controlled through these means. In doing so the central authority 330 may manage accessing and controlling the network blocks incorporated into the permissioned blockchain 340. Upon the approval 350 of the central authority, the now updated blockchain 360 can reflect the added block 320.

NFT platforms in accordance with many embodiments of the invention may also benefit from the anonymity and accessibility of a public blockchain. Therefore, NFT platforms in accordance with many embodiments of the invention can have the capacity to create verified NFT entries written to a permissioned blockchain.

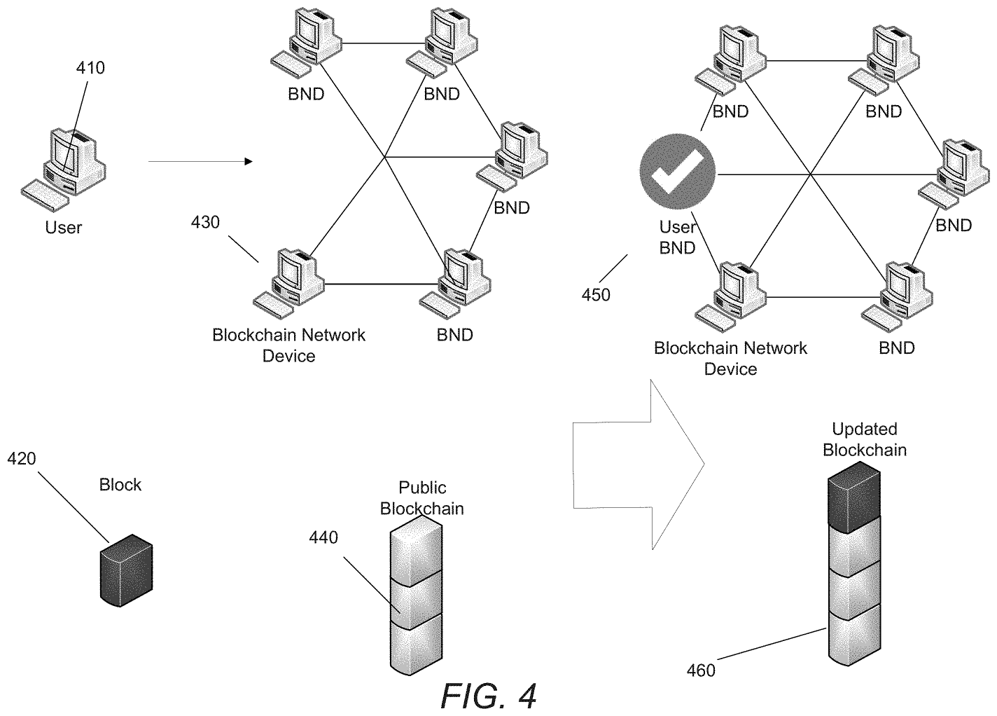

An implementation of a permissionless, decentralized, or public blockchain in accordance with an embodiment of the invention is illustrated in FIG. 4. In a permissionless blockchain, individual users 410 can directly participate in relevant networks and operate as blockchain network devices 430. As blockchain network devices 430, parties would have the capacity to participate in changes to the blockchain and participate in transaction verifications (via the mining mechanism). Transactions are broadcast over the computer network and data quality is maintained by massive database replication and computational trust. Despite being decentralized, an updated blockchain 460 cannot remove entries, even if anonymously made, making it immutable. In many decentralized blockchains, many blockchain network devices 430, in the decentralized system may have copies of the blockchain, allowing the ability to validate transactions. In many instances, the blockchain network device 430 can personally add transactions, in the form of blocks 420 appended to the public blockchain 440. To do so, the blockchain network device 430 would take steps to allow for the transactions to be validated 450 through various consensus mechanisms (Proof of Work, Proof of Stake, etc.). A number of consensus mechanisms in accordance with various embodiments of the invention are discussed further below.

Additionally, in the context of blockchain configurations, the term smart contract is often used to refer to software programs that run on blockchains. While a standard legal contract outlines the terms of a relationship (usually one enforceable by law), a smart contract enforces a set of rules using self-executing code within NFT platforms. As such, smart contracts may have the means to automatically enforce specific programmatic rules through platforms. Smart contracts are often developed as high-level programming abstractions that can be compiled down to bytecode. Said bytecode may be deployed to blockchains for execution by computer systems using any number of mechanisms deployed in conjunction with the blockchain. In many instances, smart contracts execute by leveraging the code of other smart contracts in a manner similar to calling upon a software library.

A number of existing decentralized blockchain technologies intentionally exclude or prevent rich media assets from existing within the blockchain, because they would need to address content that is not static (e.g., images, videos, music files). Therefore, NFT platforms in accordance with many embodiments of the invention may address this with blockchain mechanisms, that preclude general changes but account for updated content.

NFT platforms in accordance with many embodiments of the invention can therefore incorporate decentralized storage pseudo-immutable dual blockchains. In some embodiments, two or more blockchains may be interconnected such that traditional blockchain consensus algorithms support a first blockchain serving as an index to a second, or more, blockchains serving to contain and protect resources, such as the rich media content associated with NFTs.

In storing rich media using blockchain, several components may be utilized by an entity (“miner”) adding transactions to said blockchain. References, such as URLs, may be stored in the blockchain to identify assets. Multiple URLs may also be stored when the asset is separated into pieces. An alternative or complementary option may be the use of APIs to return either the asset or a URL for the asset. In accordance with many embodiments of the invention, references can be stored by adding a ledger entry incorporating the reference enabling the entry to be timestamped. In doing so, the URL, which typically accounts for domain names, can be resolved to IP addresses. However, when only files of certain types are located on particular resources, or where small portions of individual assets are stored at different locations, users may require methods to locate assets stored on highly-splintered decentralized storage systems. To do so, systems may identify at least primary asset destinations and update those primary asset destinations as necessary when storage resources change. The mechanisms used to identify primary asset destinations may take a variety of forms including, but not limited to, smart contracts.

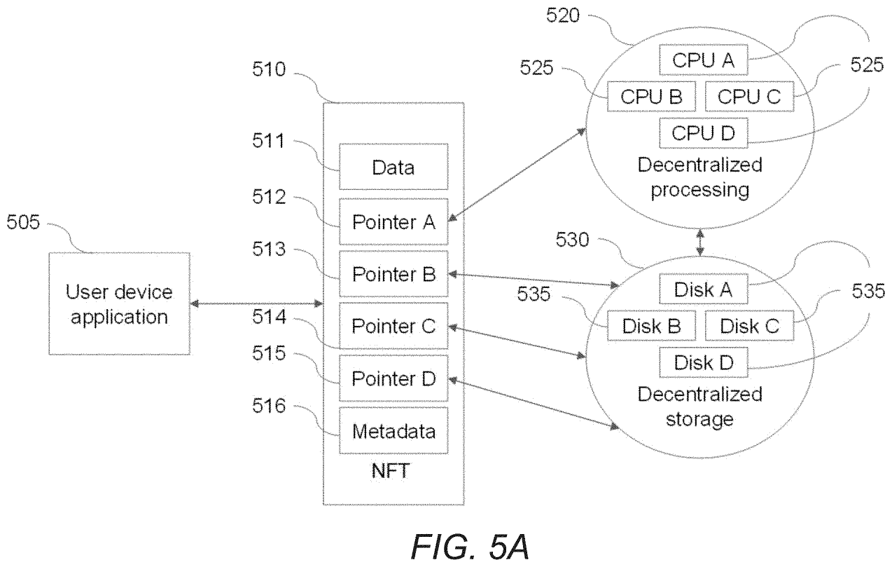

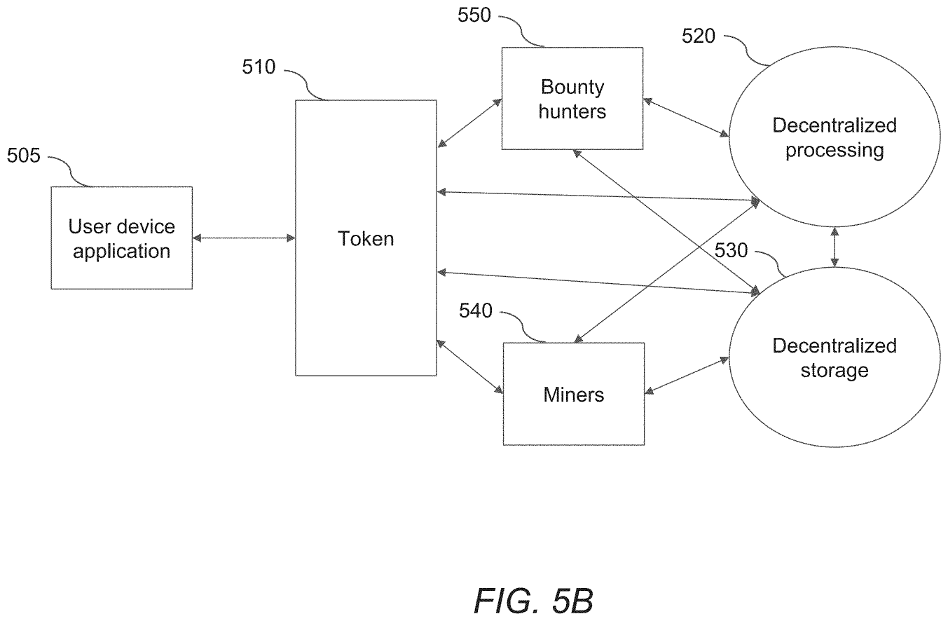

A dual blockchain, including decentralized processing 520 and decentralized storage 530 blockchains, in accordance with some embodiments of the invention is illustrated in FIG. 5A. Application running on devices 505, may interact with or make a request related to NFTs 510 interacting with such a blockchain. An NFT 510 in accordance with several embodiments of the invention may include many values including generalized data 511 (e.g. URLs), and pointers such as pointer A 512, pointer B 513, pointer C 514, and pointer D 515. In accordance with many embodiments of the invention, the generalized data 511 may be used to access corresponding rich media through the NFT 510. The NFT 510 may additionally have associated metadata 516.

Pointers within the NFT 510 may direct an inquiry toward a variety of on or off-ledger resources. In some embodiments of the invention, as illustrated FIG. 5A, pointer A 512 can direct the need for processing to the decentralized processing network 520. Processing systems are illustrated as CPU A, CPU B, CPU C, and CPU D 525. The CPUs 525 may be personal computers, server computers, mobile devices, edge loT devices, etc. Pointer A may select one or more processors at random to perform the execution of a given smart contract. The code may be secure or nonsecure and the CPU may be a trusted execution environment (TEE), depending upon the needs of the request. In the example reflected in FIG. 5A, pointer B 513, pointer C 514, and pointer D 515 all point to a decentralized storage network 530 including remote off-ledger resources including storage systems illustrated as Disks A, B, C, and D 535.

The decentralized storage system may co-mingle with the decentralized processing system as the individual storage systems utilize CPU resources and connectivity to perform their function. From a functional perspective, the two decentralized systems may also be separate. Pointer B 513 may point to one or more decentralized storage networks 530 for the purposes of maintaining an off-chain log file of token activity and requests. Pointer C 514 may point to executable code within one or more decentralized storage networks 530. And Pointer D 515 may point to rights management data, security keys, and/or configuration data within one or more decentralized storage networks 530.

Dual blockchains may additionally incorporate methods for detection of abuse, essentially operating as a “bounty hunter” 550. FIG. 5B illustrates the inclusion of bounty hunters 550 within dual blockchain structures implemented in accordance with an embodiment of the invention. Bounty hunters 550 allow NFTs 510, which can point to networks that may include decentralized processing 520 and/or storage networks 530, to be monitored. The bounty hunter's 550 objective may be to locate incorrectly listed or missing data and executable code within the NFT 510 or associated networks. Additionally, the miner 540 can have the capacity to perform all necessary minting processes or any process within the architecture that involves a consensus mechanism.

Bounty hunters 550 may also choose to verify each step of a computation, and if they find an error, submit evidence of this in return for some reward. This can have the effect of invalidating the incorrect ledger entry and, potentially based on policies, all subsequent ledger entries. Such evidence can be submitted in a manner that is associated with a public key, in which the bounty hunter 550 proves knowledge of the error, thereby assigning value (namely the bounty) with the public key.

Assertions made by bounty hunters 550 may be provided directly to miners 540 by broadcasting the assertion. Assertions may be broadcast in a manner including, but not limited to posting it to a bulletin board. In some embodiments of the invention, assertions may be posted to ledgers of blockchains, for instance, the blockchain on which the miners 540 operate. If the evidence in question has not been submitted before, this can automatically invalidate the ledger entry that is proven wrong and provide the bounty hunter 550 with some benefit.

Applications and methods in accordance with various embodiments of the invention are not limited to use within NFT platforms. Accordingly, it should be appreciated that the capabilities of any blockchain configuration described herein can also be implemented outside the context of an NFT platform network architecture unrelated to the storage of fungible tokens and/or NFTs. A variety of components, mechanisms, and blockchain configurations that can be utilized within NFT platforms are discussed further below. Moreover, any of the blockchain configurations described herein with reference to FIGS. 3-5B (including permissioned, permissionless, and/or hybrid mechanisms) can be utilized within any of the networks implemented within the NFT platforms described above.

### NFT Platforms Consensus Mechanisms

NFT platforms in accordance with many embodiments of the invention can depend on consensus mechanisms to achieve agreement on network state, through proof resolution, to validate transactions. In accordance with many embodiments of the invention, Proof of Work (PoW) mechanisms may be used as a means of demonstrating non-trivial allocations of processing power. Proof of Space (PoS) mechanisms may be used as a means of demonstrating non-trivial allocations of memory or disk space. As a third possible approach, Proof of Stake mechanisms may be used as a means of demonstrating non-trivial allocations of fungible tokens and/or NFTs as a form of collateral. Numerous consensus mechanisms are possible in accordance with various embodiments of the invention, some of which are expounded on below.

Traditional mining schemes, such as Bitcoin, are based on Proof of Work, based on performing the aforementioned large computational tasks. The cost of such tasks may not only be computational effort, but also energy expenditure, a significant environmental concern. To address this problem, mining methods operating in accordance with many embodiments of the invention may instead operate using Proof of Space mechanisms to accomplish network consensus, wherein the distinguishing factor can be memory rather than processing power. Specifically, Proof of Space mechanisms can perform this through network optimization challenges. In several embodiments the network optimization challenge may be selected from any of a number of different challenges appropriate to the requirements of specific applications including graph pebbling. In some embodiments, graph pebbling may refer to a resource allocation game played on discrete mathematics graphs, ending with a labeled graph disclosing how a player might get at least one pebble to every vertex of the graph.

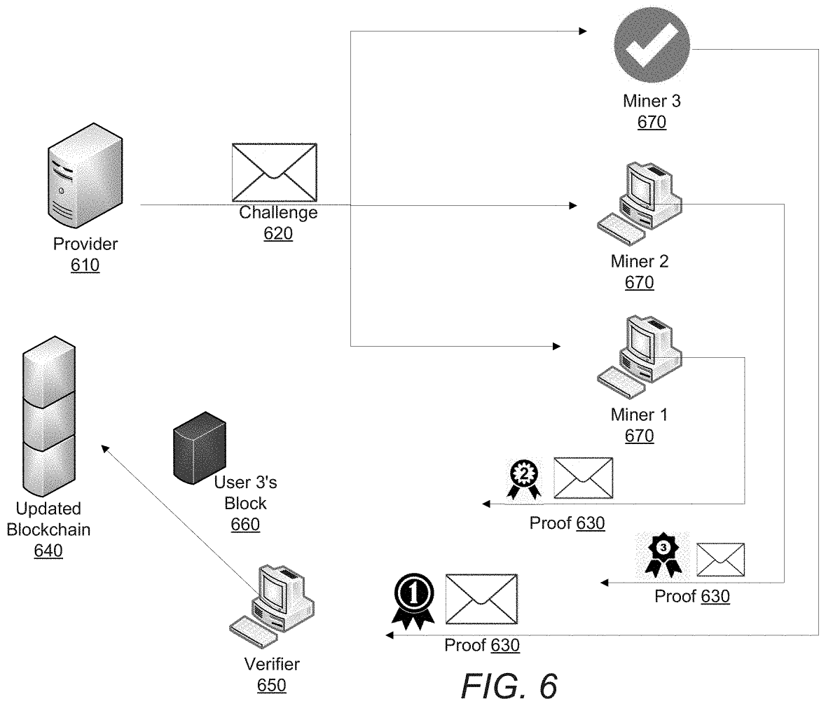

An example of Proof of Work consensus mechanisms that may be implemented in decentralized blockchains, in accordance with a number of embodiments of the invention, is conceptually illustrated in FIG. 6. The example disclosed in this figure is a challenge-response authentication, a protocol classification in which one party presents a complex problem (“challenge”) 610 and another party must broadcast a valid answer (“proof”) 620 to have clearance to add a block to the decentralized ledger that makes up the blockchain 630. As a number of miners may be competing to have this ability, there may be a need for determining factors for the addition to be added first, which in this case is processing power. Once an output is produced, verifiers 640 in the network can verify the proof, something which typically requires much less processing power, to determine the first device that would have the right to add the winning block 650 to the blockchain 630. As such, under a Proof of Work consensus mechanism, each miner involved can have a success probability proportional to the computational effort expended.

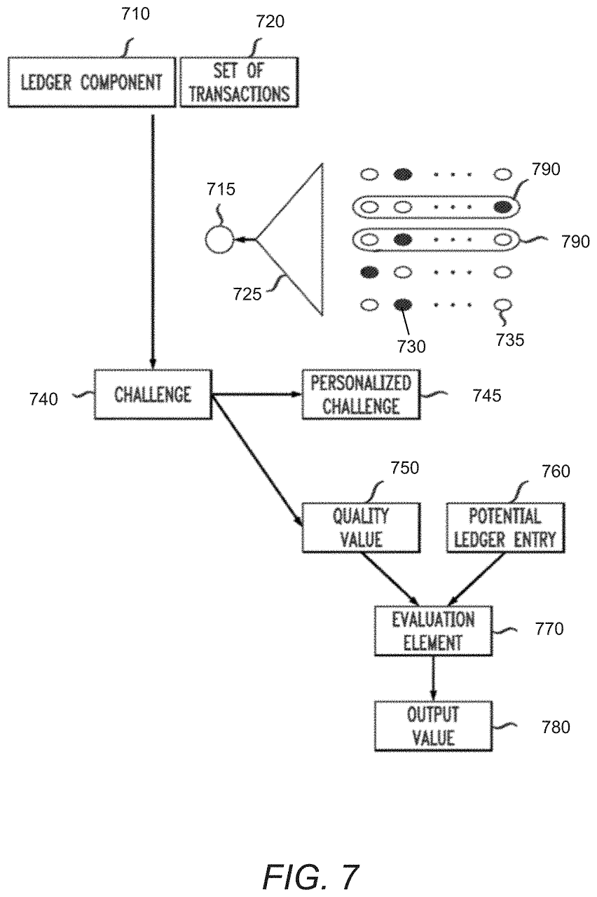

An example of Proof of Space implementations on devices in accordance with some embodiments of the invention is conceptually illustrated in FIG. 7. The implementation includes a ledger component 710, a set of transactions 720, and a challenge 740 computed from a portion of the ledger component 710. A representation 715 of a miner's state may also be recorded in the ledger component 710 and be publicly available.

In some embodiments, the material stored on the memory of the device includes a collection of nodes 730, 735, where nodes that depend on other nodes have values that are functions of the values of the associated nodes on which they depend. For example, functions may be one-way functions, such as cryptographic hash functions. In several embodiments the cryptographic hash function may be selected from any of a number of different cryptographic hash functions appropriate to the requirements of specific applications including (but not limited to) the SHA1 cryptographic hash function. In such an example, one node in the network may be a function of three other nodes. Moreover, the node may be computed by concatenating the values associated with these three nodes and applying the cryptographic hash function, assigning the result of the computation to the node depending on these three parent nodes. In this example, the nodes are arranged in rows, where two rows 790 are shown. The nodes are stored by the miner, and can be used to compute values at a setup time. This can be done using Merkle tree hash-based data structures 725, or another structure such as a compression function and/or a hash function.

Challenges 740 may be processed by the miner to obtain personalized challenges 745, made to the device according to the miner's storage capacity. The personalized challenge 745 can be the same or have a negligible change, but could also undergo an adjustment to account for the storage space accessible by the miner, as represented by the nodes the miner stores. For example, when the miner does not have a large amount of storage available or designated for use with the Proof of Space system, a personalized challenge 745 may adjust challenges 740 to take this into consideration, thereby making a personalized challenge 745 suitable for the miner's memory configuration.

In some embodiments, the personalized challenge 745 can indicate a selection of nodes 730, denoted in FIG. 7 by filled-in circles. In the FIG. 7 example specifically, the personalized challenge corresponds to one node per row. The collection of nodes selected as a result of computing the personalized challenge 745 can correspond to a valid potential ledger entry 760. However, here a quality value 750 (also referred to herein as a qualifying function value) can also be computed from the challenge 740, or from other public information that is preferably not under the control of any one miner.

A miner may perform matching evaluations 770 to determine whether the set of selected nodes 730 matches the quality value 750. This process can take into consideration what the memory constraints of the miner are, causing the evaluation 770 to succeed with a greater frequency for larger memory configurations than for smaller memory configurations. This can simultaneously level the playing field to make the likelihood of the evaluation 770 succeeding roughly proportional to the size of the memory used to store the nodes used by the miner. In some embodiments, non-proportional relationships may be created by modifying the function used to compute the quality value 750. When the evaluation 770 results in success, then the output value 780 may be used to confirm the suitability of the memory configuration and validate the corresponding transaction.

In many embodiments, nodes 730 and 735 can also correspond to public keys. The miner may submit valid ledger entries, corresponding to a challenge-response pair including one of these nodes. In that case, public key values can become associated with the obtained NFT. As such, miners can use a corresponding secret/private key to sign transaction requests, such as purchases. Additionally, any type of digital signature can be used in this context, such as RSA signatures, Merkle signatures, DSS signatures, etc. Further, the nodes 730 and 735 may correspond to different public keys or to the same public key, the latter preferably augmented with a counter and/or other location indicator such as a matrix position indicator, as described above. Location indicators in accordance with many embodiments of the invention may be applied to point to locations within a given ledger. In accordance with some embodiments of the invention, numerous Proof of Space consensus configurations are possible, some of which are discussed below.

Hybrid methods of evaluating Proof of Space problems can also be implemented in accordance with many embodiments of the invention. In many embodiments, hybrid methods can be utilized that conceptually correspond to modifications of Proof of Space protocols in which extra effort is expanded to increase the probability of success, or to compress the amount of space that may be applied to the challenge. Both come at a cost of computational effort, thereby allowing miners to improve their odds of winning by spending greater computational effort. Accordingly, in many embodiments of the invention dual proof-based systems may be used to reduce said computational effort. Such systems may be applied to Proof of Work and Proof of Space schemes, as well as to any other type of mining-based scheme.

When utilizing dual proofs in accordance with various embodiments of the invention, the constituent proofs may have varying structures. For example, one may be based on Proof of Work, another on Proof of Space, and a third may be a system that relies on a trusted organization for controlling the operation, as opposed to relying on mining for the closing of ledgers. Yet other proof structures can be combined in this way. The result of the combination will inherit properties of its components. In many embodiments, the hybrid mechanism may incorporate a first and a second consensus mechanism. In several embodiments, the hybrid mechanism includes a first, a second, and a third consensus mechanisms. In a number of embodiments, the hybrid mechanism includes more than three consensus mechanisms. Any of these embodiments can utilize consensus mechanisms selected from the group including (but not limited to) Proof of Work, Proof of Space, and Proof of Stake without departing from the scope of the invention. Depending on how each component system is parametrized, different aspects of the inherited properties will dominate over other aspects.

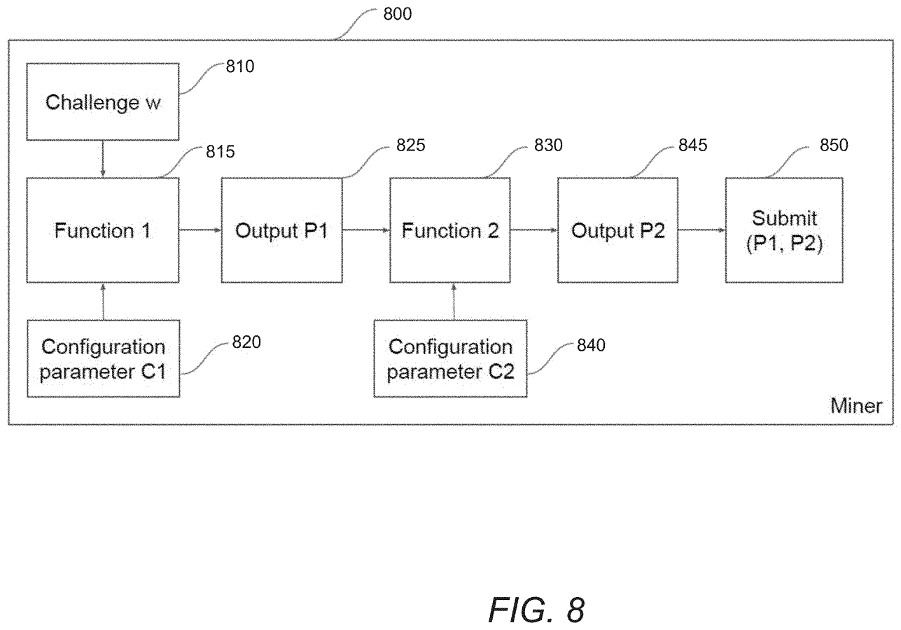

Dual proof configurations in accordance with a number of embodiments of the invention is illustrated in FIG. 8. A proof configuration in accordance with some embodiments of the invention may tend to use the notion of quality functions for tie-breaking among multiple competing correct proofs relative to a given challenge (w) 810. This classification of proof can be described as a qualitative proof, inclusive of proofs of work and proofs of space. In the example reflected in FIG. 8, proofs P1 and P2 are each one of a Proof of Work, Proof of Space, Proof of Stake, and/or any other proof related to a constrained resource, wherein P2 may be of a different type than P1, or may be of the same type.

Systems in accordance with many embodiments of the invention may introduce the notion of a qualifying proof, which, unlike qualitative proofs, are either valid or not valid, using no tie-breaking mechanism. Said systems may include a combination of one or more qualitative proofs and one or more qualifying proofs. For example, it may use one qualitative proof that is combined with one qualifying proof, where the qualifying proof is performed conditional on the successful creation of a qualitative proof. FIG. 8 illustrates challenge w 810, as described above, with a function 1 815, which is a qualitative function, and function 2 830, which is a qualifying function.

To stop miners from expending effort after a certain amount of effort has been spent, thereby reducing the environmental impact of mining, systems in accordance with a number of embodiments of the invention can constrain the search space for the mining effort. This can be done using a configuration parameter that controls the range of random or pseudo-random numbers that can be used in a proof. Upon challenge w 810 being issued to one or more miners 800, it can be input to Function 1 815 along with configuration parameter C1 820. Function 1 815 may output proof P1 825, in this example the qualifying proof to Function 2 830. Function 2 830 is also provided with configuration parameter C2 840 and computes qualifying proof P2 845. The miner 800 can then submit the combination of proofs (P1, P2) 850 to a verifier, in order to validate a ledger associated with challenge w 810. In some embodiments, miner 800 can also submit the proofs (P1, P2) 850 to be accessed by a 3rd-party verifier.

NFT platforms in accordance with many embodiments of the invention may additionally benefit from alternative energy-efficient consensus mechanisms. Therefore, computer systems in accordance with several embodiments of the invention may instead use consensus-based methods alongside or in place of proof-of-space and proof-of-space based mining. In particular, consensus mechanisms based instead on the existence of a Trusted Execution Environment (TEE), such as ARM TrustZone™ or Intel SGX™ may provide assurances exist of integrity by virtue of incorporating private/isolated processing environments.

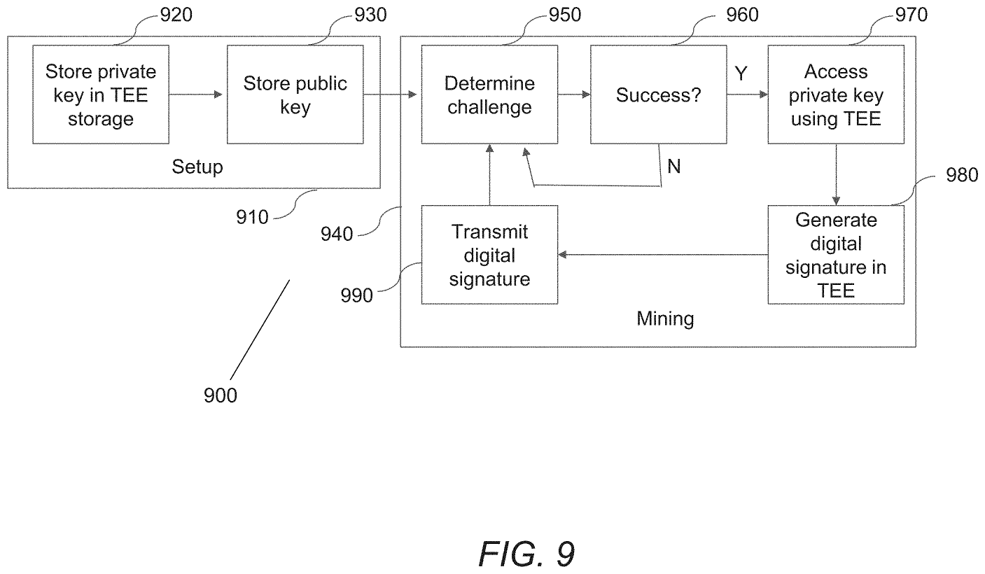

An illustration of sample process 900 undergone by TEE-based consensus mechanisms in accordance with some embodiments of the invention is depicted in FIG. 9. In some such configurations, a setup 910 may be performed by an original equipment manufacturer (OEM) or a party performing configurations of equipment provided by an OEM. Once a private key/public key pair is generated in the secure environment, process 900 may store (920) the private key in TEE storage (i.e. storage associated with the Trusted Execution Environment). While storage may be accessible from the TEE, it can be shielded from applications running outside the TEE. Additionally, processes can store (930) the public key associated with the TEE in any storage associated with the device containing the TEE. Unlike the private key, the public key may also be accessible from applications outside the TEE. In a number of embodiments, the public key may also be certified. Certification may come from OEMs or trusted entities associated with the OEMs, wherein the certificate can be stored with the public key.

In many embodiments of the invention, mining-directed steps can also be influenced by the TEE. In the illustrated embodiment, the process 900 can determine (950) a challenge. For example, this may be by computing a hash of the contents of a ledger. In doing so, process 900 may also determine whether the challenge corresponds to success 960. In some embodiments of the invention, the determination of success may result from some pre-set portion of the challenge matching a pre-set portion of the public key, e.g. the last 20 bits of the two values matching. In several embodiments the success determination mechanism may be selected from any of a number of alternate approaches appropriate to the requirements of specific applications. The matching conditions may also be modified over time. For example, modification may result from an announcement from a trusted party or based on a determination of a number of participants having reached a threshold value.

When the challenge does not correspond to a success 960, process 900 can return to determine (950) a new challenge. In this context, process 900 can determine (950) a new challenge after the ledger contents have been updated and/or a time-based observation is performed. In several embodiments the determination of a new challenge may come from any of a number of approaches appropriate to the requirements of specific applications, including, but not limited to, the observation of as a second elapsing since the last challenge. If the challenge corresponds to a success 960, then the processing can continue on to access (970) the private key using the TEE.

When the private key is accessed, process can generate (980) a digital signature using the TEE. The digital signature may be on a message that includes the challenge and/or which otherwise references the ledger entry being closed. Process 900 can also transmit (980) the digital signature to other participants implementing the consensus mechanism. In cases where multiple digital signatures are received and found to be valid, a tie-breaking mechanism can be used to evaluate the consensus. For example, one possible tie-breaking mechanism may be to select the winner as the party with the digital signature that represents the smallest numerical value when interpreted as a number. In several embodiments the tie-breaking mechanism may be selected from any of a number of alternate tie-breaking mechanisms appropriate to the requirements of specific applications.

Applications and methods in accordance with various embodiments of the invention are not limited to use within NFT platforms. Accordingly, it should be appreciated that consensus mechanisms described herein can also be implemented outside the context of an NFT platform network architecture unrelated to the storage of fungible tokens and/or NFTs. Moreover, any of the consensus mechanisms described herein with reference to FIGS. 6-9 (including Proof of Work, Proof of Space, Proof of Stake, and/or hybrid mechanisms) can be utilized within any of the blockchains implemented within the NFT platforms described above with reference to FIGS. 3-5B. Various systems and methods for implementing NFT platforms and applications in accordance with numerous embodiments of the invention are discussed further below.

### NFT Platforms Constituent Devices and Applications

A variety of computer systems that can be utilized within NFT platforms and systems that utilize NFT blockchains in accordance with various embodiments of the invention are illustrated below. The computer systems in accordance with many embodiments of the invention may implement a processing system 1010, 1120, 1220 using one or more CPUs, GPUs, ASICs, FPGAs, and/or any of a variety of other devices and/or combinations of devices that are typically utilized to perform digital computations. As can readily be appreciated each of these computer systems can be implemented using one or more of any of a variety of classes of computing devices including (but not limited to) mobile phone handsets, tablet computers, laptop computers, personal computers, gaming consoles, televisions, set top boxes and/or other classes of computing device.

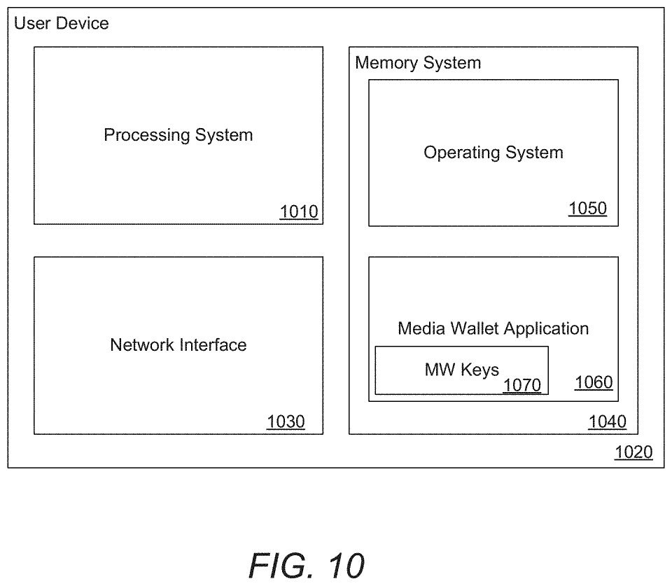

A user device capable of communicating with an NFT platform in accordance with an embodiment of the invention is illustrated in FIG. 10. The memory system 1040 of particular user devices may include an operating system 1050 and media wallet applications 1060. Media wallet applications may include sets of media wallet (MW) keys 1070 that can include public key/private key pairs. The set of MW keys may be used by the media wallet application to perform a variety of actions including, but not limited to, encrypting and signing data. In many embodiments, the media wallet application enables the user device to obtain and conduct transactions with respect to NFTs by communicating with an NFT blockchain via the network interface 1030. In some embodiments, the media wallet applications are capable of enabling the purchase of NFTs using fungible tokens via at least one distributed exchange. User devices may implement some or all of the various functions described above with reference to media wallet applications as appropriate to the requirements of a given application in accordance with various embodiments of the invention.

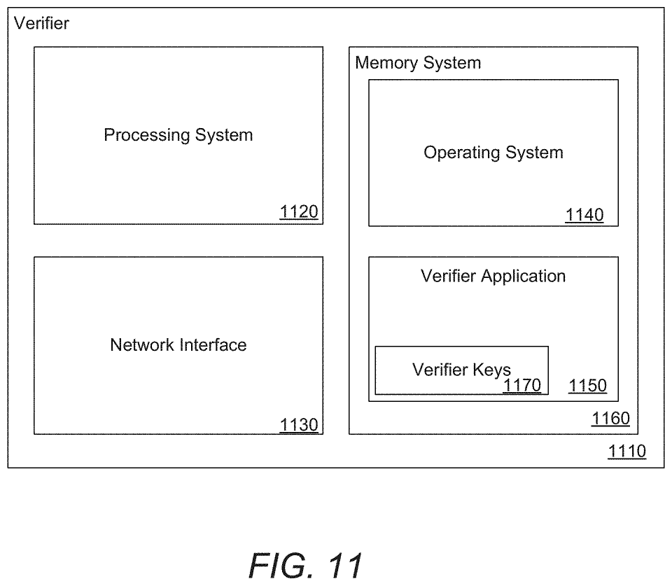

A verifier 1110 capable of verifying blockchain transactions in an NFT platform in accordance with many embodiments of the invention is illustrated in FIG. 11. The memory system 1160 of the verifier computer system includes an operating system 1140 and a verifier application 1150 that enables the verifier 1110 computer system to access a decentralized blockchain in accordance with various embodiments of the invention. Accordingly, the verifier application 1150 may utilize a set of verifier keys 1170 to affirm blockchain entries. When blockchain entries can be verified, the verifier application 1150 may transmit blocks to the corresponding blockchains. The verifier application 1150 can also implement some or all of the various functions described above with reference to verifiers as appropriate to the requirements of a given application in accordance with various embodiments of the invention.

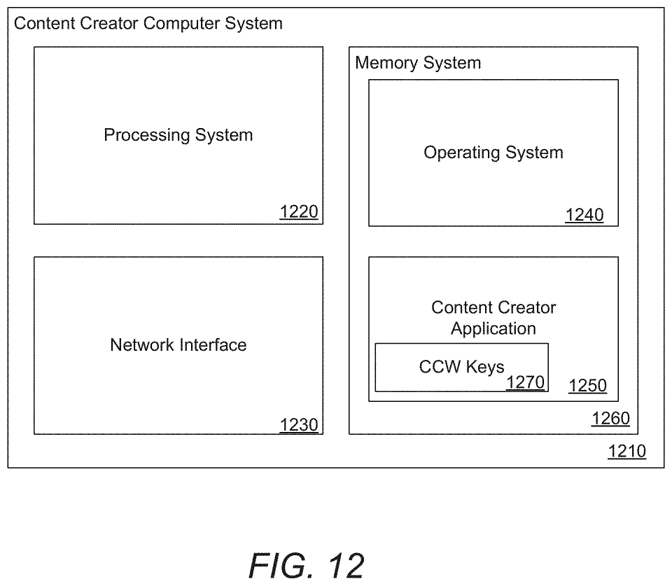

A content creator system 1210 capable of disseminating content in an NFT platform in accordance with an embodiment of the invention is illustrated in FIG. 12. The memory system 1260 of the content creator computer system may include an operating system 1240 and a content creator application 1250. The content creator application 1250 may enable the content creator computer system to mint NFTs by writing smart contracts to blockchains via the network interface 1230. The content creator application can include sets of content creator wallet (CCW) keys 1270 that can include a public key/private key pairs. Content creator applications may use these keys to sign NFTs minted by the content creator application. The content creator application can also implement some or all of the various functions described above with reference to content creators as appropriate to the requirements of a given application in accordance with various embodiments of the invention.

Computer systems in accordance with many embodiments of the invention incorporate digital wallets (herein also referred to as “wallets” or “media wallets”) for NFT and/or fungible token storage. In several embodiments, the digital wallet may securely store rich media NFTs and/or other tokens. Additionally, in some embodiments, the digital wallet may display user interface through which user instructions concerning data access permissions can be received.

In a number of embodiments of the invention, digital wallets may be used to store at least one type of token-directed content. Example content types may include, but are not limited to crypto currencies of one or more sorts; non-fungible tokens; and user profile data.

Example user profile data may incorporate logs of user actions. In accordance with some embodiments of the invention, example anonymized user profile data may include redacted, encrypted, and/or otherwise obfuscated user data. User profile data in accordance with some embodiments may include, but are not limited to, information related to classifications of interests, determinations of a post-advertisement purchases, and/or characterizations of wallet contents.

Media wallets, when storing content, may store direct references to content. Media wallets may also reference content through keys to decrypt and/or access the content. Media wallets may use such keys to additionally access metadata associated with the content. Example metadata may include, but is not limited to, classifications of content. In a number of embodiments, the classification metadata may govern access rights of other parties related to the content.

Access governance rights may include, but are not limited to, whether a party can indicate their relationship with the wallet; whether they can read summary data associated with the content; whether they have access to peruse the content; whether they can place bids to purchase the content; whether they can borrow the content, and/or whether they are biometrically authenticated.

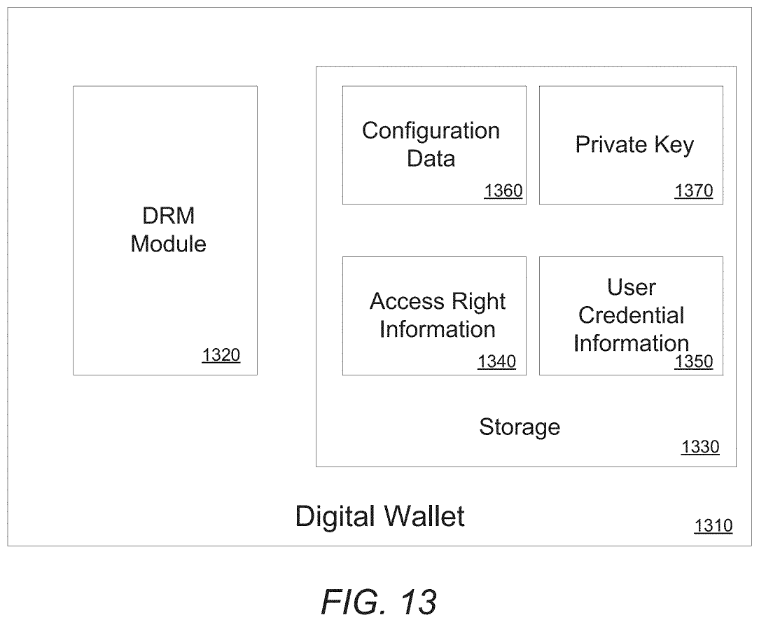

An example of a media wallet 1310 capable of storing rich media NFTs in accordance with an embodiment of the invention is illustrated in FIG. 13. Media wallets 1310 may include a storage component 1330, including access right information 1340, user credential information 1350, token configuration data 1360, and/or at least one private key 1370. In accordance with many embodiments of the invention, a private key 1370 may be used to perform a plurality of actions on resources, including but not limited to decrypting NFT and/or fungible token content. Media wallets may also correspond to a public key, referred to as a wallet address. An action performed by private keys 1370 may be used to prove access rights to digital rights management modules. Additionally, private keys 1370 may be applied to initiating ownership transfers and granting NFT and/or fungible token access to alternate wallets. In accordance with some embodiments, access right information 1340 may include lists of elements that the wallet 1310 has access to. Access right information 1340 may also express the type of access provided to the wallet. Sample types of access include, but are not limited to, the right to transfer NFT and/or fungible ownership, the right to play rich media associated with a given NFT, and the right to use an NFT and/or fungible token. Different rights may be governed by different cryptographic keys. Additionally, the access right information 1340 associated with a given wallet 1310 may utilize user credential information 1350 from the party providing access.

In accordance with many embodiments of the invention, third parties initiating actions corresponding to requesting access to a given NFT may require user credential information 1350 of the party providing access to be verified. User credential information 1350 may be taken from the group including, but not limited to, a digital signature, hashed passwords, PINs, and biometric credentials. User credential information 1350 may be stored in a manner accessible only to approved devices. In accordance with some embodiments of the invention, user credential information 1350 may be encrypted using a decryption key held by trusted hardware, such as a trusted execution environment. Upon verification, user credential information 1350 may be used to authenticate wallet access.

Available access rights may be determined by digital rights management (DRM) modules 1320 of wallets 1310. In the context of rich media, encryption may be used to secure content. As such, DRM systems may refer to technologies that control the distribution and use of keys required to decrypt and access content. DRM systems in accordance with many embodiments of the invention may require a trusted execution zone. Additionally, said systems may require one or more keys (typically a certificate containing a public key/private key pair) that can be used to communicate with and register with DRM servers. DRM modules 1320 in some embodiments may also use one or more keys to communicate with a DRM server. In several embodiments, the DRM modules 1320 may include code used for performing sensitive transactions for wallets including, but not limited to, content access. In accordance with a number of embodiments of the invention, the DRM module 1320 may execute in a Trusted Execution Environment. In a number of embodiments, the DRM may be facilitated by an Operating System (OS) that enables separation of processes and processing storage from other processes and their processing storage.

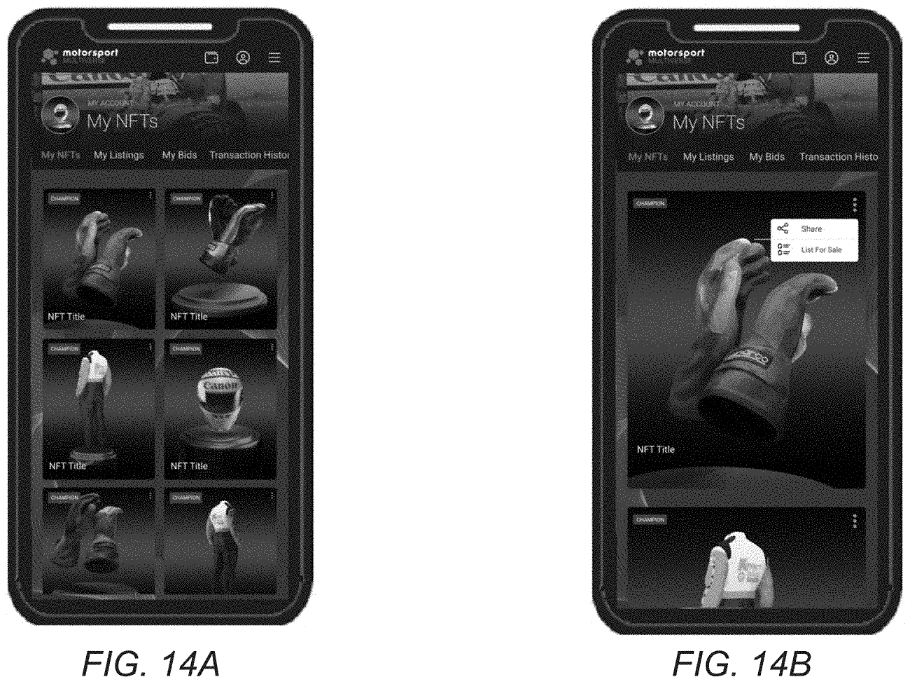

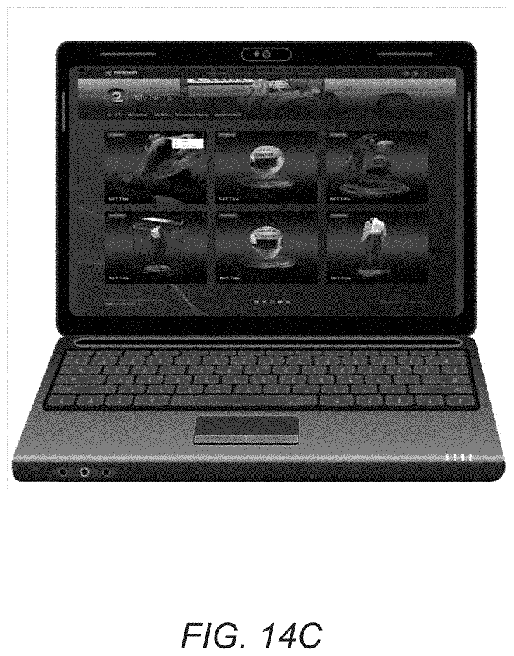

Operation of media wallet applications implemented in accordance with some embodiments of the invention is conceptually illustrated by way of the user interfaces shown in FIGS. 14A-14C. In many embodiments, media wallet applications can refer to applications that are installed upon user devices such as (but not limited to) mobile phones and tablet computers running the iOS, Android and/or similar operating systems. Launching media wallet applications can provide a number of user interface contexts. In many embodiments, transitions between these user interface contexts can be initiated in response to gestures including (but not limited to) swipe gestures received via a touch user interface. As can readily be appreciated, the specific manner in which user interfaces operate through media wallet applications is largely dependent upon the user input capabilities of the underlying user device. In several embodiments, a first user interface context is a dashboard (see, FIGS. 14A, 14C) that can include a gallery view of NFTs owned by the user. In several embodiments, the NFT listings can be organized into category index cards. Category index cards may include, but are not limited to digital merchandise/collectibles, special event access/digital tickets, fan leaderboards. In certain embodiments, a second user interface context (see, for example, FIG. 14B) may display individual NFTs. In a number of embodiments, each NFT can be main-staged in said display with its status and relevant information shown. Users can swipe through each collectible and interacting with the user interface can launch a collectible user interface enabling greater interaction with a particular collectible in a manner that can be determined based upon the smart contract underlying the NFT.

A participant of an NFT platform may use a digital wallet to classify wallet content, including NFTs, fungible tokens, content that is not expressed as tokens such as content that has not yet been minted but for which the wallet can initiate minting, and other non-token content, including executable content, webpages, configuration data, history files and logs. This classification may be performed using a visual user interface. Users interface may enable users to create a visual partition of a space. In some embodiments of the invention, a visual partition may in turn be partitioned into sub-partitions. In some embodiments, a partition of content may separate wallet content into content that is not visible to the outside world (“invisible partition”), and content that is visible at least to some extent by the outside world (“visible partition”). Some of the wallet content may require the wallet use to have an access code such as a password or a biometric credential to access, view the existence of, or perform transactions on. A visible partition may be subdivided into two or more partitions, where the first one corresponds to content that can be seen by anybody, the second partition corresponds to content that can be seen by members of a first group, and/or the third partition corresponds to content that can be seen by members of a second group.

For example, the first group may be users with which the user has created a bond, and invited to be able to see content. The second group may be users who have a membership and/or ownership that may not be controlled by the user. An example membership may be users who own non-fungible tokens (NFTs) from a particular content creator. Content elements, through icons representing the elements, may be relocated into various partitions of the space representing the user wallet. By doing so, content elements may be associated with access rights governed by rules and policies of the given partition.

One additional type of visibility may be partial visibility. Partial visibility can correspond to a capability to access metadata associated with an item, such as an NFT and/or a quantity of crypto funds, but not carry the capacity to read the content, lend it out, or transfer ownership of it. As applied to a video NFT, an observer to a partition with partial visibility may not be able to render the video being encoded in the NFT but see a still image of it and a description indicating its source.

Similarly, a party may have access to a first anonymized profile which states that the user associated with the wallet is associated with a given demographic. The party with this access may also be able to determine that a second anonymized profile including additional data is available for purchase. This second anonymized profile may be kept in a sub-partition to which only people who pay a fee have access, thereby expressing a form of membership. Alternatively, only users that have agreed to share usage logs, aspects of usage logs or parts thereof may be allowed to access a given sub-partition. By agreeing to share usage log information with the wallet comprising the sub-partition, this wallet learns of the profiles of users accessing various forms of content, allowing the wallet to customize content, including by incorporating advertisements, and to determine what content to acquire to attract users of certain demographics.

Another type of membership may be held by advertisers who have sent promotional content to the user. These advertisers may be allowed to access a partition that stores advertisement data. Such advertisement data may be encoded in the form of anonymized profiles. In a number of embodiments, a given sub-partition may be accessible only to the advertiser to whom the advertisement data pertains. Elements describing advertisement data may be automatically placed in their associated partitions, after permission has been given by the user. This partition may either be visible to the user. Visibility may also depend on a direct request to see “system partitions.” A first partition may correspond to material associated with a first set of public keys, a second partition to material associated with a second set of public keys not overlapping with the first set of public keys, wherein such material may comprise tokens such as crypto coins and NFTs. A third partition may correspond to usage data associated with the wallet user, and a fourth partition may correspond to demographic data and/or preference data associated with the wallet user. Yet other partitions may correspond to classifications of content, e.g., child-friendly vs. adult; classifications of whether associated items are for sale or not, etc.

The placing of content in a given partition may be performed by a drag-and-drop action performed on a visual interface. By selecting items and clusters and performing a drag-and-drop to another partition and/or to a sub-partition, the visual interface may allow movement including, but not limited to, one item, a cluster of items, and a multiplicity of items and clusters of items. The selection of items can be performed using a lasso approach in which items and partitions are circled as they are displayed. The selection of items may also be performed by alternative methods for selecting multiple items in a visual interface, as will be appreciated by a person of skill in the art.

Some content classifications may be automated in part or full. For example, when user place ten artifacts, such as NFTs describing in-game capabilities, in a particular partition, they may be asked if additional content that are also in-game capabilities should be automatically placed in the same partition as they are acquired and associated with the wallet. When “yes” is selected, then this placement may be automated in the future. When “yes, but confirm for each NFT” is selected, then users can be asked, for each automatically classified element, to confirm its placement. Before the user confirms, the element may remain in a queue that corresponds to not being visible to the outside world. When users decline given classifications, they may be asked whether alternative classifications should be automatically performed for such elements onwards. In some embodiments, the selection of alternative classifications may be based on manual user classification taking place subsequent to the refusal.

Automatic classification of elements may be used to perform associations with partitions and/or folders. The automatic classification may be based on machine learning (ML) techniques considering characteristics including, but not limited to, usage behaviors exhibited by the user relative to the content to be classified, labels associated with the content, usage statistics; and/or manual user classifications of related content.

Multiple views of wallets may also be accessible. One such view can correspond to the classifications described above, which indicates the actions and interactions others can perform relative to elements. Another view may correspond to a classification of content based on use, type, and/or users-specified criterion. For example, all game NFTs may be displayed in one collection view. The collection view may further subdivide the game NFTs into associations with different games or collections of games. Another collection may show all audio content, clustered based on genre. users-specified classification may be whether the content is for purposes of personal use, investment, or both. A content element may show up in multiple views. users can search the contents of his or her wallet by using search terms that result in potential matches.

Alternatively, the collection of content can be navigated based the described views of particular wallets, allowing access to content. Once a content element has been located, the content may be interacted with. For example, located content elements may be rendered. One view may be switched to another after a specific item is found. For example, this may occur through locating an item based on its genre and after the item is found, switching to the partitioned view described above. In some embodiments, wallet content may be rendered using two or more views in a simultaneous manner. They may also select items using one view.

Media wallet applications in accordance with various embodiments of the invention are not limited to use within NFT platforms. Accordingly, it should be appreciated that applications described herein can also be implemented outside the context of an NFT platform network architecture unrelated to the storage of fungible tokens and/or NFTs. Moreover, any of the computer systems described herein with reference to FIGS. 10-14C can be utilized within any of the NFT platforms described above.

### NFT Platforms NFT Interactions

NFT platforms in accordance with many embodiments of the invention may incorporate a wide variety of rich media NFT configurations. The term “Rich Media Non-Fungible Tokens” can be used to refer to blockchain-based cryptographic tokens created with respect to a specific piece of rich media content and which incorporate programmatically defined digital rights management. In some embodiments of the invention, each NFT may have a unique serial number and be associated with a smart contract defining an interface that enables the NFT to be managed, owned and/or traded.

Under a rich media blockchain in accordance with many embodiments of the invention, a wide variety of NFT configurations may be implemented. Some NFTs may be referred to as anchored NFTs (or anchored tokens), used to tie some element, such as a physical entity, to an identifier. Of this classification, one sub-category may be used to tie users' real-world identities and/or identifiers to a system identifier, such as a public key. In this disclosure, this type of NFT applied to identifying users, may be called a social NFT, identity NFT, identity token, and a social token. In accordance with many embodiments of the invention, an individual's personally identifiable characteristics may be contained, maintained, and managed throughout their lifetime so as to connect new information and/or NFTs to the individual's identity. A social NFT's information may include, but are not limited to, personally identifiable characteristics such as name, place and date of birth, and/or biometrics.

An example social NFT may assign a DNA print to a newborn's identity. In accordance with a number of embodiments of the invention, this first social NFT might then be used in the assignment process of a social security number NFT from the federal government. In some embodiments, the first social NFT may then be associated with some rights and capabilities, which may be expressed in other NFTs. Additional rights and capabilities may also be directly encoded in a policy of the social security number NFT.

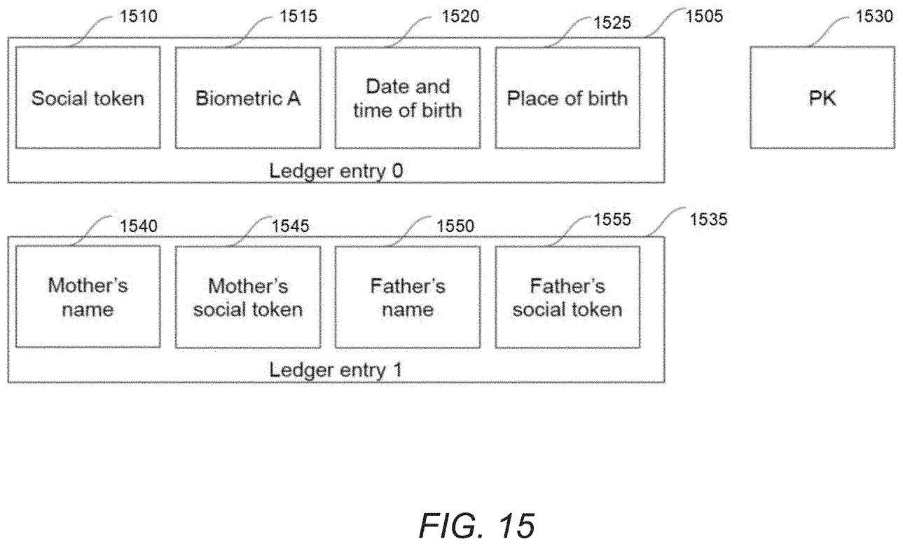

A social NFT may exist on a personalized branch of a centralized and/or decentralized blockchain. Ledger entries related to an individual's social NFT in accordance with several embodiments of the invention are depicted in FIG. 15. Ledger entries of this type may be used to build an immutable identity foundation whereby biometrics, birth and parental information are associated with an NFT. As such, this information may also be protected with encryption using a private key 1530. The initial entry in a ledger, “ledger entry 0” 1505, may represent a social token 1510 assignment to an individual with a biometric “A” 1515. In this embodiment, the biometric may include but is not limited to a footprint, a DNA print, and a fingerprint. The greater record may also include the individual's date and time of birth 1520 and place of birth 1525. A subsequent ledger entry 1 1535 may append parental information including but not limited to mothers' name 1540, mother's social token 1545, father's name 1550, and father's social token 1555.

In a number of embodiments, the various components that make up a social NFT may vary from situation to situation. In a number of embodiments, biometrics and/or parental information may be unavailable in a given situation and/or period of time. Other information including, but not limited to, race gender, and governmental number assignments such as social security numbers, may be desirable to include in the ledger. In a blockchain, future NFT creation may create a life-long ledger record of an individual's public and private activities. In accordance with some embodiments, the record may be associated with information including, but not limited to, identity, purchases, health and medical records, access NFTs, family records such as future offspring, marriages, familial history, photographs, videos, tax filings, and/or patent filings. The management and/or maintenance of an individual's biometrics throughout the individual's life may be immutably connected to the first social NFT given the use of a decentralized blockchain ledger.

In some embodiments, a certifying third party may generate an NFT associated with certain rights upon the occurrence of a specific event. In one such embodiment, the DMV may be the certifying party and generate an NFT associated with the right to drive a car upon issuing a traditional driver's license. In another embodiment, the certifying third party may be a bank that verifies a person's identity papers and generates an NFT in response to a successful verification. In a third embodiment, the certifying party may be a car manufacturer, who generates an NFT and associates it with the purchase and/or lease of a car.

In many embodiments, a rule may specify what types of policies the certifying party may associate with the NFT. Additionally, a non-certified entity may also generate an NFT and assert its validity. This may require putting up some form of security. In one example, security may come in the form of a conditional payment associated with the NFT generated by the non-certified entity. In this case, the conditional payment may be exchangeable for funds if abuse can be detected by a bounty hunter and/or some alternate entity. Non-certified entities may also relate to a publicly accessible reputation record describing the non-certified entity's reputability.

Anchored NFTs may additionally be applied to automatic enforcement of programming rules in resource transfers. NFTs of this type may be referred to as promise NFTs. A promise NFT may include an agreement expressed in a machine-readable form and/or in a human-accessible form. In a number of embodiments, the machine-readable and human-readable elements can be generated one from the other. In some embodiments, an agreement in a machine-readable form may include, but is not limited to, a policy and/or an executable script. In some embodiments, an agreement in a human-readable form may include, but is not limited to, a text and/or voice-based statement of the promise.

In some embodiments, regardless of whether the machine-readable and human-readable elements are generated from each other, one can be verified based on the other. Smart contracts including both machine-readable statements and human-accessible statements may also be used outside the implementation of promise NFTs. Moreover, promise NFTs may be used outside actions taken by individual NFTs and/or NFT-owners. In some embodiments, promise NFTs may relate to general conditions, and may be used as part of a marketplace.

In one such example, horse betting may be performed through generating a first promise NFT that offers a payment of $10 if a horse does not win. Payment may occur under the condition that the first promise NFT is matched with a second promise NFT that causes a transfer of funds to a public key specified with the first promise NFT if horse X wins.

A promise NFT may be associated with actions that cause the execution of a policy and/or rule indicated by the promise NFT. In some embodiments of the invention, a promise of paying a charity may be associated with the sharing of an NFT. In this embodiment, the associated promise NFT may identify a situation that satisfies the rule associated with the promise NFT, thereby causing the transfer of funds when the condition is satisfied (as described above). One method of implementation may be embedding in and/or associating a conditional payment with the promise NFT. A conditional payment NFT may induce a contract causing the transfer of funds by performing a match. In some such methods, the match may be between the promise NFT and inputs that identify that the conditions are satisfied, where said input can take the form of another NFT. In a number of embodiments, one or more NFTs may also relate to investment opportunities.

For example, a first NFT may represent a deed to a first building, and a second NFT a deed to a second building. Moreover, the deed represented by the first NFT may indicate that a first party owns the first property. The deed represented by the second NFT may indicate that a second party owns the second property. A third NFT may represent one or more valuations of the first building. The third NFT may in turn be associated with a fourth NFT that may represent credentials of a party performing such a valuation. A fifth NFT may represent one or more valuations of the second building. A sixth may represent the credentials of one of the parties performing a valuation. The fourth and sixth NFTs may be associated with one or more insurance policies, asserting that if the parties performing the valuation are mistaken beyond a specified error tolerance, then the insurer would pay up to a specified amount.

A seventh NFT may then represent a contract that relates to the planned acquisition of the second building by the first party, from the second party, at a specified price. The seventh NFT may make the contract conditional provided a sufficient investment and/or verification by a third party. A third party may evaluate the contract of the seventh NFT, and determine whether the terms are reasonable. After the evaluation, the third party may then verify the other NFTs to ensure that the terms stated in the contract of the seventh NFT agree. If the third party determines that the contract exceeds a threshold in terms of value to risk, as assessed in the seventh NFT, then executable elements of the seventh NFT may cause transfers of funds to an escrow party specified in the contract of the sixth NFT.

Alternatively, the first party may initiate the commitment of funds, conditional on the remaining funds being raised within a specified time interval. The commitment of funds may occur through posting the commitment to a ledger. Committing funds may produce smart contracts that are conditional on other events, namely the payments needed to complete the real estate transaction. The smart contract also may have one or more additional conditions associated with it. For example, an additional condition may be the reversal of the payment if, after a specified amount of time, the other funds have not been raised. Another condition may be related to the satisfactory completion of an inspection and/or additional valuation.

NFTs may also be used to assert ownership of virtual property. Virtual property in this instance may include, but is not limited to, rights associated with an NFT, rights associated with patents, and rights associated with pending patents. In a number of embodiments, the entities involved in property ownership may be engaged in fractional ownership. In some such embodiments, two parties may wish to purchase an expensive work of digital artwork represented by an NFT. The parties can enter into smart contracts to fund and purchase valuable works. After a purchase, an additional NFT may represent each party's contribution to the purchase and equivalent fractional share of ownership.

Another type of NFTs that may relate to anchored NFTs may be called “relative NFTs.” This may refer to NFTs that relate two or more NFTs to each other. Relative NFTs associated with social NFTs may include digital signatures that is verified using a public key of a specific social NFT. In some embodiments, an example of a relative NFT may be an assertion of presence in a specific location, by a person corresponding to the social NFT. This type of relative NFT may also be referred to as a location NFT and a presence NFT. Conversely, a signature verified using a public key embedded in a location NFT may be used as proof that an entity sensed by the location NFT is present. Relative NFTs are derived from other NFTs, namely those they relate to, and therefore may also be referred to as derived NFTs. An anchored NFT may tie to another NFT, which may make it both anchored and relative. An example of such may be called pseudonym NFTs.

Pseudonym NFTs may be a kind of relative NFT acting as a pseudonym identifier associated with a given social NFT. In some embodiments, pseudonym NFTs may, after a limited time and/or a limited number of transactions, be replaced by a newly derived NFTs expressing new pseudonym identifiers. This may disassociate users from a series of recorded events, each one of which may be associated with different pseudonym identifiers. A pseudonym NFT may include an identifier that is accessible to biometric verification NFTs. Biometric verification NFTs may be associated with a TEE and/or DRM which is associated with one or more biometric sensors. Pseudonym NFTs may be output by social NFTs and/or pseudonym NFTs.

Inheritance NFTs may be another form of relative NFTs, that transfers rights associated with a first NFT to a second NFT. For example, computers, represented by an anchored NFT that is related to a physical entity (the hardware), may have access rights to WiFi networks. When computers are replaced with newer models, users may want to maintain all old relationships, for the new computer. For example, users may want to retain WiFi hotspots. For this to be facilitated, a new computer can be represented by an inheritance NFT, inheriting rights from the anchored NFT related to the old computer. An inheritance NFT may acquire some or all pre-existing rights associated with the NFT of the old computer, and associate those with the NFT associated with the new computer.

More generally, multiple inheritance NFTs can be used to selectively transfer rights associated with one NFT to one or more NFTs, where such NFTs may correspond to users, devices, and/or other entities, when such assignments of rights are applicable. Inheritance NFTs can also be used to transfer property. One way to implement the transfer of property can be to create digital signatures using private keys. These private keys may be associated with NFTs associated with the rights. In accordance with a number of embodiments, transfer information may include the assignment of included rights, under what conditions the transfer may happen, and to what NFT(s) the transfer may happen. In this transfer, the assigned NFTs may be represented by identifies unique to these, such as public keys. The digital signature and message may then be in the form of an inheritance NFT, or part of an inheritance NFT. As rights are assigned, they may be transferred away from previous owners to new owners through respective NFTs. Access to financial resources is one such example.

However, sometimes rights may be assigned to new parties without taking the same rights away from the party (i.e., NFT) from which the rights come. One example of this may be the right to listen to a song, when a license to the song is sold by the artist to consumers. However, if the seller sells exclusive rights, this causes the seller not to have the rights anymore.

In accordance with many embodiments of the invention, multiple alternative NFT configurations may be implemented. One classification of NFT may be an employee NFT or employee token. Employee NFTs may be used by entities including, but not limited to, business employees, students, and organization members. Employee NFTs may operate in a manner analogous to key card photo identifications. In a number of embodiments, employee NFTs may reference information including, but not limited to, company information, employee identity information and/or individual identity NFTs.

Additionally, employee NFTs may include associated access NFT information including but not limited to, what portions of a building employees may access, and what computer system employees may utilize. In several embodiments, employee NFTs may incorporate their owner's biometrics, such as a face image. In a number of embodiments, employee NFTs may operate as a form of promise NFT. In some embodiments, employee NFT may comprise policies or rules of employing organization. In a number of embodiments, the employee NFT may reference a collection of other NFTs.

Another type of NFT may be referred to as the promotional NFT or promotional token. Promotional NFTs may be used to provide verification that promoters provide promotion winners with promised goods. In some embodiments, promotional NFTs may operate through decentralized applications for which access restricted to those using an identity NFT. The use of a smart contract with a promotional NFT may be used to allow for a verifiable release of winnings. These winnings may include, but are not limited to, cryptocurrency, money, and gift card NFTs useful to purchase specified goods. Smart contracts used alongside promotional NFTs may be constructed for winners selected through random number generation.

Another type of NFT may be called the script NFT or script token. Script tokens may incorporate script elements including, but not limited to, story scripts, plotlines, scene details, image elements, avatar models, sound profiles, and voice data for avatars. Script tokens may also utilize rules and policies that describe how script elements are combined. Script tokens may also include rightsholder information, including but not limited to, licensing and copyright information. Executable elements of script tokens may include instructions for how to process inputs; how to configure other elements associated with the script tokens; and how to process information from other tokens used in combination with script tokens.

Script tokens may be applied to generate presentations of information. In accordance with some embodiments, these presentations may be developed on devices including but not limited to traditional computers, mobile computers, and virtual reality display devices. Script tokens may be used to provide the content for game avatars, digital assistant avatars, and/or instructor avatars. Script tokens may comprise audio-visual information describing how input text is presented, along with the input text that provides the material to be presented. It may also comprise what may be thought of as the personality of the avatar, including how the avatar may react to various types of input from an associated user.

In some embodiments, script NFTs may be applied to govern behavior within an organization. For example, this may be done through digital signatures asserting the provenance of the scripts. Script NFTs may also, in full and/or in part, be generated by freelancers. For example, a text script related to a movie, an interactive experience, a tutorial, and/or other material, may be created by an individual content creator. This information may then be combined with a voice model or avatar model created by an established content producer. The information may then be combined with a background created by additional parties. Various content producers can generate parts of the content, allowing for large-scale content collaboration.

Features of other NFTs can be incorporated in a new NFT using techniques related to inheritance NFTs, and/or by making references to other NFTs. As script NFTs may consist of multiple elements, creators with special skills related to one particular element may generate and combine elements. This may be used to democratize not only the writing of storylines for content, but also outsourcing for content production. For each such element, an identifier establishing the origin or provenance of the element may be included. Policy elements can also be incorporated that identify the conditions under which a given script element may be used. Conditions may be related to, but are not limited to execution environments, trusts, licenses, logging, financial terms for use, and various requirements for the script NFTs. Requirements may concern, but are not limited to, what other types of elements the given element are compatible with, what is allowed to be combined with according the terms of service, and/or local copyright laws that must be obeyed.

Evaluation units may be used with various NFT classifications to collect information on their use. Evaluation units may take a graph representing subsets of existing NFTs and make inferences from the observed graph component. From this, valuable insights into NFT value may be derived. For example, evaluation units may be used to identify NFTs whose popularity is increasing or waning. In that context, popularity may be expressed as, but not limited to, the number of derivations of the NFT that are made; the number of renderings, executions or other uses are made; and the total revenue that is generated to one or more parties based on renderings, executions or other uses.

Evaluation units may make their determination through specific windows of time and/or specific collections of end-users associated with the consumption of NFT data in the NFTs. Evaluation units may limit assessments to specific NFTs (e.g. script NFTs). This may be applied to identify NFTs that are likely to be of interest to various users. In addition, the system may use rule-based approaches to identify NFTs of importance, wherein importance may be ascribed to, but is not limited to, the origination of the NFTs, the use of the NFTs, the velocity of content creation of identified clusters or classes, the actions taken by consumers of NFT, including reuse of NFTs, the lack of reuse of NFTs, and the increased or decreased use of NFTs in selected social networks.

Evaluations may be repurposed through recommendation mechanisms for individual content consumers and/or as content originators. Another example may address the identification of potential combination opportunities, by allowing ranking based on compatibility. Accordingly, content creators such as artists, musicians and programmers can identify how to make their content more desirable to intended target groups.

The generation of evaluations can be supported by methods including, but not limited to machine learning (ML) methods, artificial intelligence (AI) methods, and/or statistical methods. Anomaly detection methods developed to identify fraud can be repurposed to identify outliers. This can be done to flag abuse risks or to improve the evaluation effort.

Multiple competing evaluation units can make competing predictions using alternative and proprietary algorithms. Thus, different evaluation units may be created to identify different types of events to different types of subscribers, monetizing their insights related to the data they access.

In a number of embodiments, evaluation units may be a form of NFTs that derive insights from massive amounts of input data. Input data may correspond, but is not limited to the graph component being analyzed. Such NFTs may be referred to as evaluation unit NFTs.

The minting of NFTs may associate rights with first owners and/or with an optional one or more policies and protection modes. An example policy and/or protection mode directed to financial information may express royalty requirements. An example policy and/or protection mode directed to non-financial requirements may express restrictions on access and/or reproduction. An example policy directed to data collection may express listings of user information that may be collected and disseminated to other participants of the NFT platform.

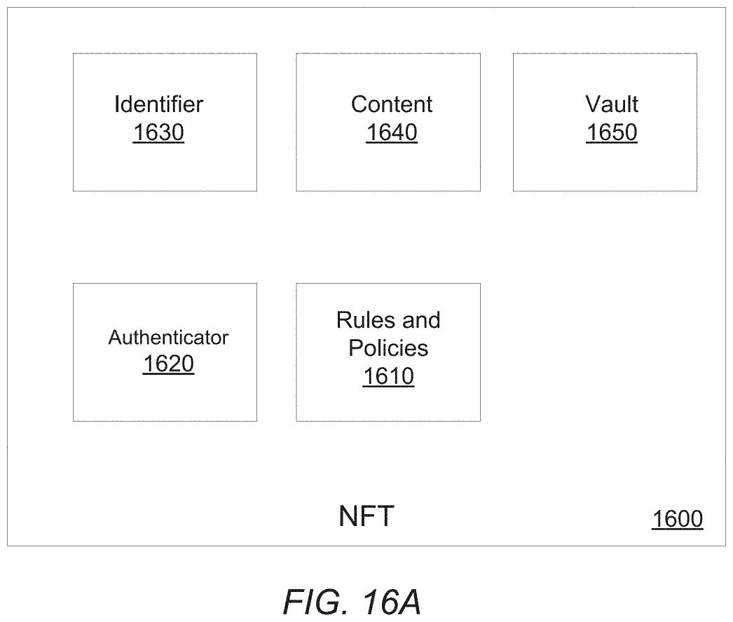

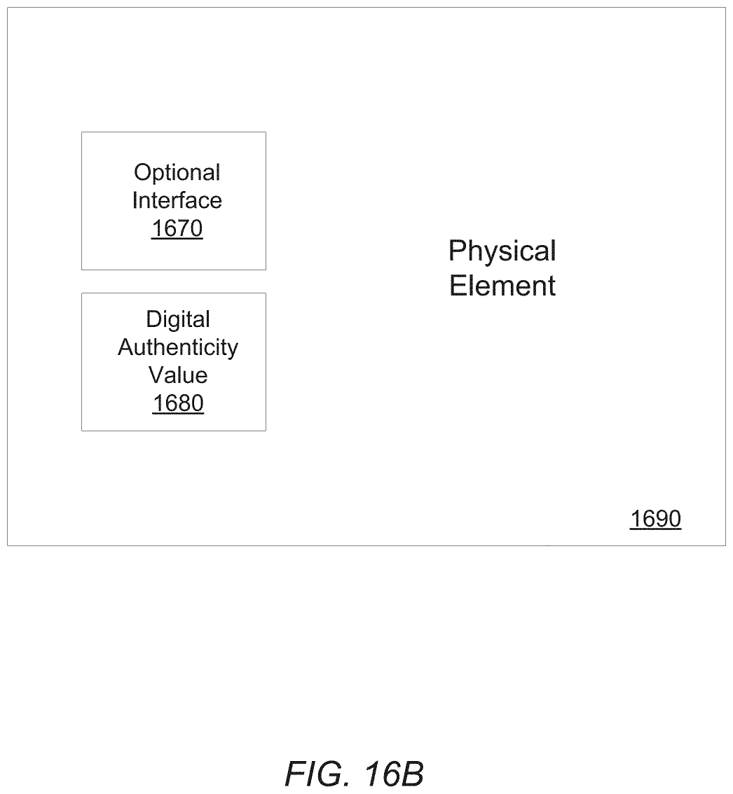

An example NFT which may be associated with specific content in accordance with several embodiments of the invention is illustrated in FIG. 16. In some embodiments, an NFT 1600 may utilize a vault 1650, which may control access to external data storage areas. Methods of controlling access may include, but are not limited to, user credential information 1350. In accordance with a number of embodiments of the invention, control access may be managed through encrypting content 1640. As such, NFTs 1600 can incorporate content 1640, which may be encrypted, not encrypted, yet otherwise accessible, or encrypted in part. In accordance with some embodiments, an NFT 1600 may be associated with one or more content 1640 elements, which may be contained in or referenced by the NFT. A content 1640 element may include, but is not limited to, an image, an audio file, a script, a biometric user identifier, and/or data derived from an alternative source. An example alternative source may be a hash of biometric information). An NFT 1600 may also include an authenticator 1620 capable of affirming that specific NFTs are valid.

In accordance with many embodiments of the invention, NFTs may include a number of rules and policies 1610. Rules and policies 1610 may include, but are not limited to access rights information 1340. In some embodiments, rules and policies 1610 may also state terms of usage, royalty requirements, and/or transfer restrictions. An NFT 1600 may also include an identifier 1630 to affirm ownership status. In accordance with many embodiments of the invention, ownership status may be expressed by linking the identifier 1630 to an address associated with a blockchain entry.

In accordance with a number of embodiments of the invention, NFTs may represent static creative content. NFTs may also be representative of dynamic creative content, which changes over time. In accordance with many examples of the invention, the content associated with an NFT may be a digital content element.

One example of a digital content element in accordance with some embodiments may be a set of five images of a mouse. In this example, the first image may be an image of the mouse being alive. The second may be an image of the mouse eating poison. The third may be an image of the mouse not feeling well. The fourth image may be of the mouse, dead. The fifth image may be of a decaying mouse.

The user credential information 1350 of an NFT may associate each image to an identity, such as of the artist. In accordance with a number of embodiments of the invention, NFT digital content can correspond to transitions from one representation (e.g., an image of the mouse, being alive) to another representation (e.g., of the mouse eating poison). In this disclosure, digital content transitioning from one representation to another may be referred to as a state change and/or an evolution. In a number of embodiments, an evolution may be triggered by the artist, by an event associated with the owner of the artwork, randomly, and/or by an external event.

When NFTs representing digital content are acquired in accordance with some embodiments of the invention, they may also be associated with the transfer of corresponding physical artwork, and/or the rights to said artwork. The first ownership records for NFTs may correspond to when the NFT was minted, at which time its ownership can be assigned to the content creator. Additionally, in the case of “lazy” minting, rights may be directly assigned to a buyer.

In some embodiments, as a piece of digital content evolves, it may also change its representation. The change in NFTs may also send a signal to an owner after it has evolved. In doing so, a signal may indicate that the owner has the right to acquire the physical content corresponding to the new state of the digital content. Under an earlier example, buying a live mouse artwork, as an NFT, may also carry the corresponding painting, and/or the rights to it. A physical embodiment of an artwork that corresponds to that same NFT may also be able to replace the physical artwork when the digital content of the NFT evolves. For example, should the live mouse artwork NFT change states to a decaying mouse, an exchange may be performed of the corresponding painting for a painting of a decaying mouse.

The validity of one of the elements, such as the physical element, can be governed by conditions related to an item with which it is associated. For example, a physical painting may have a digital authenticity value that attests to the identity of the content creator associated with the physical painting.

An example of a physical element 1690 corresponding to an NFT, in accordance with some embodiments of the invention is illustrated in FIG. 16. A physical element 1690 may be a physical artwork including, but not limited to, a drawing, a statue, and/or another physical representation of art. In a number of embodiments, physical representations of the content (which may correspond to a series of paintings) may each be embedded with a digital authenticity value (or a validator value) value. In accordance with many embodiments of the invention, a digital authenticity value (DAV) 1680 may be therefore be associated with a physical element 1690 and a digital element. A digital authenticity value may be a value that includes an identifier and a digital signature on the identifier. In some embodiments the identifier may specify information related to the creation of the content. This information may include the name of the artist, the identifier 1630 of the digital element corresponding to the physical content, a serial number, information such as when it was created, and/or a reference to a database in which sales data for the content is maintained. A digital signature element affirming the physical element may be made by the content creator and/or by an authority associating the content with the content creator.

In some embodiments, the digital authenticity value 1680 of the physical element 1690 can be expressed using a visible representation. The visible representation may be an optional physical interface 1670 taken from a group including, but not limited to, a barcode and a quick response (QR) code encoding the digital authenticity value. In some embodiments, the encoded value may also be represented in an authenticity database. Moreover, the physical interface 1670 may be physically associated with the physical element. One example of such may be a QR tag being glued to or printed on the back of a canvas. In some embodiments of the invention, the physical interface 1670 may be possible to physically disassociate from the physical item it is attached to. However, if a DAV 1680 is used to express authenticity of two or more physical items, the authenticity database may detect and block a new entry during the registration of the second of the two physical items. For example, if a very believable forgery is made of a painting the forged painting may not be considered authentic without the QR code associated with the digital element.

In a number of embodiments, the verification of the validity of a physical item, such as a piece of artwork, may be determined by scanning the DAV. In some embodiments, scanning the DAV may be used to determine whether ownership has already been assigned. Using techniques like this, each physical item can be associated with a control that prevents forgeries to be registered as legitimate, and therefore, makes them not valid. In the context of a content creator receiving a physical element from an owner, the content creator can deregister the physical element 1690 by causing its representation to be erased from the authenticity database used to track ownership. Alternatively, in the case of an immutable blockchain record, the ownership blockchain may be appended with new information. Additionally, in instances where the owner returns a physical element, such as a painting, to a content creator in order for the content creator to replace it with an “evolved” version, the owner may be required to transfer the ownership of the initial physical element to the content creator, and/or place the physical element in a stage of being evolved.

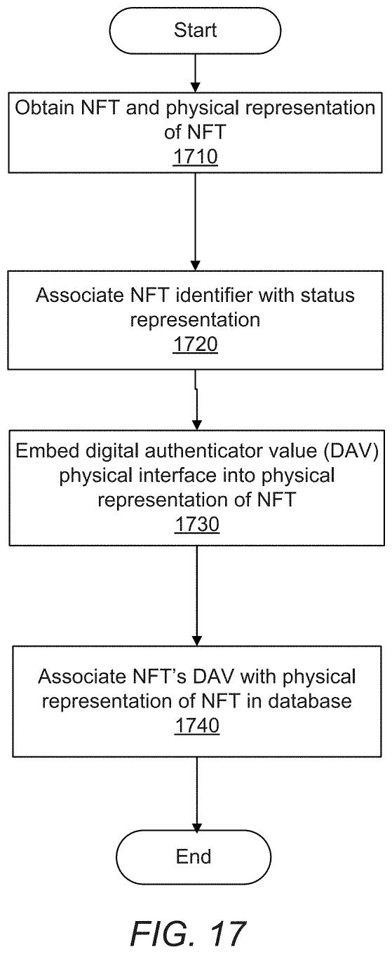

An example of a process for connecting an NFT digital element to physical content in accordance with some embodiments of the invention is illustrated in FIG. 17. Process 1700 may obtain (1710) an NFT and a physical representation of the NFT in connection with an NFT transaction. Under the earlier example, this may be a painting of a living mouse and an NFT of a living mouse. By virtue of establishing ownership of the NFT, the process 1700 may associate (1720) an NFT identifier with a status representation of the NFT. The NFT identifier may specify attributes including, but not limited to, the creator of the mouse painting and NFT (“Artist”), the blockchain the NFT is on (“NFT-Chain”), and an identifying value for the digital element (“no. 0001”). Meanwhile, the status representation may clarify the present state of the NFT (“alive mouse”). Process 1700 may also embed (1730) a DAV physical interface into the physical representation of the NFT. In a number of embodiments of the invention, this may be done by implanting a QR code into the back of the mouse painting. In affirming the connection between the NFT and painting, Process 1700 can associate (1740) the NFT's DAV with the physical representation of the NFT in a database. In some embodiments, the association can be performed through making note of the transaction and clarifying that it encapsulates both the mouse painting and the mouse NFT.

While specific processes are described above with reference to FIGS. 15-17, NFTs can be implemented in any of a number of different ways to enable as appropriate to the requirements of specific applications in accordance with various embodiments of the invention. Additionally, the specific manner in which NFTs can be utilized within NFT platforms in accordance with various embodiments of the invention is largely dependent upon the requirements of a given application.

### Providing Security Against Deception and Abuse in Distributed and Tokenized Environments

As digital resources, such as NFTs, proliferate, there may be attempts to imitate legitimate NFTs. There may also be attempts to impersonate known owners of known NFTs, attacks on applications that access and include NFTs, as well as middlemen known to buy and sell NFTs. These attacks may not be limited to a very small number of NFTs or entities associated with NFTs. Moreover, as NFTs are deployed to represent digital content in an ever-increasing number of contexts and disciplines, the growth of the opportunity to misrepresent both content and entities will be explosive. Criminals can rapidly move from one discipline to another, identifying recently large numbers of NFTs of potential value and posing as the owners of these.

The techniques used to block phishing attacks and BEC attacks (as well as other impersonation-based attacks) may not apply to impersonation and imitation related to digital resources, such as NFTs. Moreover, even if today's techniques could be applied to this problem, which they may not, the mere scale of the problem makes it unlikely to be possible to be addressed.

Moreover, since many NFTs are bought and sold using crypto payments, it may be natural for criminals also to request crypto payments when impersonating legitimate NFT owners or imitating legitimate NFTs. The victims, likewise, will likely already be users of crypto currencies. Any payment made with such a currency is non-recoverable in the case of fraud, as it is instantaneous, and commonly semi-anonymous as far as the criminal's identity goes. This will further worsen the problem by making monetization easier for criminals, therefore having the effect of throwing gasoline on a fire, the fire being the initial fraud problem. Similarly, as regular brick-and-mortar organizations start taking crypto payments or other instant-transfer payments, they are likely to be impersonated to end users, e.g., with consumers receiving messages appearing to come from their local utility company, asking for payment of the electricity bill using such instant-transfer payments. Brick-and-mortar stores that introduce QR codes to identify their crypto wallets may find the legitimate QR codes being replaced by the QR codes of criminals, whether crooked employees, contractors or customers with temporary physical access to the QR code display. These, and a variety of related types of abuse may lead to an urgent need to protect users against fraud.

### Identity Tokens

In many embodiments, NFT platforms can include security platforms that include identity tokens that can be utilized to provide a mechanism to address abuse associated with impersonation. In particular, in an attack, an attacker can impersonate a trusted entity, such as a marketplace or a famous NFT owner, and offers an intended victim to purchase an NFT. This can be one type of imitation, namely of the identity of this entity. In an example, the offered NFT may be an apparent clone of an NFT that is known to the intended victim, which is another type of imitation. In another example, the offered NFT may not be an apparent clone, but may seem appealing to the victim due to the apparent association with the apparent seller. The criminal may either initiate communication with the intended victim, or create an advertisement, e.g., on Craigslist™, Amazon™ or marketplaces developed for selling of NFTs, and waiting for the intended victim to contact them.

In many embodiments of the security platforms, to address abuse associated with impersonation of trusted entities, identity tokens can be used. Further details on identity tokens in accordance with many embodiments are disclosed in the U.S. patent application Ser. No. 17/808,264 filed Jun. 22, 2022 titled “Systems and Methods for Token Creation and Management”, by Markus Jakobsson and Stephen C. Gerber, which is herein incorporated by reference in its entirety.

In many embodiments of the security platforms, an identity token can tie an identity of an entity to the person. In many embodiments, a biometric template can be stored in another token, linked to the identity token, and can be used to prove that there is a person known to be associated with the identity of the identity token that is engaged in a transaction.

In cases where the identity may not be that of an individual but of an organization, access control tokens can be used to verify that a person known to be associated with the organization has satisfied an identity verification, e.g., using biometrics, among various other mechanisms, and may also have an employee token identifying their credentials and level of responsibility.

In many embodiments, identity tokens as well as authentication (e.g., using biometrics) can also be tied to pseudonyms such as email addresses, user identifications on different platforms (e.g., Twitter handles, Facebook names, among others), among various other user names and identities held by different services and platforms. Many embodiments of the security platforms can provide pseudonymous tokens or alias tokens. Thus, for example, a tentative seller can prove that they correspond to a given alias, such as the Twitter handle of a known NFT investor. In many embodiments, one or more such proofs related to different but linked identities and pseudonyms can be required in order to protect against attacks in which a criminal takes over a small number of aliases, e.g., using malware that performs man-in-the-middle attacks on the impersonation target for them to identify themselves using biometrics, seemingly for a legitimate reason. In several embodiments, the mechanism used for transfer or exchange of NFTs and funds can implement verification of identities relative to claimed identities in this manner.

Detecting Look-Alike Identities based on Reputation Scores

Many embodiments of the security platforms can detect identify fraud using various scoring mechanism and cross-checks across different types of information. In particular, a problem can be of criminals using look-alike identities, such as identities with minor and mostly undetectable differences to impersonated identities. For example, a criminal may register an alias “CarniveruosElephant”, posing as a user with the alias “CarniverousElephant”. The criminal would further associate an alias token with this alias to a biometric token or other authentication token for which they are able to successfully authenticate. Then, posing as “CarniveruosElephant”, the criminal may attempt to sell NFTs that the intended victim is likely to believe are associated with the better-known alias “CarniverousElephant”. In many embodiments, security platforms can detect that the claimed alias is similar to another existing alias. In many embodiments, security platforms can use a combination of different types of information from different sources.

In particular, the security platforms may also recognize that the other alias has a high recognition in the marketplace, e.g., by being associated with a high reputation, a large number of trades, several high-value trades, or a large number of social media posts among various other types of information indicative of reputation. The security platforms may identify that the seller may pose as the more recognized user, and alert the buyer to this risk. For example, the security platforms may notify a tentative buyer that “The seller, CarniveruosElephant, is a seller with a reputation of 1.4 out of 100, and with a recent complaint risk of 72 out of 100. This seller may at first appear to be the seller CarniverousElephant, which is known since 2019 and who has a reputation of 86 out of 100 and a recent complaint risk of 2 out of 100.”

In many embodiments, a reputation score may be computed from various different types of information, including the number of observed transactions, the duration of these transactions occurring, among various other types of information. In several embodiments of the security platforms, changes in velocity, e.g., rapid trend changes for any such inputs may be used to identify risk, e.g., of account take-over. In many embodiments, complaint scores may be associated with a number of complaints that have been filed, in relation to the number of transactions believed to be performed with users not associated with the user associated with the score. In several embodiments, security platforms may detect a shift in the value of the items being sold by a user (e.g., CarniveruosElephant) to detect abuse of the reputation system by a seller intentionally shifting from low-value legal products to high-value illegal products. In certain embodiments, two users may be believed to be associated with each other by comparing information from different sources. For example, two users may be associated with each other if they have the same IP address, the same hardware fingerprint, they have transacted extensively in the past, or similar types of information. The determination that two text strings, such as two names or aliases, are similar can be performed using the methods disclosed in U.S. Provisional Patent application Ser. No. 16/917197, filed Jun. 30, 20202, titled “DETECTING OF BUSINESS EMAIL COMPROMISE” by Markus Jakobsson, which is incorporated by reference in its entirety.

Authenticating NFTs and Preventing Sales of Illegal Copies using Registries

In many embodiments, security platforms can detect and prevent the sale of illegal copies of NFTs. In particular, criminals may attempt to sell NFTs or other tokens that are near-identical, to a typical human observer, to other NFTs. For example, consider an example situation in which artist A creates an artwork A1 and mints an NFT A2 from A1. Then, criminal B obtains a representation of A1, which may not be identical to A1 but which would be deemed to be a copy thereof from a legal perspective. For example, the criminal may create B1=f(A1), where f is a function that makes non-noticeable modifications, e.g., in the least significant bits of the input value, or which crops the input marginally. Alternatively, f may be the identity function, i.e., B1=A1. Criminal B then mints an NFT B2 from B1 and attempts to sell it.

To address these types of activities, in many embodiments, security platforms can create a registry of NFTs and compare newly observed NFTs to the entries in the registry. For example, the registry may include one entry related to NFT A2, where the entry includes a collection of metrics related to the associated artwork A1. The metrics can include a Fast Fourier Transform (FFT) of A1, a cryptographic hash of A1, a fuzzy hash related to A1, a spectrometry representation of A1, among various other metrics. If the NFT A2 is not a visual art piece, but an audio element, then the metrics may be the duration of the associated art piece A1, the FFT of A1, a description of the principal frames of A1, among various other metrics that can be utilized to authenticate audio. Many embodiments of the security platforms may use metrics similar to those used for copyright infringement on social media, detection of modifications of media, as is used in automated fake news detection, among various other techniques as appropriate to the requirements of specific applications in accordance with embodiments of the invention. An example approach to detect forged imagery, as is commonly used in fake news, was described in the 2019 publication titled “Content Authentication for Neural Imaging Pipelines: End-to-end Optimization of Photo Provenance in Complex Distribution Channels” by Pawel Korus and Nasir Memon, which is incorporated by reference in its entirety.

In many embodiments of the security platforms, the combination of metrics may evolve over time and be augmented as they do. For example, the registry record for A2 may include a reference to an associated art piece A1, which can be assessed over and over to determine new metrics. In many embodiments, more famous art pieces may use special-purpose metrics that can be costlier to evaluate and store, some of which may correspond to proprietary functions evaluated by third parties specializing in creating art piece fingerprints. It should be understood that the term “art piece” here should be interpreted in a broad sense, including any form of media content of value to recognize. Any form of digital content can be protected in an analogous manner. Some of the metrics in the record of the registry may not match a media file that has been marginally modified to evade detection. Therefore, many embodiments of the security platforms system can use multiple metrics. There can be a benefit to using multiple metrics and/or to maintaining the registry in a way that the exact metrics may not be disclosed, and often change.

In many embodiments of the security platforms, multiple competing registries may be used and contacted when a new NFT is detected. If a match is found, a comparison can be escalated, whether to another registry, or to a human operator tasked with verifying the correctness of a match. A registry may operate as a form of or in collaboration with a bounty hunter whose goal it is to detect abuse; it may also be used by an insurer that certifies content as likely original after having found it not to match registry entries. Registries can be funded by artists by being paid a percentage of revenues obtained from the sale of NFTs. When a user expresses interest in an NFT, the user can pay to have the NFT scanned in one or more registries, and pay a service fee for doing that. A seller may also provide a certificate of authenticity, which could be expressed in the form of a certificate token. This certificate token can be produced by one or more trusted entities collaborating with the one or more registries.

Technology for managing bounty hunters was introduced in U.S. patent application Ser. No. 17/806,065 filed Jun. 8, 2022 titled “Systems and Methods for Maintenance of NFT Assets”, by Markus Jakobsson, Stephen C. Gerber, and Guy Stewart, which is herein incorporated by reference in its entirety. Accordingly, registry services may fit well with NFT asset hosting services, decentralized ledger and hosting services, and especially those assets hosted that incur a regular NFT smart contract payment for hosting.

Decentralized systems, such as public ledgers, decentralized storage systems, and NFT technologies, are seemingly less capable of being policed by centralized authorities. White hat security individuals have historically performed testing of resources, such as penetration testing. Other individuals focus on open source software whereby a community of coders improves performance, features, and security of these systems. Bounty hunters are tasked with identifying problems, such as those associated with breach of contract. For instance, a bounty hunter may identify a missing asset that is not being hosted per contract, or an identity token that has been compromised. The lack of central authorities in decentralized systems begs for a system that is both high-integrity and self-policing. Bounty hunters are one form of self-policing whereby they are incentivized primarily through smart contract bounties. However, there are instances where self-policing may only come with a vigilante-style incentive. These individuals and organizations can be referred to as vigilantes. Vigilantes are incentivized by revenge and keeping society orderly, where contract incentives do not exist, but their ethical and moral standards generally represent the good of society rather than those of the criminals. Not every decentralized system will incentivize bounty hunters for every mission; the vision and resources required is likely beyond the scope of a system's designers. This can be where vigilantes can help decentralized systems remain orderly where centralized authorities may not exist. For example, an individual's identity token may, at some point, be associated with an illicit biometric token enabling a criminal to access a cryptocurrency wallet or NFT library. A vigilante may be able to correct the biometric token by reverting it to its correct token and recover funds or resources that may have been taken by the criminal. The vigilante may be offered a reward for successful resource recovery. What constitutes a vigilante may vary from jurisdiction to jurisdiction because of local laws. Additionally, vigilante activities may be heavily based on machine learning (ML) and artificial intelligence (AI) systems whereby expert coders configure systems to monitor for illicit activity, malware in tokens, etc.

Yet another problem is when a criminal creates an NFT from an art piece, or other type of content, which the criminal does not own, but which is not already represented as an NFT. This can be solved in a similar way to how NFT contents may be enshrined in a registry. However, while not all art pieces can be placed in such content registries, a large number can, whether by the request of the originators or by the registries scanning the internet for art pieces and other forms of content that should be protected and storing references to this, or the content itself, along with one or more easily searchable metrics associated to the content. If a match between a newly minted NFT and a recorded art piece is found, that can be indicative of one of the following events: (a) a false positive, e.g., a mistaken match; (b) a criminal attempt as described above, or (c) an instance in which an artist first creates and shares content, which is included in the registry, whether with the artist's knowledge or not, and then is incorporated, by the artist, in an NFT. Other related technology of relevance is disclosed in U.S. Provisional Patent Application Ser. No. 63/216,662 entitled “Pseudo-immutable blockchain method with Security and Privacy Enhancements” by Markus Jakobsson, as was incorporated by reference in its entirety above.

In many embodiments of the security platforms, the first case can be avoided by multiple verifications using multiple metrics and multiple registries, combined with an admin-type assessment, as described above. The admin may be a user such as a potential buyer, may be an employee of the registry, or may be a user performing a cloud-sourcing task, such as what users do on AMAZON™ MECHANICAL TURK™ (AMT). The third case can be resolved by the artist providing evidence of origination, such as proving that they control the domain from which the content was accessed by the registry; providing that they have access to an account that uploaded the content, etc. Whereas this may not be a fool-proof approach, it heuristically addresses the problem to a large extent, and can be used in combination with certifications, e.g., in the form of certification tokens, of other registered artists, and asserting that they know the origin of the content, and that it is that of the artist minting the NFT. This can be automatically adjudicated, or an admin can access reviews, reputations and assertions and make determinations. This is a possible task to be performed by bounty hunters as well. If both the first case and the third case can be precluded, that means that the NFT likely was created by a person who does not have rights to the material. Criminals may be dissuaded from attempting to do this by having to put up some amount of money as security when minting NFTs, where this money is rescinded if abuse is detected, otherwise returned along with an optional certification, e.g., in the form of a certification token.

Such certification tokens could include information about the entities involved in the assessment, the score of an assessment, and/or the date of the assessment. In numerous embodiments, certification tokens could be registered by being logged on a ledger, which also performs a time-stamping functionality. Such certification tokens may be helpful for sellers and buyers of content tokens, such as NFTs, as well as to any party wishing to license the content, determine the content's origin, and more. Thus, this process helps create certainty in the truthfulness of content, and its operation costs can be funded as a portion of sales and licenses related to such content. It can also be provided for free at the time of registration, with a proviso that if the content at any point becomes worth at least a threshold amount e.g., such as $500, as determined by a sale, then 10% of the sale amount is automatically paid to the service provider, or an umbrella organization of service providers. This would avoid front-loading of costs associated with the establishment of trust. The proviso could be expressed in the form of a smart contract element that is associated with the NFT or other content token, or with its registry entry.

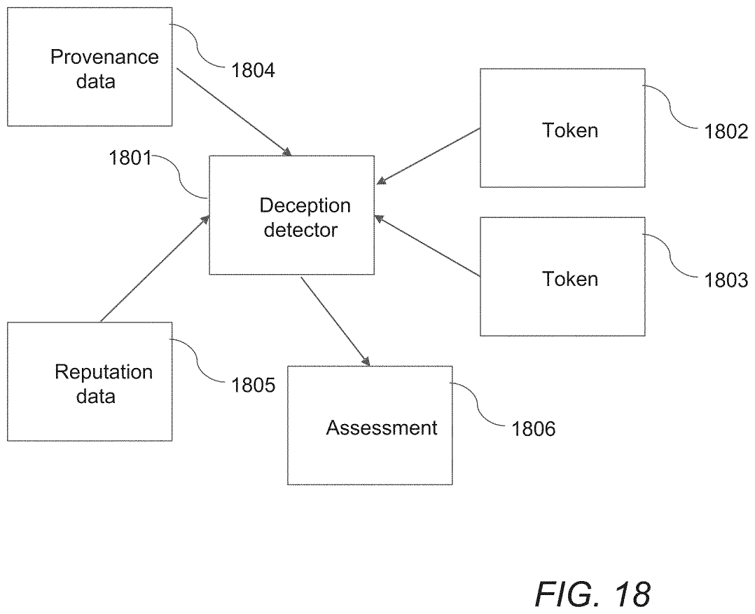

Security platforms in accordance with various embodiments of the invention can utilize a variety of data from different sources to assess the authenticity of a token. A deception detector in accordance with an embodiment of the invention is illustrated in FIG. 18. In particular, FIG. 18 illustrates a deception detector 1801, which may be represented as a token, taking as input token 1802 and token 1803 and assessing whether one of token 1802 and token 1803 is a deceptive version of the other, or of other known tokens (e.g., which can be stored as provenance data 1804, which may also include time stamps, origination data, and/or certification data among various other types of data). In many embodiments, deception detector 1801 uses reputation data 1805 among various other types of data that can be used to determine a confidence score for a transaction, which, like provenance data 1804, may be tokenized, and makes an assessment 1806, which may indicate that token 1802 is likely a deceptive version of token 1803; that both token 1802 and token 1803 are deceptive versions of known recorded tokens; that token 1803 has a weak certification chain; that token 1802 has a high reputation, among a variety of other assessments. A variety of assessments can be made, as will be understood by skilled artisans. Deception detector 1801 can take as input a larger number of inputs in addition to token 1802 and token 1803; the input to deception detector 1801 may include a stream of data or logs, some of which corresponds to tokens and other portions which do not. Deception detected may, as part of assessment 1806, output alerts and notifications, or may output logs or log entries that are taken as input by other executable tokens or services. Although a particular architecture for a deception detector is illustrated in FIG. 18, any of a variety of architectures that utilize different types of data from different sources can be utilized to detect and prevent illegal copying of tokens as appropriate to the requirements of specific applications in accordance with embodiments of the invention. Details for detecting and preventing other forms of fraudulent activity, including deceptive payments are described below.

### Deceptive Payments

Yet another problem relates to deceptive payment requests, e.g., by an impersonator of a service provider with which the intended victim has a relationship. There can be two versions of this problem: where the attacker has no relationship with the impersonated entity, and where he does. The first type can be referred to as an entity impersonation attempt. In the second scenario, the attacker may have an insider that works for or with the impersonated entity, or may have managed to place malware with the impersonated entity. This type of attack can be referred to as an insider-aided impersonation attempt. This disclosure addresses both of these attacks.

Simple impersonated entity attacks can be addressed based in part on certification tokens as described herein. When a person receives an invoice, e.g., with reference such as a clickable link, a QR code or other reference, the message (e.g., email, SMS, or camera scan of the QR code) initiates a verification of the request. In many embodiments of the security platforms, this verification includes identifying the payee based on the reference, to determine whether the associated party is associated with high risk, as described. This can be done using certification tokens, reputation tokens, and/or databases indicating past activity, past complaints, and more. A risk score can be generated and if the risk exceeds a threshold, which may be a system-established threshold or which may be set in part by or based on the user that is the tentative payer, then a warning can be generated. In addition, the context of the request can be determined. The context can include any associated message associated with the reference, past payment activity of the tentative payer, and/or other information associated with the payer. For example, if the payer has, in the past, sent payments to an entity with the handle “Acme Inc.” and now receives an invoice or other reference associated with a tentative payee with the handle “Acmee Inc.” or “Acme 1 nc.” or “Acme LLC”, then that is indicative of a high risk of abuse, since such a handle is likely to be misunderstood by typical users. Similarly, if the security platforms have indications that the tentative payer has done business with “Acme Inc.” in the past and received an indication of a payment from one of the look-alikes described above, then that is an indication of increased risk. An indication of past business may include (but is not limited to) the exchange of emails and/or the fact that many people in the tentative payer's zip code do business with “Acme Inc.”

In various embodiments, a second risk score can be generated based on the extent to which the reference has a relationship that is potentially a high risk of being misunderstood by the tentative payer. In many embodiments, the system also determines whether the tentative payee has a legitimate relationship with a payee that they are associated with the tentative payer (e.g., using certification tokens and identity tokens indicating that “Acme Inc.” and “Acme LLC” are owned by the same entity, “Acme Mothership”), which then is an indication of the second risk score not being relevant. If the reference is associated with a context, such as a message that has indications of risk, then this is also considered. For example, a message that has “Acme Inc.”'s logo but which is not from “Acme Inc.” could be a risk, but does not have to be. It may not be a risk if the email simply states that the sender is a seller of “Acme Inc.” products, but may be a risk if it states that the sender is “Acme Inc.”, whereas that is determined not to be true. This can a problem that is known to be difficult to resolve using traditional technology. Accordingly, in many embodiments of the security platforms, by combining it with the second risk score, which is an assessment of risk of deception, and an indication of what entity the reference is similar to, a better determination can be made. Namely, if there is a high deception risk score, associated with a claimed payee that looks like (but is not, based on trust token analysis, certification token analysis, etc.) “Acme Inc.”, and there are indications in the email associated with the reference that indicate “Acme Inc.” (e.g., using the use of their logo, their color palette, email layout, among various other types of information) then this can be an indication of risk that is added to the second risk score, which tracks the risk for deceptive use of brands. If a request is associated with a risk score that exceeds a first threshold, a warning may be presented. If the risk score exceeds a second threshold, any transfer of funds may be blocked from the tentative payer to the tentative payee, except if the tentative payer performs an involved configuration task in which they are warned of the risks of making the configuration changes, and where an admin associated with the tentative payer optionally gets notified of the configuration changes.

In the more complex case, an attacker mounts an insider-aided impersonation attempt, with the goal of tricking the security platforms to accept a reference as secure when it is not, e.g., based on an email being sent from an insider, such as “Joe Schmoe <joeschmoe@acmeinc.com>” with an invoice that looks like it comes from Acme, but where Joe Schmoe is not normally sending invoices on behalf of Acme Inc. Many other versions of this attack are possible, as will be understood by a skilled artisan, and the goal of these attacks is to corrupt the computation of the risk scores described above. To address this, the security platforms in accordance with many embodiments can use access right tokens that identify access rights to resources, such as a resource that corresponds to sending invoices. Thus, an organization can enable an employee or a role associated with one or more employees to perform sensitive tasks, such as sending invoices or making payments from the funds of the organization. This can be done by expressing the rights of the users in an access right token, as described in U.S. patent application Ser. No. 17/808,264 filed Jun. 22, 2022 titled “Systems and Methods for Token Creation and Management”, by Markus Jakobsson and Stephen C. Gerber, which is herein incorporated by reference in its entirety which is herein incorporated by reference in its entirety. A user that does not have the rights of initiating payments or payment requests but who does so can be blocked by the security platforms, or a recipient of a request associated with such a user can be provided a warning. In a number of embodiments, based on a policy that can be set by each organization, an admin may be notified of such an attempt, e.g., if “Joe Schmoe <joeschmoe@acmeinc.com>” sends invoices but is not authorized to do so, then an admin associated with Acme Inc. may be notified. In many embodiments, the capabilities of “Joe Schmoe <joeschmoe@acmeinc.com>” can be automatically rescinded if such abuse is detected, since that indicates that Joe Schmoe either is a rogue employee or has been corrupted, including his computer having been compromised by a hacker. In many embodiments, the rescinding of capabilities can be managed in a distributed manner, for each recipient organization and/or for each tentative payer, or a security representative thereof, and results in a blocking of messages from the rescinded accounts. In certain embodiments, it may result in the automatic blocking of payment requests with other parties, if the payment requests exhibit structural similarities to the one Joe Schmoe sent, and this is determined to be a look-alike payee request.

Filtering and alerting in accordance with certain embodiments of the invention can be performed using one or more security tokens, which may include executable tokens and tokens including rules and policies. A more thorough description of the use of tokens is provided in U.S. patent application Ser. No. 17/808,264 filed Jun. 22, 2022 titled “Systems and Methods for Token Creation and Management”, by Markus Jakobsson and Stephen C. Gerber, which is herein incorporated by reference in its entirety. The representation of the filters and alert generations may not have to be in the form of tokens, but could also be expressed in terms of client-side applications, server-side gateways and filters, and may utilize reputation databases, whether in the form of reputation tokens or in terms of free-standing databases. Thus, the expression of the filters can be modified as will be understood by a person of skill in the art. In many embodiments, security tokens, like other forms of tokens, can have a license associated with them, requiring a user to pay a fee for a period of use or for an instance of use, or based on another formula taking measured utilization as inputs; such evaluations can be performed in the token itself or in associated tokens; it may also be performed by associated tokens not executed on the same platforms as the security token, but providing some service to the security token. Competing service providers can provide similar services, and compete based on the manner in which these are performed, the speed or accuracy with which they are performed, and based on reputation scores associated with the services; these reputation scores can be automatically determined, e.g., based on user actions.

In many embodiments of the security platforms, if a user receives a message that is not blocked, but which should have been blocked, and the user accordingly indicates that the message is a spam message, a fraud message, a porn message, etc., this indication is communicated to a reputation collecting entity that may be another service-providing token, and applied to the service provider or service providers performing the service of screening, indicating that this was a false negative. Similarly, if users identify false positives, e.g., by going through their spam folder or being told by trusted collaborators that they are missing messages, then the user can create a complaint report, e.g., by pressing a button in a GUI, indicating that an important message was lost; this can be tallied as a false positive. The false positive numbers and the false negative numbers that are collected in this way can be absolute numbers. Sometimes, they can be estimated based on double-layer filtering where a second filter identifies shortcomings of a first filter.

In many embodiments of the security platforms, to generate error rates, the associated traffic volume is determined, e.g., by a reporting unit in an end-user device or token representing the display of messages, and the absolute counts divided by the full volume numbers including the detected false positives. This can permit automated comparison of the efficacy of security services. Such metrics, in several embodiments, also determine the seriousness of a failure. For example, a false negative for a ransomware attack is much more serious than a false negative for a spam message, just like a false positive is much more serious for a message from a colleague than for an unsolicited advertisement message. Each error can be assigned a weight. Then, when false positives and false negatives are reported, the system in accordance with several embodiments can determine the type of message these relate to and create a weighted false positive and weighted false negative count. This can be divided by a number that either represents the number of messages that were received, or should have been received; or the weighted number of such messages, where the same weights are applied to the delivered messages and reported by a client-side application.

In many embodiments of the security platforms, the determination of the nature of a message can be estimated based on historical interactions, based on user reactions such as whether the user rendered the message or rendered and interacted with the message, and/or based on explicit user reports associated with the message. Such metrics may be collected for some but not all users, where some users opt in to automatically provide some types of feedback but not others. A variety of such metrics may be used to automatically rate various competing services and associate scores or reputations with them. Users can use these scores or reputations to decide what services, corresponding for example to what security tokens, to use. In many embodiments, automated evaluations of services apply to other forms of service as well, and can be automatically scored based on domain-specific metrics of relevance. For example, two rendering applications can be compared based on A/B testing in which a large number of users use one of the rendering applications and implicit and/or explicit feedback is collected. One example of implicit feedback can include the duration a user spends using the rendering application, which, seen as a distribution, can enable the comparison of rendering applications. One example of explicit feedback is a user-provided rating, e.g., of the visual quality of a movie.

### Composite Tokens

In many embodiments of the security platforms, some services can provision tokens, such as the security tokens described, that are compositions of collaborating tokens, which can be referred to as composite tokens. In certain embodiments, a composite token may include a collection of several independent tokens (e.g., four independent security tokens). For example, a composite token can include four independent security tokens, referred to as A, B, C and D. Here, B and C may perform overlapping tasks, and report on any instance the other missed. A can perform another task that does not overlap with the tasks of B and C, but which complements them. D may receive metrics from tokens A, B and C, and can be in charge of providing configuration guidance to one or more of token A, B and C, thereby dynamically responding to changes in needs, and automatically identifying weaknesses and generating parameter changes to reduce the risks of error onwards. The errors may be weighted, as described, and may be based on an end-user subjective risk assessment provided to token D.

In many embodiments of the security platforms, the composite token can include independent tokens provided by different originators. Continuing with the example, a token A may be built with the knowledge that it may be used in combination with token B and C, and token B may be built to provide a free-standing service. Token C may be built as a low-cost version of token B, and included in the combination to test whether it has the same benefits as token B; this evaluation may be one of the tasks performed by token D. Thus, the provider of token D may be an entity that offers bundling and automated configuration, and where token D is in charge of evaluating the relative performance of various other tokens and to create the most efficient and affordable combinations, given various user need profiles. Accordingly, composite tokens in accordance with some embodiments of the invention can include various independent security tokens, where each can have different originators, tasks, capabilities, and/or responsibilities with respect to other tokens.

In many embodiments, tokens can collaborate and interact, and provide a modular design of the associated system in accordance with many embodiments can create benefits for society. The associated functionality can include a self-regulating token, where, for example, token D is the part of the self-regulating token performing modifications of functionality. In some embodiments, multiple tokens associated with one composite token may cause such modifications. Composite tokens are described in U.S. patent application Ser. No. 17/806,724, filed Jun. 13, 2022, entitled “Systems and Methods for Blockchain-Based Collaborative Content Generation” by Bjorn Jakobsson et a., which is incorporated by reference in its entirety.

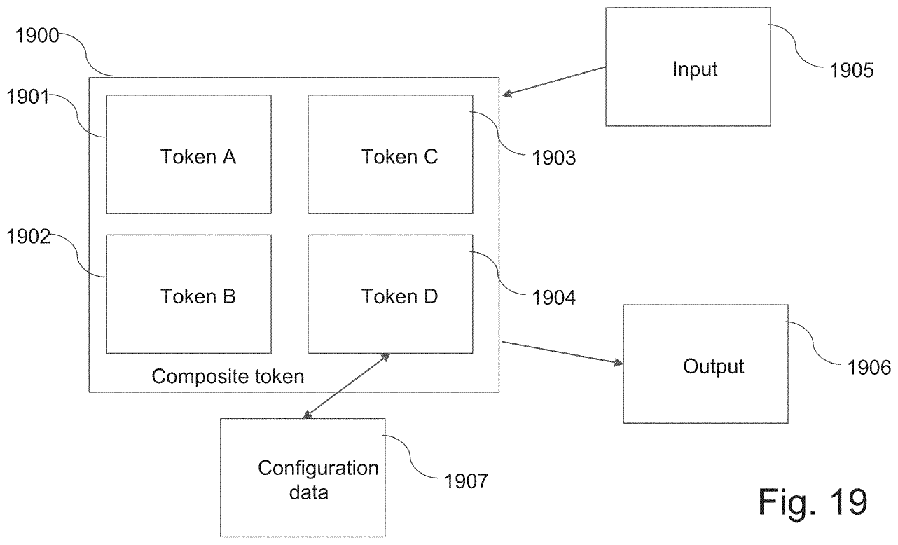

Security platforms in accordance with several embodiments of the invention can include meta-tokens that can be composites of several tokens forming a token mesh, with each token providing a specific set of capabilities and access to certain types of data. A meta-token in accordance with an embodiment of the is illustrated in FIG. 19. In particular, FIG. 19 illustrates a meta-token, in this case a composite token 1900, including four example tokens. Token A 1901 can perform a first computation on input 1905; token B 1902 can perform a second computation on input 1905; token C 1903 can perform a third computation on input 1905. Tokens A, B and C may operate on different portions of input 1905, on overlapping portions, and/or on the same portions. Token D 1904 can access the outputs (not shown) of token A 1901, token B 1902, and token C 1903, and can generate an aggregate output, output 1906. Token D can also consider the parameters governing the operation of token A 1901, token B 1902, and token C 1903, said parameters stored in configuration data 1907. In certain embodiments, the configuration data 1907 can be a part of composite token 1900. In several embodiments, the configuration data can be freestanding. The configuration data 1907 can determine whether parameters should be modified; if so, one or more tokens can convey updated parameters to other tokens. For example, token D 1904 can convey updated parameters to token A 1901, token B 1902, and token C 1903 and store the updated parameters in configuration data 1907, which may be in the form of a token. Composite token 1900 can be seen as a token mesh, with associated configuration data 1907. Based on the context, input 1905 and output 1906 may also be part of the token mesh. Although FIG. 19 illustrates a particular composite token that includes several tokens, any of a variety of composite token configurations with different configuration parameters, access rights, operational and computational capabilities can be utilized as appropriate to the requirements of specific applications in accordance with embodiments of the invention.

### Identity Token Protections Against Malware

In an abusive setting, an attacker may manage to create or take control over an identity token, e.g., by associating an illegitimate biometric token or other authentication token with the identity token, manipulating the access control token governing who can authenticate for a given functionality, or similar actions. This may be done using malware or social engineering. Alternatively, a forged identity token may be generated by a weak link in the certification chain used to create a certification token for an identity token, where this may be due to a weak pseudo-random generator, a breach, an insider attack, a nation-state attack on an entity creation certification tokens, among various other types of potential attacks. In many embodiments of the security platforms, this can be detected by analysis of changes (e.g., of recommendations, certifications, content including executable content, etc.) and where multiple changes co-occur within a window of time, among an analysis of various other types of information. Many embodiments of the security platforms can use an anomaly detection method, which can track the velocity of changes over time and correlate this to risk-related events, such as the change of the process or certification of the entity that produces the indications. Many embodiments of the security platforms can use machine learning (ML) and artificial intelligence (AI), which can be both well suited to detect such anomalies, as well as various statistical methods, as will be appreciated by skilled artisans.

### Malicious Tokens

Other forms of dangerous attacks can involve a malicious token, e.g., an executable token that carries malicious instructions, or a token with a policy that is undesirable or which exposes a user to risk. Malicious tokens can be introduced into a system in a variety of ways, including by malicious service providers creating them, marketing them or otherwise spreading them; or by a malicious actor taking control over a service provider that is benevolent, changing token content produced by this now-controlled entity, or swapping out references from one benevolent source (such as a benevolent token, or a database with legitimate content and references) to a malicious source (such as a malicious token, or a database with harmful content or references). Malicious tokens can be worse than traditional malware in many ways, as tokens naturally build on collaboration and distributed computing, and rely on a trust infrastructure that is supported by other tokens, such as certification tokens. Thus, while tokens can be more powerful than traditional computing structures, the increase in capabilities can also be accessible to malicious parties who successfully corrupt the infrastructure. Thus, detecting such abuse can be important. Accordingly, many embodiments provide for security platforms that can detect abuse by verifying certification chains.

### Certification Tokens

Similar to how an executable token may be certified using a certification token, certification tokens in accordance with a variety of embodiments of the invention may certify other certification tokens. Security platforms in accordance with many embodiment can include a certification token that includes a digital signature. In a number of embodiments, certification tokens may include other assessments of security and validity, some of which may be generated in real-time. To increase the protection against one of the tokens in such a chain being corrupted, many embodiments of the security platforms can require multiple certifications for a sensitive token, such as a security token or another token with broad access or capabilities to resources. In certain embodiments, however, if these resulting two or more chains of certifications intersect, that point of intersection may include a weak link, which can be undesirable, unless this link is known to be highly trustworthy and secure against compromise. Therefore, in many embodiments of the security platforms, assessments may be made of chains of certifications, and two or more such chains, determining whether each chain comprises only high-quality certification tokens, and whether the two or more chains are non-intersecting.

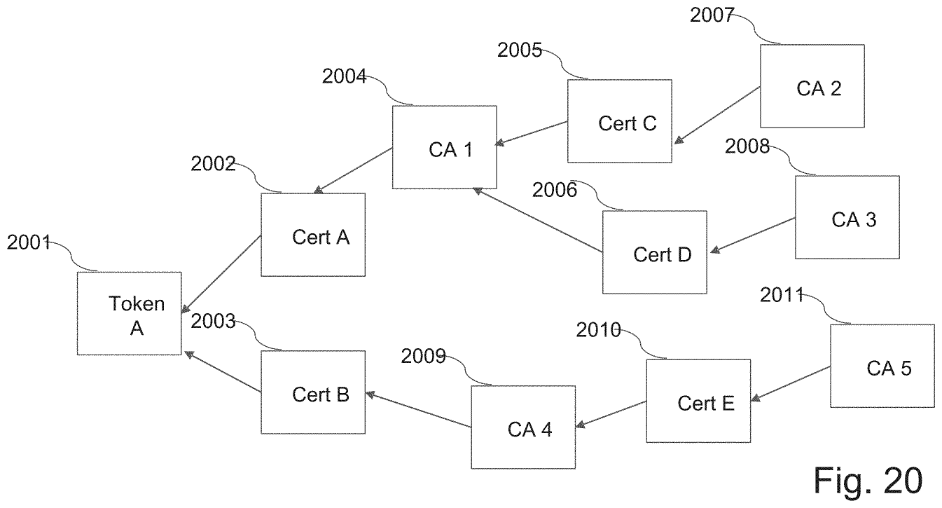

Security platforms in accordance with several embodiments of the invention can include chains of certification tokens to increase protection against abuse. An example of a token mesh of certification tokens in accordance with an embodiment of the invention is illustrated in FIG. 20. In particular, FIG. 20 illustrates an example token mesh including several certification tokens. Token A 2001 may be a token with executable content, a recommendation, a policy or another token as disclosed in U.S. patent application Ser. No. 17/808,264 filed Jun. 22, 2022 titled “Systems and Methods for Token Creation and Management”, by Markus Jakobsson and Stephen C. Gerber, which is herein incorporated by reference in its entirety.

As illustrated in FIG. 20, Token A 2001 can be certified using several certification tokens. In particular, two certification tokens, certification token cert A 2002 and certification token cert B 2003 can be used. Cert A 2002 may be generated by certification authority CA 1, 2004, which may be represented by a token but could also be a free-standing application that has not been tokenized. Certification authority CA 1, 2004 can be certified by certification authority CA 2, 2007 and certification authority CA 3, 2008, using certification token Cert C 2005 and Cert D 2006. Certification token cert B 2003 can be certified by certification authority CA 4, 2009, which in turn may be certified by CA 5, 2011, using certificate token Cert E 2010. Certification authorities CA 2, 2007, CA 3, 2008 and CA 5, 2011 may be root certificate authorities, or otherwise trusted by a verifier. Accordingly, Token A 2001 can be certified using several certification tokens, certification authorities providing a chain of certifications. Although FIG. 20 illustrates using a particular chain of certification authorities to certify tokens, any of a variety of configurations that include verifying tokens across multiple registries and/or certification authorities can be utilized as appropriate to the requirements of specific applications in accordance with embodiments of the invention.

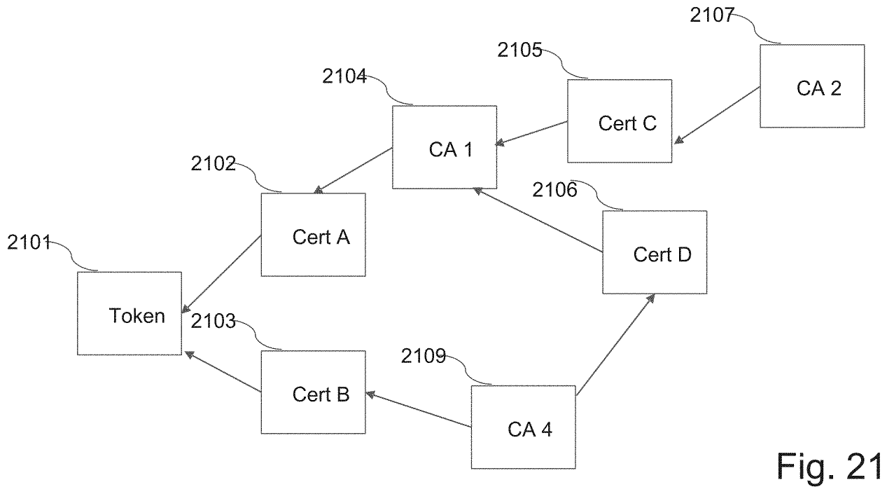

Security platforms in accordance with many embodiments can include a token mesh that includes determining the quality of a chain (e.g., strength/weakness) of the links between certification authorities and a token. A token mesh in accordance with an embodiments of the invention is illustrated in FIG. 21. In particular, FIG. 21 illustrates an example token mesh that includes certification tokens. As illustrated, certification authority CA 4, 2109, may be a weak link. If certification authority CA 4, 2109 were corrupted, then this could make certificate Cert B 203 not trustworthy, and also make certificate Cert D 2106 not trustworthy. Thus, the certification of token 2101 may rely singularly on certification authority CA 2, 2107 in such a situation. This corresponds to a weaker security assurance than the token mesh in FIG. 20, all other things, such as the reputation of the certification authorities, being the same. Accordingly, security platforms in accordance with many embodiments can dynamically determine the quality of different certification chains in order to determine risk factors with respect to a token. Although FIG. 21 illustrates a particular example of determining the quality of certification chains using several certification authorities, any of a variety of multi-chain configurations and analysis can be performed as appropriate to the requirements of specific applications in accordance with various embodiments of the invention.

In many embodiments of the security platforms, the quality of a chain can be assessed by determining the reputation of the associated token originators, as well as the contexts in which they are generated. For example, certification tokens run by well-known organizations with a history of defending against abuse, where the tokens are generated in trusted execution environments (TEEs) in the context of Digital Rights Management (DRM) environments may be considered higher quality than tokens generated by new-comer organizations, of whom little is known, and where the execution environment is not known. Since the certification token may have a real-time dynamic element that is generated in response to the security posture of the assessed token, recent events can be of relevance to consider when determining security scores of such units.

In many embodiments of the security platforms, a certification token may be generated by a service provision token, which may itself be certified by two or more other certification tokens. The longer the chain is, the higher the risk of one link in the chain being corrupted. At the same time, the more the certification structure fans out, using multiple non-intersecting paths, the better the security against corruption. As various originators of security assessments going into certification tokens may have different reputation, such reputations are also of importance. In many embodiments of the security platforms, these various factors can be preferably combined when a security assessment is made, one such security assessment being of a security token, and made in light to the risk of compromise of service provision tokens producing certification tokens.

In many embodiments of the security platforms, if such a service provider is breached, its private key may be used to generate digital signatures for certification tokens that should not be trusted. Since certification tokens may be time-stamped by being recorded on a ledger, old (and potentially not affected) tokens can be distinguished from new tokens that are affected by this breach. By determining when a potential breach may have taken place, an assessment can be made of when the certificate tokens no longer can be trusted. This assessment can be strengthened by determining, for two or more chains that contribute to one and the same final assessment of a token, whether there are risk-related events for each of these chain segments that potentially affects all the chains. In addition to using time-stamps to determine such risks, a forward-secure digital signature scheme can be used for the generation of digital signatures for the certification tokens. One such scheme was disclosed in the 1999 publication “A Forward-Secure Digital Signature Scheme” by Mihir Bellare and Sara K. Miner, and is incorporated by reference in its entirety.

### Recommendation Systems Using Token Mesh

Just like certification tokens can be used in multiple chains, forming a mesh of certifications to defend against abuse against the distributed maintenance of trust, such meshes can be used in the context of other assessments of importance. Such a structure can be referred to as a token mesh as described. Security platforms in accordance with several embodiments can also provide recommendations. The use of recommendations can be important in the context of maintaining security and integrity of a distributed system, and just like for the certification tokens, there can be a risk of compromise, whether by an outsider or an insider, of recommendation tokens. Therefore, the service providers that generate recommendation tokens may, in turn, be assessed by other entities that generate recommendation tokens describing the recommendation-token-generating entities. To reduce the risk of abuse, e.g., by one link in this chain devaluing or inflating a recommendation and therefore skewing the end result, it can be desirable to form recommendation meshes. In addition to the use of recommendation tokens for the assessment of service providers in such a mesh, these entities can also be certified, using certification tokens. Whereas a recommendation token may speak to the typical quality of service of an entity, certification can speak to the robustness of computation, and to the validity of a process, such as a process being what it is believed to be, as opposed to being corrupted or replaced, while the recommendation speaks to the quality of the service, when not compromised. Accordingly, in many embodiments of the security platforms, a mesh of recommendations can be commonly combined with a mesh of certifications.

In many embodiments of the security platforms, a way to generate an assessment from a mesh, whether of certificate tokens, recommendation tokens, and/or other tokens such as inheritance tokens, or a combination of such, it may be beneficial to use statistical methods that use weights that have been selected using machine learning (ML) methods. In several embodiments of the security platforms, the weights may be used in artificial intelligence (AI) assessments of complex meshes, where the assessment generates one or more scores. Scores in accordance with numerous embodiments of the invention may include (but are not limited to) cumulative trust scores related to certification, cumulative quality scores related to recommendation, and/or cumulative combinations of scores, corresponding, for example, to an estimated benevolence of a token in the context of a given environment. Environments in accordance with a number of embodiments of the invention may refer to (but are not limited to) a computational environment, a set of collaborating tokens, or a combination thereof.

In many embodiments of the security platforms, the quality and trustworthiness of a token mesh can be an important metric to determine and convey. However, quality may be relative to the needs of the user, where the user may be a human user, an enterprise, and/or one or more tokens consuming information generated by other tokens and other sources of information. Similarly, trustworthiness may be relative to the needs of the consumer of information. For example, one entity may, due to its exposure to risk, trust a large government-backed entity originating certificate tokens, whereas another, such as a political dissident, may fear government-backed entities. Many entities may not be able to enunciate what their risk exposure or concerns are. Some entities may have a large security budget, and therefore be able to consume very high-quality and highly trusted tokens and other information, independent of the cost of doing so, whether other entities may not be able to afford this. Some entities may consider their greatest exposure to be the reduction of productivity that may be the result of receiving irrelevant spam messages that distract employees. Such messages may include benevolent but irrelevant data, such as social network posts that do not help employees reach their productivity goals. Another organization may fear compromise by hackers, foreign governments, or similar, e.g., by malware-infested tokens or ransomware attacks.

Security platforms in accordance with several embodiments can provide a security service to automatically or semi-automatically assess the risks of a given entity, whether an individual, enterprise, part of an enterprise, or government agency, and to provide guidance, relative to risks and costs, of what token meshes would best address the needs of the entity. Security platforms can include a service provision token that performs personalized assessments and generates recommendations. In many embodiments, some such security-assessment tokens may require access to sensitive information of entities to be assessed to provide a higher-quality assessment, and thus, need to be trusted, whereas others may use only public data. The security and integrity of security platforms in accordance with many embodiments can be supported and maintained by a combination of components as those described herein. For example, security platforms in accordance with several embodiments may include one unit that assesses tokens and the similarity between these and other tokens, to assess the risk that one of these tokens may correspond to an attempt at impersonation, deception or similar. Security platforms can identify what tokens, among a collection of similar tokens, is most likely to be an original by analyzing trust indicators such as time-stamps, access logs, certification tokens, recommendation tokens and their assessments, among various other indicators. Security platforms can determine trustworthiness based on an element by element analysis and/or by considering token meshes. Thus, such techniques can be used to identify attempts at deception where one token is created or configured to deceive an end user or her organization to believe the token to be another token. Such protective measures can also be used to identify the introduction of malicious code, in the form of tokens or references made by tokens, or the corruption of previously benevolent tokens, changed to carry malicious content, such as code, policies or references. In addition, security platforms can include access control tokens and biometric tokens and use these to verify authorization to perform specified actions, such as sending invoices or receiving or dispersing funds on behalf of an organization. Such constructs can be referred to as authorization tokens, as they link a right to a physical identity.

Security platforms in accordance with many embodiments can create recommendations by the creation of assessments, e.g., in the form of recommendation tokens, certificate tokens, and/or derived tokens, including meta-data tokens. The integrity of such assessments can be verified in analogous manners. These can be supported by registries, which may be implemented in the form of tokens describing resources. Discrepancies and risks can be detected by bounty hunters. In some embodiments, structures can offer assurance in the form of insurance embodied in insurance tokens. Insurance tokens in accordance with several embodiments of the invention can be implemented using certification tokens backed by conditional payments controlled by policies, where the policies can be embodied in executable tokens expressing conditional contracts. In the context where recommendations are not created by automated algorithms alone, but also based on expert review and consideration, the identity of the expert can be associated with a recommendation and tied to the physical persona of the expert. Use of a combination of token elements for identities are disclosed in U.S. patent application Ser. No. 17/808,264 filed Jun. 22, 2022 titled “Systems and Methods for Token Creation and Management”, by Markus Jakobsson and Stephen C. Gerber, which is herein incorporated by reference in its entirety. Bounty hunters can be rewarded using the techniques disclosed in U.S. Prov. Patent Application Ser. No. 63/216,662 filed Jun. 30, 2021 entitled “Pseudo-immutable blockchain method”, by Markus Jakobsson, which is incorporated by reference in its entirety.

In many embodiments of the security platforms, security tokens can be created from one or more elements, such as tokens with executable contents, e.g., acting as a filter and having notification or alert and logging capabilities. Like security tokens, other types of tokens can also be created by composition of two or more tokens, representing different aspects of a computation, and/or exchanging information using pre-specified APIs or other interfaces associated with the tokens. These can be referred to as composite tokens as described. In many embodiments of security platforms, some token elements of these composite tokens may be configured to collect metrics from other tokens, to compare efficacy, and/or to identify modifications or re-configurations in the collection of tokens that together perform a service, such as a security service. This can enable dynamic changes of the composite tokens. Tokens, including composite tokens, with such capabilities can be referred to as dynamic tokens.

Security platforms in accordance with many embodiments can make assessments of what tokens to use as components. In many embodiments, assessments, such as (but not limited to) certifications and recommendations, can be determined from potentially interleaved token meshes. Token meshes in accordance with a number of embodiments of the invention may include executable elements that, in turn, are used to configure and maintain the integrity of the token mesh in light of contextual changes, environmental risks, and new information, including (but not limited to) new threat information, new risk information, and/or new metrics. Thus, token meshes may also be examples of composite tokens that have the nature of being able to self-modify, e.g., they are dynamic tokens as well. Accordingly, a skilled artisan will appreciate that the disclosed structures, which are highly configurable and provide a component-based approach to secure evaluation in distributed settings, are highly capable of addressing complex problems while drawing on certification and recommendation structures that, by themselves, can be described in the same manner. Security platforms in accordance with certain embodiments can provide a fractal composition of computational elements and data elements, including tokens carrying user-generated content, enabling the computational paradigm, and thus giving rise to a marketplace in which contributors can obtain license fees for tokens they originate, thereby fueling the commercial capabilities that these structures create. U.S. Provisional Patent Ser. No. 17/806,728 filed Jun. 13, 2022, entitled “Systems and Methods for Encrypting and Controlling Access to Encrypted Data Based Upon Immutable Ledgers” by Bjorn Markus Jakobsson, Stephen C. Gerber and Ajay Kapur described related technology, and is herein incorporated by reference in its entirety.

### Data Logging

In many embodiments of the security platforms, logging can be an important function as it enables the creation, e.g., of highly trusted entities, of metrics that can be used by less trusted entities to make assessments. Different entities can receive different access rights. For example, a first entity that is certified to be very secure can access potentially sensitive information related to a token, a token creator, or a token user, and generate a log, where the log includes entries that describe the scrutinized data. Whereas the scrutinized data may be sensitive and should not be disclosed to entities with lower trust ratings, the logs can include only data that is less sensitive or not sensitive at all, and therefore can be allowed for other entities to access. Data can be tokenized and encrypted, as described in U.S. patent application Ser. No. 17/808,264 filed Jun. 22, 2022 titled “Systems and Methods for Token Creation and Management”, by Markus Jakobsson and Stephen C. Gerber, which is herein incorporated by reference in its entirety, where only select entities can decrypt the data. Security platforms can make a determination based on identity, role, certification, and/or trust level, among various other factors. Security platforms in accordance with several embodiments can provide for managing this data, tokenized and encrypted information can be encrypted using a public key that is associated with an identity, e.g., of the party that can decrypt the token data. This may be a distributed party, such as a quorum of individually semi-trusted participants, where these parties may modify the key which the data is encrypted to by the selected entity. The encryption can also be identity based, e.g., as described in “Identity-Based Encryption from the Weil Pairing” by Dan Boneh and Matthew Franklin, a publication which is incorporated by reference in its entirety. Other forms of identity-based encryption (IBE) can also be used, as will be appreciated by a skilled artisan; one such other example is titled “Certificate-Based Encryption and the Certificate Revocation Problem”, by Craig Gentry, which is herein incorporated by reference in its entirety.

Security platforms in accordance with many embodiments can include access control that can be based on the use of a certified TEE or DRM system, or using other methods to select, based on a policy, who can access protected information. Some logs may not be encrypted, but include plaintext data. Whether encrypted, or otherwise protected, or not, the data in the logs can be authenticated by the party generating the log entry information. Security platforms can use digital signatures associated with the originator of a log entry, potentially associated with certification tokens proving the provenance of the data being analyzed, and/or the parties generating the log entry, where such parties may also be represented as tokens or by token meshes.

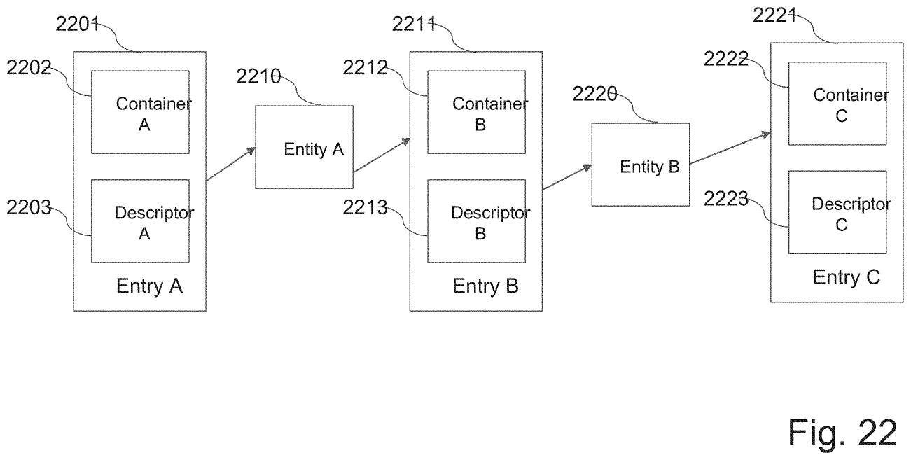

Security platforms that include management and generation of logs in accordance with an embodiment of the invention is illustrated in FIG. 22. In particular, FIG. 22 illustrates the generation of logs by a series of service providers. Different logs can have different rights with respect to access, decryption, processing, and these rights may be different for different entries. For example as illustrated in FIG. 22, a log including entry A 2201 can be accessed by entity A 2210, where entry A 2201 may be a token. Entry A 2201 can include container A 2202 and descriptor A 2203, both of which may also be tokens, or elements of a token. Descriptor A 2203 may indicate that entity A 2210 has access rights. Container A 2202 can be extracted by entity A 2210, where the extraction may include decryption. Entity A 2210 performs processing on data extracted from container A 2202, optionally using additional inputs (not shown), generating an entry B 2211 that is entered on a log or otherwise conveyed to entity B 2220. Entry B 2211 can include container B 2212 and descriptor B 2213, where descriptor B 2213 may indicate greater access rights than descriptor A 2203, but does not have to. Container B 2212 may be encrypted. Entity B 2220 performs processing on data extracted from container B 2212, optionally using additional inputs (not shown), generating an entry C 2221 including container C 2222 and descriptor C 2223. In some instances, entity A 2210 or entity B 2220 may cause outputs using a graphical user interface or other user interface. Although FIG. 22 illustrates a particular management and generation structure of logging with different rights for different entities, any of a variety of configurations can be utilized by different entities as appropriate to the requirements of specific applications in accordance with embodiments of the invention.

In many embodiments of the security platforms, logs may be time-stamped by being entered on a ledger, or using other time-stamping means. Security platforms in accordance with many embodiments can include logs that include log entries that correspond to tokenized data and also include data that has not been tokenized. In several embodiments of the security platforms, a first party performs a first analysis of some data, which may include tokens or their execution, as well as of externally obtained data including user input data, where this first party generated a first log that is encrypted and associated with an access control level that is less secure than the data being analyzed. The first log may include one or more tokens, some of which may be generated by other parties. A second party, which has a security clearance sufficient to be allowed access to the first log, accesses the data of the first log and analyzes it, creating a second log, with a yet-lower security clearance requirement. This second log may be encrypted, but may not be. Both the first party and the second party may access data and logs from multiple sources, and may use proprietary algorithms to assess the data. Parties such as the first and second party may, in addition to creating logs, also create notifications and alerts.

In many embodiments of the security platforms, logs can be created of multiple types. Security platforms can include logs that can be associated with different security levels of entry generation, entry access, encryption, locked access to different parities, and notification capabilities. For example, one party may create one log that is associated with a very high bar of security for access as well as another log that is associated with another and lower bar of security for access. One party may create a log that includes encrypted entries, and another log that includes plaintext entries. Some logs may be locked to a select party in the sense that this party is the only one allowed to produce log entries for that log, whereas other logs may be collaboratively generated by two or more parties, each one which may correspond to a token mesh. Some of the parties may convey notifications and alerts to end users using graphical user interfaces (GUIs).

Security platforms in accordance with several embodiments can include self-regulating tokens that can identify risk of attack on a crypto mining structure and can modify configuration files accordingly. For example, a self regulating token can identify a heightened risk of a (e.g., 51%) attack on a crypto mining structure, and can modify configuration files to strengthen against abuse, e.g., by re-balancing parameters determining the hardness of mining. Some aspects of this are disclosed in U.S. patent application Ser. No. 17/806,725 filed Jun. 13, 2022, entitled “Grinding Resistant Cryptographic Systems and Cryptographic Systems Based on Certified Miners” by Bjorn Markus Jakobsson, which is incorporated by reference. Self-regulating tokens in accordance with several embodiments of the security platforms may control mining and verification. Similar constructions can be used to address the distributed reconfiguration of tokens and other entities in response to other risks, as will be appreciated by a person of skill in the art.

### Systems and Methods of Resolving NFT Fraud and Theft

Many embodiments of NFT platforms can include security platforms that provide fraud detection for resolving NFT fraud and theft. Several embodiments of the security platforms provide for an evolutionary NFT controlled by an oracle that can enable the virtual destruction or replacement of a stolen NFT. Evolutionary NFTs are described in U.S. Patent Application Ser. No. 63/240,953 filed Sep. 5, 2021 entitled “Evolution of Tokenized Artwork” by Ajay Kapur, Markus Jakobsson, and Stephen C. Gerber; U.S. Patent Application Ser. No. 63/248,570 filed Sep. 27, 2021 entitled “Content Evolution Techniques” by Markus Jakobsson; U.S. Provisional Patent Application Ser. No. 63/255,032 filed Oct. 13, 2021 entitled “Non-Fungible Token Peeling” by Markus Jakobsson; U.S. Provisional Patent Application Ser. No. 63/275,713 filed Nov. 4, 2021, entitled “User-Specific Evolution, Spawning and Peeling” by Markus Jakobsson and Perry Cook; and U.S. Provisional Patent Application Ser. No. 63/311,322 filed Feb. 17, 2022 entitled “Methods for Assigning and Maintaining NFT Relationships” by Rebecca Fiebrink, Mike Leisz, and Ajay Kapur, which are herein incorporated by reference in their entireties.

Security platforms in accordance with several embodiments can include an oracle that is configured to update the URI and/or metadata of a given NFT such that the asset appears to have evolved from the NFT holder's perspective. Security platforms in accordance with several embodiments may be utilized to improve the NFT assets, as described in the co-pending applications listed above. In certain embodiments, security platforms may be utilized to deprecate an asset, such as when it is identified as fraudulent or stolen. Security platforms can modify an NFT asset by disconnecting the asset, depreciating the asset, changing the URI of the asset, modifying the metadata, among other modifications.

For example, an NFT may be minted and sold to a buyer, who becomes the NFT holder. If the asset underlying the NFT is later determined to have been issued fraudulently, by a creator that does not have the rights to the underlying NFT asset, security platforms in accordance with many embodiments can modify the NFT asset where the NFT asset may be disconnected or deprecated by the oracle by changing the URI or metadata to point to an empty or valueless asset, or an asset that enables the visitor to understand that the asset is no longer available.

In another example, if the buyer was misled into buying a fake NFT, security platforms can enable a third-party to replace the asset with a similarly valuable asset. In yet another example, if the holder of the NFT is tricked into transferring or selling the NFT at well below market value, the NFT asset can be changed to a valueless asset and a replacement asset can be minted for the original holder. In this example, it is also possible to include the original NFT transaction history within the NFT metadata, or from publicly available on-chain data such that the provenance of the item remains available, with or without reference to the theft. This type of evolution can be referred to as “security evolution” as it is evolution that is performed in response to the detection of an event affecting the security of one or more participants or resources.

Security platforms in accordance with many embodiments disclosed herein are not limited in their application to situations involving theft, but can also be applied in other situations where fraudulent activity is detected or suspected. For example, if it is determined that an NFT is not legitimate, e.g., it was minted by a party that was not authorized to do so, e.g., based on content that this party did not have the rights to, then security actions can be taken to modify the contents, destroy the asset or otherwise penalize the owner(s) of the asset. Determination of asset origin is described in U.S. Provisional Patent application Ser. No. 63/220,488 filed Jul. 10, 2021 entitled “Content Origin Determination and Tokenization” by Markus Jakobsson, which is herein incorporated by reference in its entirety.

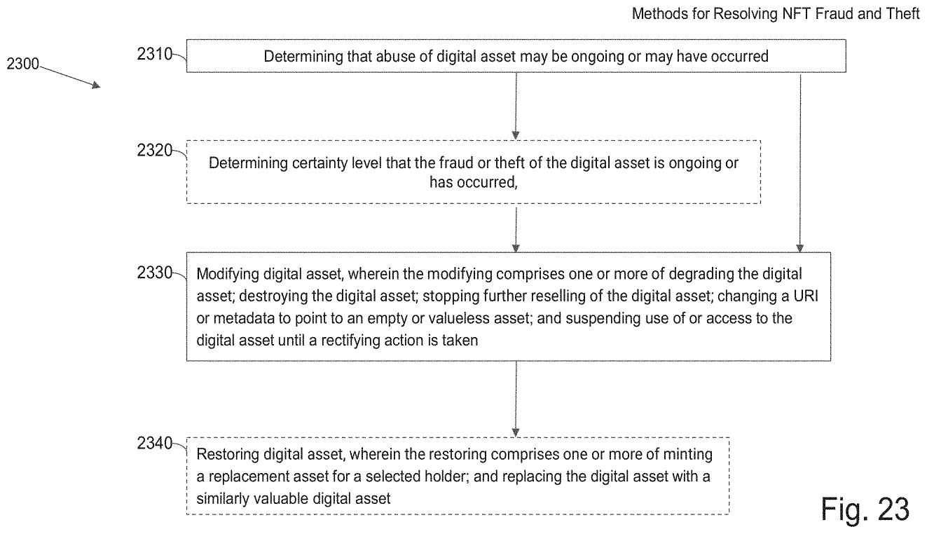

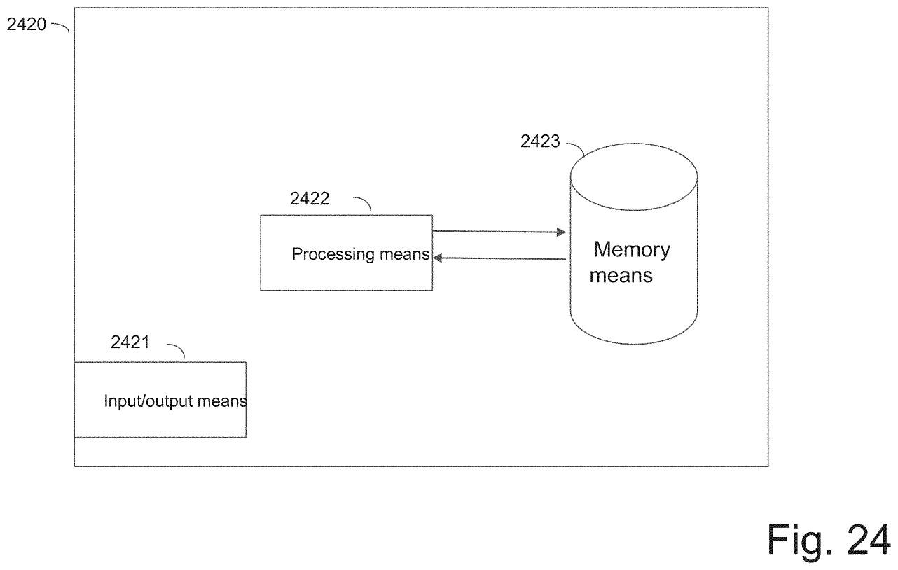

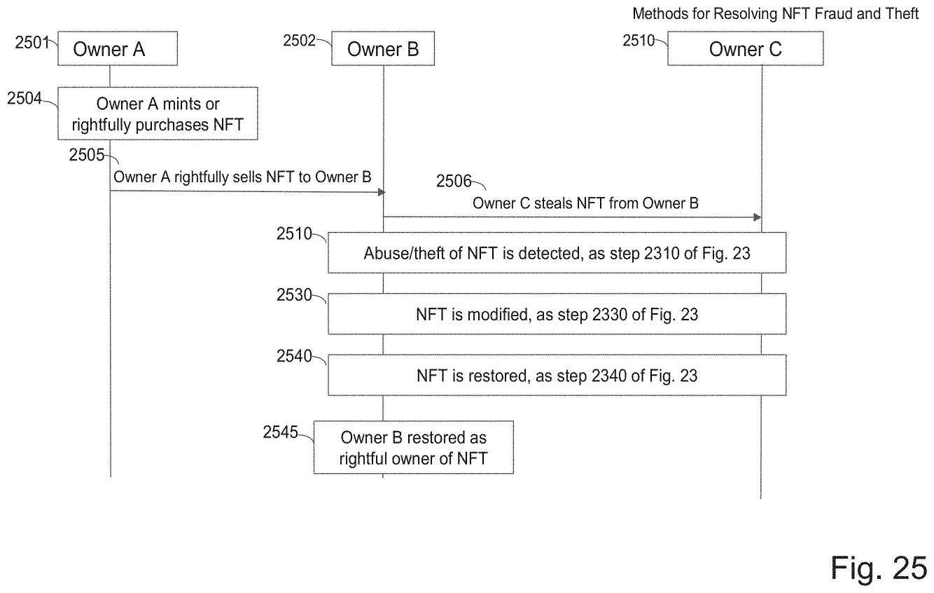

Processes for mitigating abuse of a digital asset in accordance with an embodiment of the invention is illustrated in FIG. 23. The abuse can be e.g., fraud; theft; failure to pay due taxes, royalty or other fees associated with a transaction of the digital asset; or the digital asset being an NFT, where the NFT is not legitimate, e.g., it was minted by a party that was not authorized to do so etc. It is pointed out that these are just examples of abuse and other types or sorts of abuse may be ongoing or have occurred as exemplified above. FIG. 23 illustrates the process 2300 can include determining (2310) that abuse of the digital asset may be ongoing or may have occurred. This may be done in different ways as described, e.g., by using one or more of using a set of heuristic rules; by using a machine-learning module trained to detect fraud, theft or other abuse; and/or by receiving a report from a user previously or currently associated with the digital asset, among various other techniques. Once the process determines that abuse of the digital asset may be ongoing or may have occurred, the process can modify (2330) the digital asset, where the modifying can include one or more of degrading the digital asset; destroying the digital asset; stopping further reselling of the digital asset; changing a URI or metadata to point to an empty or valueless asset; and/or suspending use of or access to the digital asset until a rectifying action is taken, among various other modifications as appropriate for the particular circumstances.

In many embodiments of the security platforms, by modifying the digital asset, the use of the digital asset can become at least degraded in the sense that it may not be further accessible, or very limited access may be provided. The asset may be completely destroyed or changed. The asset may no longer be possible to sell to another user or the asset may be frozen such that use or access of the digital asset is suspended until a rectifying action is taken. The rectifying action can be dependent on the type of abuse, e.g., if the abuse is failure to pay a fee, taxes or royalties then the use of or access to the digital asset is suspended until such fee, taxes or royalties are paid. Several examples of abuse and modifications of the digital asset are described above, and the examples given here in conjunction to FIG. 23 are merely illustrative examples. FIG. 23 also illustrates that the process can optionally restore (2340) the digital asset. This box is dotted illustrating that it is an option and not compulsory. The restoring of the asset may include one or more of minting a replacement asset for a selected holder; and/or replacing the digital asset with a similarly valuable digital asset among various other restorations. It is pointed out that even though the wording “restoring the asset” may be interpreted e.g., as recreating a destroyed asset, the meaning of the wording in can relate to rectifying the abuse or the consequences thereof. FIG. 23 also illustrates that the process 2300 can further optionally determine 2320 a certainty level that the fraud or theft of the digital asset is ongoing or has occurred, wherein the modifying (2330) of the digital asset is performed based on the determined certainty level. In particular, an abuse may not always be “black or white” meaning that it may or may not be absolutely certain that the abuse is ongoing or has taken place. Thus the modifying (2330) may be performed based on a certainty level. The certainty level can serve as an indication of how likely it is that the abuse actually is ongoing or has occurred. In many embodiments, the type of modification that is performed (2330) may depend both on the type of abuse, what consequences the abuse causes and/or the certainty level that the abuse actually is ongoing or has occurred, among various other factors. While specific processes are described above with reference to FIG. 23, any of a variety of processes for determining abuse of a digital asset and modifying the asset can be specified as appropriate to the requirements of specific applications in accordance with various embodiments of the invention.

A security device that can include security platforms for mitigating abuse of a digital asset in accordance with an embodiment of the invention is illustrated in FIG. 24. The device 2420 can include input/output means 2421 by means of which the device may receive information and transmit or provide information to other units, devices and/or entities. FIG. 24 also illustrates the device 2420 can include processing means 2422 and memory means 2423, the memory means 2423 including instructions, which when executed by the processing means 2422 causes the device to perform the method described herein. Although a particular architecture of a security device for mitigating device of a digital asset is illustrate in FIG. 24, any of a variety of architectures can be utilized as appropriate to the requirements of specific applications in accordance with embodiments of the invention.

Security platforms in accordance with several embodiments can include a switch module associated with the retrieval of content that can be configured to perform or request a security assessment related to a requested resource prior to responding to such a request. For example, the switch module may include a content hosting service, a DNS resolution service, or a unit that configures or serves software modules on demand. Switch modules in accordance with some embodiments of the invention can determine what content to serve in response to a request based on the determined security assessment. For example, if an NFT is determined to have been stolen (e.g. the user fell prey to a “phishing” attack), then the switch module may refuse to serve the content previously associated with the NFT, and instead serve an error message or a modified version of the resource. Modifications in accordance with numerous embodiments of the invention can be an encryption of the resource, where the encrypted resource can be decrypted conditional on a rectifying action being taken. Example rectifying actions may include (but are not limited to) to pay a sales tax, transfer back the ownership of the NFT to a previous owner, or provide registration information, e.g., related to a jurisdiction associated with the party making the request for the data associated with the NFT.

In many embodiments, security platforms may have different levels of security actions for different levels of risk, where one is selected based on various factors, such as (but not limited to) the comparison of a risk score with a threshold, and/or of an event with a matching description. Security platforms in accordance with several embodiments can determine if a near-certainty of fraud is established and select a security action which may be to destroy an NFT that is understood to have been stolen (or similar), and/or to re-generate a copy of the same NFT and assign this to the owner prior to the detection of the theft. The assignment may be performed pending a verification that the party to whom it should be assigned is not corrupted, e.g., by malware, still. In certain embodiments of the security platforms, if the risk is not near-certainty, but above a medium threshold, then a security action that blocks further ownership transfers may be performed. If the NFT was indeed stolen, this security action may stop the thief from reselling the stolen goods. In many embodiments, security platforms may automatically apply a policy that causes the blocking of rapid sequences of ownership transfers for a duration of time, e.g., such as 36 h, after the owner applying this policy has transferred ownership to another party. This can be a policy that prevents resale of stolen goods. There may be different levels of certainty represented by different respective thresholds. E.g., the certainty level meeting or exceeding a first threshold may indicate that the certainty level is classified as near certain; the certainty level meeting or exceeding a second threshold but still not meeting the first threshold may indicate that the certainty level is classified as quite certain, wherein quite certain is less certain than near certain etc.

In several embodiments, a suspicious transaction can be performed in which the ownership of an asset is changed. In many embodiments of the security platforms, the determination that it is suspicious may be performed using a set of heuristic rules, a machine-learning (ML) module trained to detect theft and other abuse, among various other types of analysis. After the suspicious transaction, a series of ownership transfers can be performed in rapid sequence, e.g., with an inter-arrival time that is lower than a pre-set threshold that may be global, may be specific to the asset, a user owning the asset prior to the suspicious transaction, or which is determined using the heuristic rules and/or the ML module. Security platforms may identify that these transactions are performed. In numerous embodiments, triggered by this identification, the asset can be degraded or destroyed, and a corresponding asset can be minted and assigned to the party determined to be the rightful owner. This may be determined by requesting all the owners starting right before the suspicious transaction and until the triggering to make claims. A claim may require the parties to identify themselves and provide information. A criminal may not wish to do this, and therefore would be excluded from consideration of whom to assign the newly minted asset to. In many embodiments of the security platforms, manual scrutiny as well as automated analysis can be applied to determine what party to assign the new asset to. In several embodiments of the security platforms, clustering-based analysis can be performed to associate risk values with different parties making claims. If one party corresponds to a newly created wallet identifier, or one that is not anchored in a user identity, this may indicate a higher risk that this party may not be the party to whom the newly minted asset should be assigned. Privacy-protecting clustering can be performed using encrypted data, as disclosed in U.S. Provisional Patent Application Ser. No. 63/322,265 filed Mar. 22, 2022 entitled “Escrowed Wallet and Transaction Tracking Technology” by Markus Jakobsson which is herein incorporated by reference in its entirety.

### Machine Learning to Determine Risk

In several embodiments of the security platforms, the determination of whether a transaction is suspicious, the determination of a risk score, and/or the determination of one or more security actions may be performed using one or more machine learning components. In certain embodiments of the security platforms, a classification algorithm such as a neural network may make a binary determination that a transaction is suspicious, or it may output an estimated probability that a transaction is suspicious, where a probability over some threshold leads to some security action being taken or where the probability itself determines which security action among multiple options is taken. Security platforms that include machine learning approaches in accordance with a variety of embodiments of the invention may employ generalized models of what makes a transaction suspicious or risky, may employ a model that is specific to an individual wallet or user to capture what is typical or not for this wallet or user, and/or may employ one or more models that combine a generalized approach with a more individualized one. Such models may take as inputs information such as, but not limited to, the activity of the source and receiver wallets before and after the transaction in question, the history of transaction prices for the item before and after the transaction in question, properties of the source and receiver wallets such as how long they have been in use and whether they are associated with known or verified entities, and activities or properties associated with other transactions, wallets, and items that are presumed to be fraudulent or non-fraudulent. Machine-learning-based approaches in accordance with various embodiments of the invention may take into account human inputs, for instance the fact that the human owner of the source wallet has flagged a transaction as fraudulent may be used as a further input into a neural network, or it may trigger the use of one or more distinct machine learning components which have been trained to assess the veracity of such flags rather than passively identifying fraud in non-flagged transactions.

### Security Policies

Just like evolution can be governed by policies, whether included in an NFT or expressed external to an NFT, security evolution can be governed by policies. For simplicity, these policies can be referred to as “security policies”. Security platforms in accordance with many embodiments can include security policies, and the same type of security policies can be associated with a switch module or a party providing a security assessment to a switch module. Security policies can be set by a content creator, e.g., to limit functionality of an NFT based on the failure of a royalty to be paid as the NFT is transferred from one user to another. In another example use scenario, a type of resource is implicitly associated with a security policy. The security policy may state that NFTs that include nudity or violence cannot be transferred to wallets that are owned by minors without a redaction or modification of what is being rendered to a user of a wallet. Such policies may be based on jurisdictions, e.g., associated with a receiving wallet. Methods of providing detections of jurisdictions are disclosed in U.S. Provisional Patent Application Ser. No. 63/322,265 filed Mar. 22, 2022 entitled “Escrowed Wallet and Transaction Tracking Technology” by Markus Jakobsson which is herein incorporated by reference in its entirety. Security policies may also be set by owners of NFTs by associating configurations maintained or references from their wallets or user profiles in marketplaces. In certain embodiments of the security platform, a security policy may be one that protects against accidental transfers of ownerships, where this may include a sale that is anomalously low-valued, e.g., worth one WEI instead of one ETH. A user may set limits for what is considered anomalously low, or these may be set relative to acquisition prices (e.g., “block sales for less than 1/1000th of the purchase price”) or relative to estimated market prices (e.g., “it is ok to transfer an asset with no payment between two associated wallets, but never to sell an asset at less than half its estimated market price”). Many such security policies can be in place at the same time, and can be evaluated when an action is taken to the associated NFT. Actions may not be limited to sales and use of content, but may also include user-initiated actions such as to attempt to initiate spawning of an NFT, to rent out an NFT, and/or to disclose the ownership of an NFT whose ownership the user has previously identified as being secret. Secret ownerships in accordance with numerous embodiments of the invention may be implemented using one-use wallet addresses, created solely to maintain ownership of a specified NFT, wherein one wallet embodiment may present the content corresponding to multiple wallet addresses to a user using a user interface, potentially hiding from the user that the different NFTs are associated with different wallet addresses.

In several embodiments, the determination of whether a security action, such as the return of an NFT to a previous owner, should be taken may not be possible to make simply based on evaluating one or more policies. For example, it may be that there are multiple policies to be used to determine whether an event qualifies for having a security action applied, and these different policies may indicate different and contradictory results. In such an instance, there may be a need for human assessment of the situation. This may be performed by one user, such as an admin or a judge, or a collection of users, such as a panel, or a decentralized voting organization, or the NFT creator. Different members of the panel may be represented by different computers, each one of which gets to cast a pre-specified number of votes, where the number of votes associated with one computer may be different from the number of votes associated with another. In a variety of embodiments, the computers may, together, perform a consensus-based operation, which may be or correspond to a selection or execution of a security action. Some of the computers may not represent a human admin, but may be controlled by an algorithm. In several embodiments, all the members of the panel may correspond to automated software entities, such as bounty hunters. In certain embodiments of the security platforms, at least some determinations involve an assessment by an admin.

Security platforms in accordance with several embodiments can include smart contracts and/or associated metadata that can be used to facilitate transactions. Smart contracts in accordance with several embodiments can specify conditions related to transfers of ownership, including allowing, denying, and/or delaying transfers among various other conditions.

In certain embodiments of the security platform, a creator of an NFT may specify conditions, such as in a smart contract or associated metadata, under which an NFT may change ownership. In some instances, these conditions may indicate that after the NFT is first acquired by a first user, it may not be reassigned to another user in terms of changing its ownership. However, a buyer can purchase such an NFT by having it assigned to a wallet for which there is no other contents, and instead of selling the NFT (which may be blocked by the associated condition) instead attempt to sell access to the wallet (e.g., by selling the password and allowing another user to set a new password), where the wallet contains the NFT that is not allowed to be sold. If this becomes evident to have taken place, the NFT can be degraded as described herein, e.g., by performing security evolution on it that renders it no longer accessible, or by having a switch module block access to content associated with the NFT. In certain embodiments, the determination that a wallet has been transferred can be performed by infiltration of marketplaces where such transactions are advertised. Smart contracts in accordance with numerous embodiments of the invention may be configured to deny transfers to a wallet address that is not whitelisted, is blacklisted, is empty, or is not doxxed—where doxxing attributes a real identity to an otherwise anonymous wallet address. Such doxxing may be accomplished by including one or more NFTs in a wallet that identify the owner. The smart contract may also be configured to block transfers for transaction sale values that are unusually low. In several embodiments, control of the smart contract that minted one or more NFTs may be placed in possession of a custodian, agent, or authority that maintains the smart contract with updates and is empowered to cause NFTs to be destroyed, deprecated, enhanced, or replaced, as described in this disclosure.

### Security Actions in Response to Fraud Detection

In many embodiments of the security platforms, different security actions can be taken in response to different kinds of fraud and abuse. In certain embodiments of the security platform, a security action that can be taken in response to a detection of abuse is to cause an NFT to be not useful, e.g., by degrading its content, changing the title of the NFT, and/or altering access to content or otherwise modifying the NFT; and to create a new NFT that corresponds to the degraded or modified NFT prior to the security action, where this new NFT is assigned to what is determined to be its rightful owner or custodian, such as its creator. The new NFT may be identical to the previous version, or may include indications of the security action taken, where such an indication may be a reference to an event or a log entry, and/or a classification specifying why the new NFT was minted. In a number of embodiments, security actions may be performed automatically and without any input from the original content creator of the NFT that can be referred to as the “illicitly gained” NFT. Thus, the effect of the security action can be a reversal of a previous state change, such as an ownership change, and an optional documentation of this reversal.

Security platforms in accordance with several embodiments can include processes for facilitating transfers of NFTs. A process of transferring an NFT between several users is illustrated in FIG. 25. In particular, FIG. 25 illustrates a situation where an NFT is stolen from its rightful owner in accordance with an embodiment of the invention is illustrated in FIG. 25. FIG. 25 illustrates a first owner, denoted Owner A (2501) being a rightful owner of a digital asset, namely in this example an NFT. Owner A may have purchased the NFT or may have minted the NFT. This is illustrated in box 2504. At some point, Owner A rightfully sells the NFT to Owner B (2502) indicated in the figure by event 2505. Owner B is now the rightful owner of the NFT. However, the unscrupulous Owner C (2510) somehow manages to steal the NFT from Owner B, indicated in the figure by event 2506. Unlucky for the unscrupulous Owner C the theft is somehow detected as described above and the disclosed method is thus in action. The detection of the theft can correspond to method step 2310 as illustrated in FIG. 23 by box 2510. Once the abuse, e.g., theft in this illustrative example, is detected, the NFT can be modified in method step 2530 of the method as illustrated in FIG. 23 by box 2330. In this illustrative example, the modification may be freezing the NFT so that Owner C may not be able to use and/or sell the NFT. In this illustrative example, the NFT is then restored to its rightful owner, namely Owner B (2502) which is illustrated by box 2540 which can correspond to method step 2340 illustrated in FIG. 23. Owner B is then again the rightful owner of the NFT as illustrated by box 2545. Although FIG. 25 illustrates a particular example of modifying an NFT by reverting ownership back to an owner after detecting theft, any of a variety of modifications and types of fraud detection can be performed as appropriate to the circumstances of a particular situation in accordance with embodiments of the invention.

### Malware Defense

Security platforms in accordance with many embodiments can provide a line of defense against abuse, such as malware. Malware can cause the transfer of assets, such as NFTs, to beneficiaries associated with the malware. In several embodiments, security platforms can also protect crypto coins, e.g., against malware attacks that automatically transfer funds to beneficiaries of the attack. Security platforms in accordance with a variety of embodiments of the invention can achieve this by “wrapping” cryptofunds in NFTs, such as evolutionary NFTs, where a trusted authority can cause select NFTs to become disassociated from their associated content, corresponding to a disassociation with the wrapped coin(s). In certain embodiments, wrapping can be performed by transferring one token (e.g., such as one or more coins or one or more NFTs) to a non-existent party, causing a destruction of the associated asset, and an associated incorporation of data associated with the destroyed token into a wrapper, which could be an evolutionary NFT. In many embodiments of the security platform, an evolutionary NFT can be transferred to another owner like an NFT. If it includes cryptofunds, the NFT can be spent in part, e.g., by the re-wrapping of the content into two or more new NFTs, where one or more of these are reassigned in terms of ownership. If an NFT that is used to wrap a resource is stolen, phished, or otherwise transferred in an undesirable manner, then a trusted party, which may be a distributed party, can reverse this transaction by selectively destroying some tokens, and/or some of the resources associated with one or more of the tokens. This can be combined with a new creation of NFTs holding the destroyed contents, where these new NFTs can be assigned according to the intended ownership rights. When a wallet only holds assets whose ownership can be reverted in this manner, the wallet is protected against many types of abuse, such as malware and phishing.

In several embodiments of the security platforms, security platforms may be utilized to identify on-chain assets that may have been illicitly gained by monitoring the assets that reside in, or have transferred through, wallet addresses presently or previously associated with fraudulent activity. The security platforms may be utilized to freeze the assets such that they may not be transferred without clearance, altered as described, or transferred into a temporary custodial account.

### Counterfeit Protection

In several embodiments, security platforms can be used to address problems related to counterfeits. Certain embodiments of the security platforms can use one or more registries in which content owners can upload indications of content and ownership, and/or complaints about abuse. Such abuse may include the piracy of content, e.g., in the form of minting of NFTs by users without copyright to the content incorporated in or referenced by the minted NFTs. In some instances, such registries can be at least in part manually curated, e.g., by enabling manually made submissions; and/or can be automated and based on the spidering of the Internet, of content repositories, and/or by associated analysis of the acquired data.

Security platforms in accordance with many embodiments can, when an NFT is identified that is determined to correspond to pirated content, compute a risk score indicating the certainty of this assessment can be generated, e.g., using the registries and/or by performing a comparison to elements associated with an identified NFT. NFTs may be identified by parties claiming to be the content owners, by bounty hunters, or by automated methods, e.g., that infiltrate black markets, that scan marketplaces, or that scan archives. Security platforms can use the risk score as an indication regarding the certainty of piracy and this can be compared to one or more thresholds, and an optional one or more security actions can be taken accordingly. Security platforms can perform various different security actions, including a degradation or destruction of content or NFTs, or a reassignment of ownership, e.g., by way of an automated re-minting of resources. In several embodiments, security platforms can degrade NFTs by intervening with the rendering of content, e.g., by communicating an identifier of the content to be blocked to nodes where interception or blocking can be performed. Example technology to do this and related tasks is disclosed in U.S. Patent Provisional Application Ser. No. 63/283,330 filed Nov. 26, 2021 entitled “Ownership-Based Limitations of Content Access” by Markus Jakobsson, which is herein incorporated by reference in its entirety.

Security platforms in accordance with several embodiments may allow the control of an NFTs via a “Manager” smart contract that acts as an agent. An NFT may be authorized to act solely by signed transactions issued by the “Manager” contract. When an entity attempts to transfer an NFT, the NFT might respond with a reference to the manager agent, e.g., by causing the latter to respond or by responding with a reference to the manager agent. The manager agent can then evaluate the conditions of the transfer and determine whether it allows the transfer.

Security platforms in accordance with several embodiments can include a security service that can be operated by an entity that has generated a smart contract associated with an NFT that has been identified as requiring a security action applied. In many embodiments, security services, by virtue of possessing the signing keys used in a smart contract, can be able to control, including undo, transfers of ownership associated with the contract, e.g., by generating new directions to override previous transfers. In many embodiments of the security platform, a smart contract can be created to allow different security measures by the security service. A smart contract can also be created to designate a trusted third party, which may be a distributed entity and which may correspond to a consensus mechanism, to perform transfers of ownership and other modifications related to the NFT. In many embodiments of the security platforms, an NFT may remain entirely under control of the smart contract that minted the NFT. Therefore, security platforms can define rules that allow the “repossession” of stolen NFTs, block transfer until one or more controlling keys authorize transfer to a specified account, and/or block transfers that have not met specific parameters such as price. These actions can be taken based on detections and policies governing security actions, as disclosed herein.

### Using Watchful Bridging for Blockchain Fraud Prevention

Many traditional blockchain systems can be computationally expensive to operate. To address this, a layer-2 blockchain can be commonly used to lower costs of operation by batching entries. Doing so may lower costs, such as gas fees and environmental impact, since the layer-2 protocol may typically use a less expensive technology than the layer-1 protocol it ties in with. The layer-2 protocol may operate with a lower degree of security than the layer-1 chain, without resulting in a severe compromise of security; this is because of the periodic batch recording of chain segments from the layer-2 chain onto the layer-1 chain. Traditional blockchain systems, whether using a single blockchain or a two-layer approach, have many security problems related to the impossibility to undo transactions. Whereas originally hailed as a feature, the absence of an undo operation has increasingly fueled scams and abuse, such.

Many embodiments of the NFT system include security platforms that can address an array of multi-layer blockchain security problems. In many embodiments, security platforms can provide watchful bridging between a layer-1 blockchain and a layer-2 blockchain. The bridge can be the connection between the layer-1 and the layer-2 chain. In many embodiments of the security platforms, using a first bridge, a time-stamped state of a layer-1 chain may be used as a starting point for a segment of a layer-2 chain.

Certain embodiments of the security platforms can use a time-stamped block of the layer-1 chain as the input to the layer-2 chain, thereby creating a seed ledger onto which events recorded on the layer-2 chain are added. In many embodiments of the security platform, the second chain may be generated for a pre-specified amount of time; until it includes a pre-specified number of recorded entries; and/or until a function determining when to bridge back determines, based on inputs such as time and/or ledger entries among various other factors, that it is time to bridge back.

In many embodiments of the security platforms, when it is determined to be the proper time to bridge back, then, using a second bridge, one or more segments and/or entire segment of the layer-2 chain can be recorded on the layer-1 chain. This is traditionally done by recording the last ledger entry in the layer-2 chain as a subsequent entry of the layer-1 chain.

By using watchful bridging, many embodiments of the security platforms can implement a host of valuable security features. Security platforms in accordance with many embodiments can provide that the bridge be watchful, by which it selectively identifies what entries on the layer-2 chain to cause to be registered on the layer-1 chain, or conversely, what entries to block. Blocking entries in accordance with some embodiments of the invention may cause the associated events to be canceled, thereby enabling an undo of abuse within a limited period of time. In many embodiments, security platforms can also make it possible to delay the registering of events by first canceling them during the bridging from the layer-2 chain to the layer-1 chain, and then to automatically add them to the next layer-2 block to be created. The reporting of a layer-2 element to the layer-1 chain, e.g., by including the layer-2 event in a hash to be added to a layer-1 ledger entry, can be referred to as the confirmation of the associated event. The selective avoidance of confirmation can be referred to as blocking of the associated event. In certain embodiments, a delay of the security decision can occur when the element that is excluded from being recorded onto the layer-1 chain is automatically re-introduced on the next layer-2 chain, where the security decision is whether to confirm or block the event from being recorded.

In many embodiments of the security platforms, the selective confirmation, blocking or delaying of a security decision can be implemented by a watchful bridge. Whereas traditional bridges do not offer options, but record all layer-2 events on the layer-1 chain, a watchful bridge in accordance with many embodiments can include one or more processes that are used to selectively confirm, block or delay. In certain embodiments of the security platforms, the use of delay can be used when insufficient certainty of the determination whether to confirm or block can be achieved, or when an insufficient time has passed from the recording of the associated event on the layer-2 chain until the bridging back.

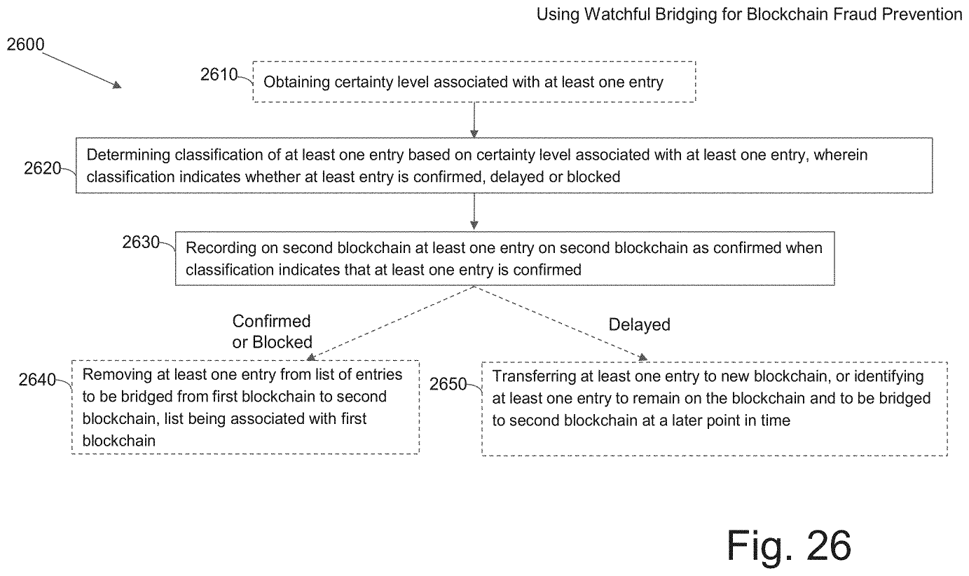

A process for bridging from a first blockchain to a second blockchain using a watchful bridge in accordance with an embodiment of the invention is illustrated in FIG. 26. A first blockchain can include at least one entry and the process includes being performed by a watchful bridge. FIG. 26 illustrates the process includes determining (2620) a classification of the at least one entry based on a certainty level associated with the at least one entry, where the classification indicates whether the at least entry is confirmed, delayed or blocked. As described herein, the certainty level may be based on various types of information pertaining to whether or not the at least one entry may be associated with problems, irregularities or abuse which may be reported by one or more other entities, such as bounty hunters, oracles, agents, and/or other smart contracts. As described herein, a certainty level may also be associated with a certain amount of time having to pass after the creation of the at least one event. Further, the at least one event that the first blockchain includes may originate from the second blockchain being copied onto the first blockchain.

The process can determine (2620), based on the certainty level, the classification of the at least one entry. In certain embodiments, the classification can be first determined by the first blockchain and the watchful bridge can determine it simply be receiving or reading it. In certain embodiments, the watchful bridge can obtain the certainty level and use the certainty level to determine the classification. Further, obtaining the certainty level may include receiving or reading it from the first blockchain, or determining the certainty level based on available information as described above.

The process can record (2630) on the second blockchain the at least one entry on the second blockchain as confirmed when the classification indicates that the at least one entry is confirmed. In this manner, the event associated with the at least one entry is confirmed on the second blockchain.

The process can include optionally obtaining (2610) a certainty level associated with at least one entry as just explained above. The process can include optionally removing (2640) the at least one entry and/or optionally transferring (2650) the at least one entry. In particular, in case the at least one entry is confirmed or blocked, it means that the at least one entry is bridged to the second blockchain and then the process can remove (2640) the at least one entry from a list of entries to be bridged from first blockchain to the second blockchain, the list being associated with the first blockchain. If the at least one entry is confirmed or blocked, it means that there may be no further need for the at least one entry to be considered by the watchful bridge again. In certain embodiments, watchful bridges may have a list of entries or the entries may have a flag or in any other way being indicated as eligible for being bridged to the second blockchain. Thus, when an entry no longer is eligible for being bridged to the second blockchain, it may be removed from the list or have a flag changed, or various other indicators of the change.

However, if the at least one entry is classified as delayed, the process may optionally transfer/record (2650) the at least one entry to a new first blockchain, the new first blockchain being of the same level as the first blockchain; or identifying the at least one entry to remain on the first blockchain and to be bridged to the second blockchain at a later point in time. While specific processes are described above for bridging from a first blockchain to a second blockchain using a watchful bridge based on certainty levels associated with an entry with reference to FIG. 26, any of a variety of processes for can be specified for bridging from a first blockchain to a second blockchain based on various criteria can be utilized as appropriate to the requirements of specific applications in accordance with various embodiments of the invention.

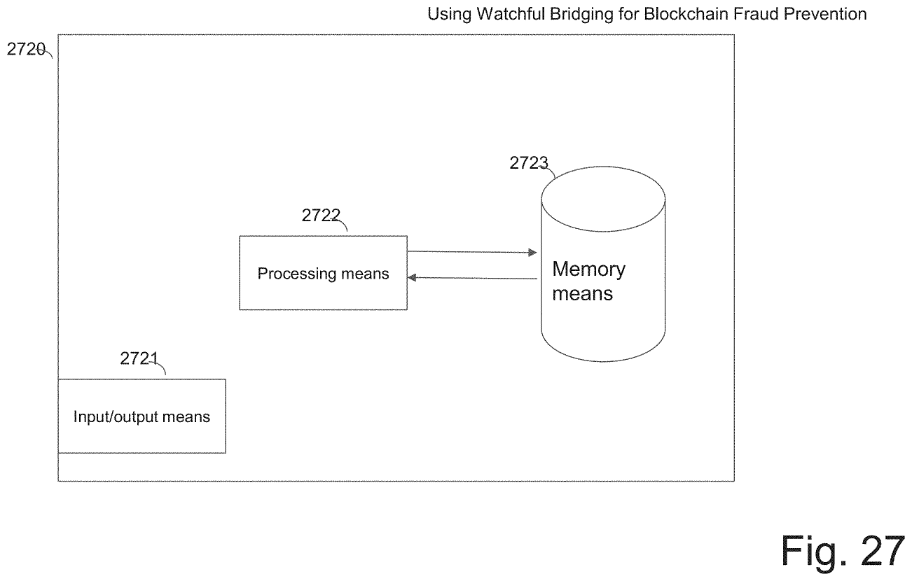

An architecture of a security platform that includes a watchful bridge for bridging between a multi-layer blockchain in accordance with an embodiment of the invention is illustrated in FIG. 27. As illustrated in FIG. 27, the watchful bridge 2720 can be configured for bridging from a first blockchain to a second blockchain. The watchful bridge 2720 can include input/output means 2721 by means of which the watchful bridge 2720 may receive information and transmit or provide information to other units, devices and/or entities. FIG. 27 also illustrates the watchful bridge 2720 can include processing means 2722 and memory means 2723, the memory means 2723 including instructions, which when executed by the processing means 2722 causes the watchful bridge 2720 to perform the processes described herein.

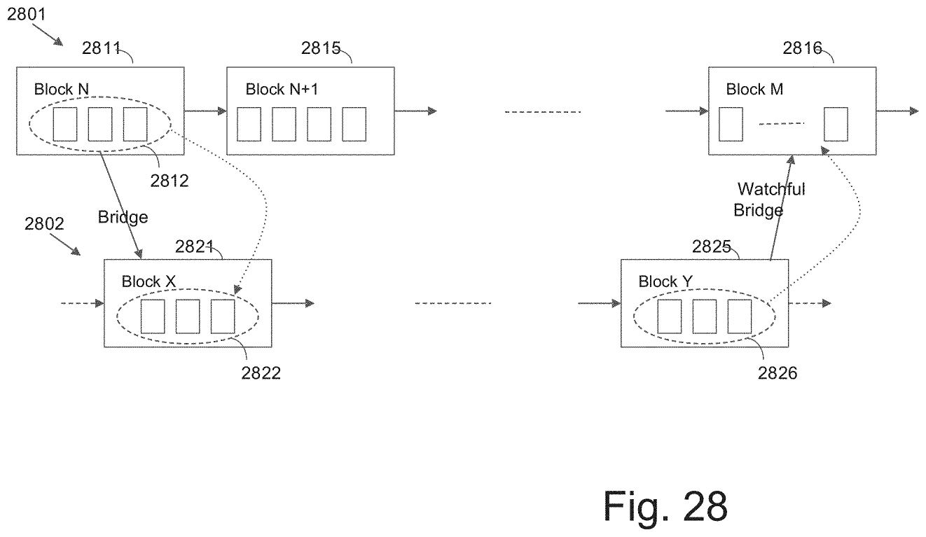

A process for bridging between a layer-1 and layer 2 block chain in accordance with an embodiment of the invention is illustrated in FIG. 28. In particular, FIG. 28 illustrates two blockchains 2801 and 2802. In this illustrative example, blockchain 2801 may be a layer-1 blockchain and blockchain 2802 may be a layer-2 blockchain. Blockchain 2801 may be referred to as a first blockchain and blockchain 2802 may be referred to as the second blockchain. At a point in time, a block N 2811 includes some entries 2812 associated with events that have taken place. A bridge can establish a connection between the layer-1 blockchain 2801 and the layer-2 blockchain 2802. Using the first bridge, a time-stamped state of a layer-1 chain may be used as a starting point for a segment of a layer-2 chain as described above. In addition, the bridge may be used to copy over one or more items from blockchain 2801 to blockchain 2802, and canceling them from blockchain 2801 by assigning their ownership to blockchain 2802, to NULL, and/or to an entity that does not have a private key. At a later point in time, a watchful bridge can be activated between a block Y 2825 of the layer-2 blockchain 2802 and a block M 2816. Using the watchful bridge, some entries 2826 of block Y 2825 are to be evaluated and possibly recorded in block M 2816. The watchful bridge may, for individual entries 2826 of block Y 2825, determine a classification of the entry based on a certainty level associated with the entry, where the classification indicates whether the entry is confirmed, delayed or blocked. The watchful bridge may further record, for individual blocks, on the second blockchain the entry on the second blockchain as confirmed when the classification indicates that the entry is confirmed. The watchful bridge may also map a multiplicity of blocks, including block Y 2825 of the layer-2 blockchain 2802 to block M 2816. In certain embodiments, the watchful bridge can record a hash value on block M 2816, said hash value being computed from the multiplicity of blocks; it may further select what entries of these blocks to record by including them in the computation of the hash value. Although FIG. 28 illustrates a particular example of bridging between two blockchains, any of a variety of processes may be utilized as appropriate to the requirements of specific applications in accordance with embodiments of the invention.

Security platforms in accordance with several embodiments can include a watchful bridge that includes a process that obtains feedback from one or more other entities, such as bounty hunters, oracles, agents, or other smart contracts among various other entities. Bounty hunters are disclosed in U.S. patent application Ser. No. 17/806,065 filed Jun. 8, 2022 titled “Systems and Methods for Maintenance of NFT Assets”, by Markus Jakobsson, Stephen C. Gerber, and Guy Stewart, which is herein incorporated by reference in its entirety. A watchful bridge in accordance with several embodiments of the security platforms can make a security determination based on the presence of, absence of or content of such feedback. For example, if no bounty hunters have provided any feedback and at least a certain time period (e.g., five seconds) have elapsed since the recording of an event on the layer-2 chain, then a watchful bridge may determine that the event should be confirmed. If, on the other hand, at least two bounty hunters have provided a warning for a given event, or at least one bounty hunter has provided evidence of abuse associated with the given event, then a watchful bridge may determine that the event should be blocked. Any event that has neither been confirmed nor blocked can be automatically moved over to the next layer-2 chain at the time a given bridging operation is performed.

In many embodiments of the security platforms that include watchful bridges, when a recorded event is delayed, it may still be associated with its original layer-2 time stamp. Thus, if an event is recorded on a layer-2 chain, then delayed by a watchful bridge (one or more times), and then finally confirmed by the watchful bridge — then the event can still be associated with its original time of being recorded on the layer-2 chain. Security platforms in accordance with certain embodiments of the invention can record, by a watchful bridge, items to be delayed, and include a flag that indicates that these items are not yet determined to be possible to confirm. Once such an item is confirmed, this can be done by referring back to this first recording onto the layer-1 chain, and adding a flag indicating that it is now confirmed. Similarly, a delayed and later blocked item can be referred to and flagged as blocked. In certain embodiments of the security platforms, an item can be removed from the state of still-pending events maintained by the watchful bridge, and therefore effectively forgotten.

In many embodiments of the security platforms, as a watchful bridge may delay events, there can be a risk that malicious agents may attempt to use the blocking functionality to repeatedly delay given transactions, either to cause inconvenience to another party, or to perpetrate a scam such as a double spend. In several embodiments of the security platforms, such behavior may be mitigated by requiring bounty hunters or bridge verifiers to provide a stake including cryptocurrency or digital assets of commercial value to operate as agents capable of reporting information that may result in a delay or cancellation of a transaction. In the event that such information is deemed to be false and submitted maliciously, some or all of the stake provided may be slashed, that is, confiscated or not returned to the staker. In several embodiments, other parties may report that the reported information is false, and the malicious agent may be banned from supplying further information. Financial penalties in the form of slashed stakes may be transferred to submitters of transactions that were falsely blocked or canceled. Further mitigation strategies are disclosed in a U.S. Provisional Patent Application Ser. No. 63/366,391 filed Jun. 14, 2022 entitled “Reversal of Blockchain Transactions” by Keir Finlow-Bates, Markus Jakobsson, Stephen C. Gerber and Stefan Dufva, which is herein incorporated by reference in its entirety.

In several embodiments of the security platforms, the watchful bridge can take as input a level-2 chain including some N entries that have not been bridged back onto the level-1 chain. Security platforms in accordance with several embodiments may generate an ordering of these N entries, e.g., in accordance with the order in which they were recorded on the level-2 chain, and associate the N entries with an N-bit vector, wherein the ith bit is set to 0 if the ith entry is not to be bridged back to the level-1 chain, and to 1 otherwise. This N-bit array can be referred to as the confirmation flag array. The corresponding N entries can be concatenated with each other and with the confirmation flag array appended to it, the corresponding string is hashed. The result of the hash can be recorded on the level-1 chain. Assume there are M1 entries that are assigned a 0 in this list.

In many embodiments of the security platforms, entries that are to be delayed as described may need to be carried over to a new level-2 chain. Assume there are M2 such entries, where M1-M2 corresponds to the number of entries, out of the N entries, that should be blocked. Security platforms in accordance with several embodiments can log the reason for blocking, e.g., by creating a record for each blocked entry and logging these blocks. Logging can take place by recording the blocking event on the new level-2 chain, for example. The remaining M2 entries can be entered on a newly created level-2 chain, e.g., by copying them onto the newly created level-2 chain, and/or by providing as input to this chain indications of what M2 entries are delayed, and what level-2 chain they originated from. The latter indicates their respective time-stamps, which can be maintained should some of them later be confirmed, the block records need time-stamps to indicate the arrival time of the entries to be blocked.

In several embodiment of the security platforms, the watchful bridge may take as an input the level-2 chain sequence of blocks that have not yet been bridged, which may include N entries or transactions, again sorted in chronological order. The watchful bridge may then construct a Merkle tree, with each leaf including a transaction k, such that, for example, transaction 1 is concatenated with transaction 2 and hashed to produce output hash H1, transaction 3 is concatenated with transaction 4 to produce output hash H2, and in general for k even and less than N, transaction k is concatenated with transaction k+1 to produce output hash H(k/2).

Security platforms in accordance with several embodiments can, if a transaction i is not to be included in a list of accepted transactions for bridging, replace the transaction with an empty string, or a string representing non-inclusion of a transaction such as “00000000”, and/or a string indicating a reason why the transaction was not confirmed. Subsequently pairs of hash outputs can be pairwise concatenated to produce a Merkle tree root hash, as is familiar to those skilled in the art of Merkle trees, and the root hash can be recorded on the level-1 chain. Security platforms can include other information that may be recorded along with the root hash, for example a beginning block number and an end block number indicating a range in which transaction 1 to transaction N may be found.

In many embodiments of the security platforms, the watchful bridge can include two components: one decision component and one logging component. The decision component can determine, based on security assessments and other assessments, whether a given entry should be confirmed, delayed and/or blocked. In some embodiments, there may be additional categories. For example, the category of blocked entries may have two sub-categories, one including entries that were blocked because they were malformed, and another that was blocked because of identified abuse. Another category may be a category of challenged entries, which may be a form of delayed entries that will be either confirmed or blocked once a response is received to a challenge, and wherein the challenge may include a request for additional contextual information from a party that submitted the entry to be recorded. The confirmed category may include multiple sub-categories, e.g., one where the confirmation is made due to a classification of the party that submitted the entry, and another where the confirmation is made due to analysis of the contents of the entry.

In several embodiments of the security platforms, the decision component of the watchful bridge can include a machine-learning (ML) and/or an artificial intelligence (AI) element that assesses inputs and performs a classification or other analysis using an algorithm and using a set of parameters, where the algorithm, the parameters, and/or some parts of these, may be public or may be secret. For instance, a classifier using an algorithm such as a neural network, support vector machine, and/or AdaBoost could be trained to categorize an entry as confirmed, delayed and/or blocked.

Security platforms in accordance with several embodiments can include a classifier trained to output decisions that then influence the routing of further decision-making to other processes, including a binary classifier that may take on the role of categorizing each entry as “approve” or “process further”, in which case other analysis can be performed to ascertain the proper assessment for an entry.

In certain embodiments of the security platforms, a machine learning algorithm could be used to predict a risk level for a particular entry, for instance using a classifier that classifies an entry as “low”, “medium”, or “high” risk, or using a regression model that assigns a risk probability or real-valued risk score. Such a risk level assessment could be used to assign differential delays to entries, for instance enabling a higher-risk entry more time to be challenged than a lower-risk one before confirming. In certain embodiments, a risk level assessment can be used by subsequent processing to ultimately assign a decision to an entry. Any such machine learning or AI technique may draw on a variety of properties of a layer-1 chain, layer-2 chain, smart contract contents, entities involved in an entry (e.g., purchase histories of wallets), and/or other values as inputs or “features” for informing such decision-making.

In many embodiments of the security platforms, machine learning models trained to perform such tasks may be trained in advance by a trusted authority, for instance an entity managing the watchful bridge, or they may be trained in an online manner to account for entries and phenomena on a particular bridge or set of bridges, and/or they may be configured through the use of transfer learning techniques, such as fine-tuning a pre-trained model on data particular to a given bridge or set of bridges, or a particular set of entries. In certain embodiments, multiple machine learning or AI algorithms may work together, for instance with one algorithm modeling the risk associated with a given contract and another modeling the risk associated with the contracting parties, and the risks output by these models being taken into consideration by a downstream process, which itself may or may not be a machine learning or AI-based process, and which may additionally take other consideration into account.

In many embodiments of the security platforms, the decision component may be distributed and operating according to consensus principles, e.g., where multiple parties make assessments regarding classifications and form a consensus of these by traditional consensus mechanisms. It may also be a quorum-based solution in which participants agreeing with each other apply a digital signature, using a private key that they share using a polynomial secret sharing method. A decision component may also be run by a single party, such as a marketplace, an escrow authority, or an algorithm that is protected using digital rights management (DRM) techniques, runs in a certified trusted execution environment (TEE), or a combination of such.

Security platforms in accordance with several embodiments can include a confirmation vector that may be a vector of binary entries, and/or a vector of other entries. In certain embodiments of the security platforms, an entry may include information about a classification (e.g., that a given entry is blocked) and may include information about the reason(s) underlying the classification, whether a description or a reference to a description. The description may be a log entry, an indicative component, a name of an abuse type or abuse campaign, among various other types of information.

In several embodiments of the security platforms, only elements that are confirmed may be hashed and their associated hash value logged on a level-1 chain. In certain embodiments of the security platforms, other items may also be logged on a level-1 chain, possibly accompanied by a label indicating whether the item is confirmed or not, what the reason is for it to be blocked, where applicable, etc.

In several embodiments of the security platforms, a level-2 chain can be continuously run, parallel to a level-1 chain, and they can be bridged at periodic interval, which may be determined by the number of entries on the level-2 chain that have not been bridged onto the level-1 chain yet; the period of time since the last bridging to the level-1 chain; and/or other heuristic algorithms and processes for determining when to bridge back to the level-1 chain.

Security platforms in accordance with several embodiments can perform, at a same time, the bridging from a level-1 chain to a level-2 chain in a periodic manner, using processes described; which may be done in a manner that is synchronized with or not synchronized with the bridging from a level-2 chain to a level-1 chain.

Security platforms in accordance with several embodiments can bridge from a level-1 chain to a level-2 chain by taking a state from the level-1 chain and adding that as an entry onto the level-2 chain. This can synchronize the level-2 chain to the level-1 chain by proving that the events already recorded on the level-1 chain took place prior to the events not yet entered on the level-2 chain. Similarly, a state of the level-2 chain can be entered on the level-1 chain, e.g., by hashing one or more level-2 elements along with a confirmation vector as described, and logging the resulting value as an entry on the level-1 chain. This can prove that the already-logged entries on the level-2 chain took place prior to yet-to-be-logged entries on the level-1 chain.

In many embodiments of the security platforms, both chains can operate independently of each other. A watchful bridge in accordance with many embodiments of the security platforms may determine a selection of entries from the level-2 chain to be included in the hash to be logged on the level-1 chain, an/d or provide selections identifying which ones of the logged entries are confirmed; other items receive an implicit time-stamp but are not yet officially in existence since they have not yet been confirmed. Security platforms using watchful bridging in accordance with several embodiments can enable selective confirmation of entries made on the level-2 chain, where the selection can be performed based on what associated events and transactions can be determined, by the watchful bridge, to satisfy system criteria that may be specified to govern security requirements of the system. At the same time, a watchful bridge can block entries that are determined to be undesirable according to some criteria known at least by the watchful bridge, but which may potentially correspond to publicly accessible criteria corresponding to undesirable behavior. Other classifications can be made, as disclosed herein; one such classification corresponds to a delay of determining a classification to be either confirmed or blocked, thereby enabling a watchful bridge to collect additional evidence on which to base the determination.

In several embodiments of the security platforms, the watchful bridge can include several processes where each process owner (e.g., identified by a given signing key) holds a stake in a shared resource pool where the resources are received from and distributed to non-stakeholders. Security platforms in accordance with several embodiments can include a resource pool that is an automated market maker pool (AMM) and/or liquidity pool where traders (e.g., non-stakeholders) submit resources to a smart contract on one chain such as a level 2 chain in order to receive a distribution of a resource on the paired level 1 chain. Bridge stakeholders can be rewarded for monitoring the resource pool and submitting distribution transactions when resources are received from traders on the paired chain. The resource pool can be controlled by smart contracts which restrict the distribution amounts to the stake held by the watchful bridge owner submitting the distribution transaction. In certain embodiments, the stakeholder cannot distribute more than their stake.

Security platforms in accordance with several embodiments can submit transactions by bridge processes which can be ordered by consensus and chained in a Merkle tree. As stakeholders distribute their stake they may no longer be able to fulfill distributions. Other stakeholders can be allowed to submit distribution transactions and in so doing lengthen the transaction chains and associated Merkle tree. This lengthening of the transaction chain can act to increase confidence that the prior distributions are legitimate. In certain embodiments, each subsequent submission might be weighted as a percentage of the pool. As the confidence level increases for a given distribution that stakeholder then regains a relative percentage of stake available for distribution. Likewise, a subsequent distribution may vote against a prior distribution by for example the explicit exclusion of that distribution from the transaction chain and Merkle tree. If subsequent distributions by other stakeholders continue to vote in favor of no confidence this can result in the entire loss of stake by the badly behaved stakeholder. Since a stake can include the distributable portions of stake plus a non-distributable portion of the stake including earned interests and fees, this can lead to a significant loss to the stakeholder. Stakeholders may also be required to fulfill pending distributions and participate in votes of confidence/no-confidence to prevent locking up other stakeholders distributions and/or automatically lose portions of their stake to the shared pool. A complete proof of history may include the signed transactions submitted by all actors including traders and bridge stakeholders. This can allow each smart contract to determine the legitimacy of a given transaction prior to any subsequent release of funds. This means that a bad actor might improperly disburse a percentage of its own stake but cannot cause the other stakeholders any losses. Security platforms in accordance with several embodiments can include rules such as withholding funds in escrow in order to cover any illegitimate transactions ensure that traders can be fully compensated for losses incurred in any illegitimate transaction.

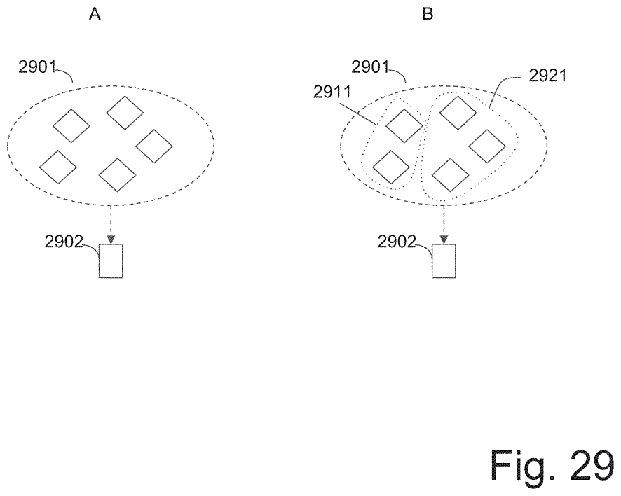

An architecture for facilitating voting between several entities to determine the recording of entries on a blockchain in accordance with an embodiment of the invention is illustrate in FIG. 29. In particular, FIG. 29 illustrates an example in which a several entities, in this example 5 entities 2901, communicate with each other. An entry 2902 of the first blockchain (e.g., a layer-2 blockchain) can be identified to be recorded on the second blockchain (e.g., a layer-1 blockchain). The identification of the entry may be done by one of them declaring what entry is to be bridged (e.g., recorded) to the second blockchain using a watchful bridge as described and the others vote on this declaration. Each entity may have a vote (e.g., one vote) or individual entities may have several votes and all entities need not have the same number of votes. Some may have a non-integer number of votes, (e.g., 3.721 votes). In several embodiments, the votes may be determined by the resource(s) staked. FIG. 29 under the letter A, it is illustrated that the several entities 2901 are about to vote regarding entry 2902. Under the letter B, the voting has taken place and in this example the votes of three entities 2921 are in majority over the votes of the other two entities 2911. In this illustrative example, the majority of votes (not necessarily the majority of entities) 2921 may have voted for the entry 2902 to be confirmed corresponding to step 2620 of FIG. 26, where the watchful bridge may then perform the recording (e.g., 2630 of FIG. 26) the entry 2902 on the second blockchain as confirmed. While specific processes are described above for bridging from a first blockchain to a second blockchain based on voting with reference to FIG. 29, any of a variety of processes for can be specified for bridging from a first blockchain to a second blockchain based on voting as appropriate to the requirements of specific applications in accordance with various embodiments of the invention.

In certain embodiments of the security platforms, instead of or in addition to casting a vote, an entity may add to the proof of history or add to the Merkle tree proof, either including or excluding the contested transaction. A single inclusion with the contested transaction signed by the trader can be sufficient proof that the transaction is valid and that any proofs that excluded the transaction are false. In certain embodiments of the security platforms, a stakeholder may be required to sign a trade authorization prior to the submission of an exchange order which gives the trader proof that a put transaction is valid and allows the smart contracts on either side to verify the transaction history.

Security platforms in accordance with many embodiments can utilize a wide variety of security techniques that can be implemented using the filtering techniques as appropriate to the requirements of specific applications. Described below are some illustrative but non-limiting examples of such techniques, some of which can implement security techniques and others which can implement other types of desirable functionality.

Security platforms in accordance with several embodiments can be used to block transactions that are determined to be associated with fraud, e.g., when it can be determined that a transfer of ownership was performed in response to a phishing attack or a malware attack; such evidence can be collected by an anti-virus software unit associated with the wallet of the victim of the abuse. Security platforms in accordance with several embodiments may also determine that a user has field a request to undo a transaction, where the request may include an indication of why the transaction should be reversed.

Security platforms in accordance with several embodiments can be used to modify and/or augment a recorded entry, e.g., to provide additional details or to correct a typo. Security platforms in accordance with several embodiments may receive requests from systems associated with the submission of the original entry to modify the entry, and may save a timestamp both of the original entry and the modification, and content describing both the original entry and the modified version, or content describing both the final version and the modification made from the original entry. The use of modifications can also be employed to annotate previously recorded data with comments, where these comments may be provided by parties different from the originator of the entry.

Security platforms in accordance with several embodiments may require that transactions that are to be performed have a tracking feature enabled, as disclosed in U.S. Provisional Patent Application Ser. No. 63/322,265 filed Mar. 22, 2022 entitled “Escrowed Wallet and Transaction Tracking Technology” by Markus Jakobsson, which is herein incorporated by reference in its entirety. Once a user creating a set of ciphertexts provides evidence that these are well-formed and enables tracking, should such be needed, there can be a determination by the watchful bridge that the associated transaction is confirmed; however, until such evidence is presented to the watchful bridge, this bridging may not be performed, and the associated transaction can be kept in “delayed” state on the level-2 chain.

Security platforms in accordance with several embodiments can provide for a tiered minting mechanism, where a low-cost minting operation associated with the recording of an event an/or transaction on the level-2 chain is permitted, and where the confirmation of the event and/or transaction is not performed until a larger payment is performed. Security platforms in accordance with several embodiments that utilized tiered minting methods can enable a large number of tokens to be minted at a low cost, and then selectively logged on the level-1 chain after a second payment is performed, the second payment causing the watchful bridge to confirm the associated entry. Other techniques for delayed minting are disclosed in U.S. Provisional Patent Application 63/362,880 filed Apr. 12, 2022, entitled “Instant NFTs and Protection Structure” by Madhu Vijayan, Markus Jakobsson, Keir Finlow-Bates and Stephen C. Gerber, which is herein incorporated by reference in its entirety.

Security platforms in accordance with several embodiments can reverse a transaction recorded on a level-1 and/or level-2 chain by an escrow authority. Associated approaches, which are compatible with the instant invention, disclosed in U.S. Provisional Patent Application Ser. No. 63/366,391 filed Jun. 14, 2022 entitled “Reversal of Blockchain Transactions” by Keir Finlow-Bates, Markus Jakobsson, Stephen C. Gerber and Stefan Dufva, which is herein incorporated by reference in its entirety. The disclosed methods are also compatible with the technology disclosed in U.S. Provisional Patent Application No. 63/365,464 entitled “Safeguarding Ownership Transfer Against Abuse” by Jakobsson, filed May 27, 2022, the disclosures of which are hereby incorporated by reference in their entirety for all purposes.

Security platforms in accordance with several embodiments can use a delay function that permits the enforcement of policies such as a blocking of resale of an NFT within a specified period of time, (e.g., such as 30 days). In certain embodiments, security platforms can determine whether the NFT may be resold, based on terms of service (ToS) associated with it, by the watchful bridge, and causing a delay of the reporting if the NFT may not be resold. Once the resale is allowed, it may automatically go through. Alternatively, a watchful bridge can block the resale when not allowed according to the ToS, and require the owner to re-initiate the sale once it is allowed to do so.

Many embodiments of the security platforms may enable an ability for the marketplace or creator wallet to recall, repossess, and/or burn the NFT in the case of a fiat card chargeback event or similar fraud if the NFT has not already been resold. This scenario may be effective for auctions where an NFT is not claimable by the winning wallet for a certain time period, for example, 14 days.

In many embodiments of the security platforms, a watchful bridge can ascertain that royalties are paid properly, or that other terms of service are abided by, and enable transactions that are acceptable. This is also described from another perspective in U.S. Provisional Patent Application Ser. No. 63/365,268 filed May 24, 2022 entitled “Content Lock Mechanism” by Markus Jakobsson, methods of which are compatible with the instant invention and which is herein incorporate by reference in its entirety.

In many embodiments of the security platforms, a watchful bridge can determine that a transfer of ownership was performed by a malware agent, e.g., based on the associated wallet not being operated on by its owner, but commands having been performed, where these commands were indicative of abuse and resulted in the transfer of ownership. Something may be abusive if it is determined that it was performed by a script that the user of the wallet did not intentionally run, for example.

Security platforms in accordance with several embodiments that include watchful bridges may toggle rules, e.g., set a rule to be active or not active. Certain embodiments can cause tracking of IP addresses of any party accessing content associated with a token for which rules are toggled, whereas tracking was not enabled prior to the toggle. Tracked IP addresses may be processed locally in a DRM module and reported to an authority if a condition is met. Alternatively, tracked IP addresses may be encrypted and transmitted to the authority to decrypt and review. Other rules may govern how content can be used, including restrictions to view content, share content, resell content, resell content within a given period of time, etc.

In several embodiments of the security platforms, actions taken by a smart contract can be unwound, reversed, or refunded. For example, a creator may specify a smart contract for 10,000 NFTs to be minted by anonymous users. The creator may offer a guarantee, whether coded in the smart contract or not, that the users will receive their mint funds back if the project is found to be fraudulent, or doesn't mint 100%, or if the NFTs fall below a valuation threshold determined by the creator. The capability to refund in such scenarios may be coded in the smart contract or assigned to an authority such as the creator. Additionally, a marketplace or other third-party, such as a bounty hunter or insurance agent, may be assigned the responsibility for determining a need for refund in full or partial. Such policies may require proceeds to be held for a pre-specified period of time.

In many embodiments of the security platforms, a watchful bridge can enforce token locks. Token locks are disclosed in U.S. Provisional Patent Application Ser. No. 63/365,268 filed May 24, 2022 entitled “Content Lock Mechanism” by Markus Jakobsson, methods of which are compatible with the instant invention and which is herein incorporate by reference in its entirety.

Security platforms in accordance with many embodiments include watchful bridges that can be used to implement a refundable mint. The refund assurance can be associated with a condition, which could relate to a time, an event, or the absence of an event. In many embodiments, if a watchful bridge determines that the condition cannot be satisfied, minted tokens, which reside on the level-2 chain, can be transferred to the level-1 chain. Until this occurs, the tokens may be delayed to remain on the level-2 chain. There are many examples of why a refundable mint is desirable, including for example, to launch a project with a claim that the mint is refundable helps alleviate misinformation attacks, concerns, trepidation; to be able to guarantee a mint sells-out or money back; to guarantee that a project achieves a specific valuation or popularity on-chain in a given time-window, or people get their money back; to create an assurance that if a contract has an error that is problematic or fatal and monies can be returned; to generate assurances that if a project is found to be immoral/illegal/unethical or simply a “rug”, money can be refunded.

In many embodiments of the security platforms, a watchful bridge can also be used to enforce a repossession of a token. For example, consider a token that is purchased by a user A from a seller B, and the smart contract specifies that A would pay B a specified amount of money (whether fiat currency or crypto currency) according to a specified payment schedule. If A does not make the requisite payments, B may report the breach of contract to the watchful bridge or an entity communicating with the watchful bridge, generating a request that the token be repossessed. Before this takes place, a verification can be performed that the payments were indeed not performed.

Many embodiments of the security platforms are not necessarily limited to the interface between level-1 and level-2 blockchains (also commonly referred to as L1 and L2 chains), but can also be applied in the interface between other blockchains, such as level-2 and level-3 (e.g., L3) chains, or between distinct L2 chains. One or more of the chains may be private chains, where the database implemented by the blockchain is not publicly viewable. One or more of the blockchains may be permissioned.

Security platforms in accordance with many embodiments may also be used to implement a layered chain of bridges. In several embodiments of the security platform, a first bridge between a first (L1) blockchain and a second (L2) blockchain, a second bridge between the second blockchain and a third (L2 or L3) blockchain, and so on, up to an nth bridge between an nth blockchain and an (n+1)th blockchain. A watchful bridge at any given rank k may monitor one or more actions performed by bridges at a higher rank k+l, where both k and l are integer values. In certain embodiments, a watchful bridge can monitor actions at lower ranks.

Security platforms in accordance with many embodiments can use different levels of security for standards of verification for different ranks of bridges. For example, a watchful bridge of rank 3 may simply regularly transfer all transactions from a fourth blockchain to the third blockchain, whereas a watchful bridge of rank 2 may require a suitable waiting period to have passed without a challenge from a bounty hunter before transferring all transactions from the third blockchain to the second blockchain, and a watchful bridge of rank 1 may require active validation by a validator before transferring all transactions from the second blockchain to the first blockchain. Accordingly, different security verifications can be used for different layer ranks, with more secure, computationally expensive, and/or different verifications for lower ranked layers.

In several embodiments of the security platforms, watchful bridges may be implemented between shards of a sharded blockchain. In certain embodiments of the security platforms, the watchful bridge may implement a process P, as disclosed in U.S. Provisional Patent Application No. 63/365,464 entitled “Safeguarding Ownership Transfer Against Abuse” by Jakobsson, filed May 27, 2022, the disclosure of which is hereby incorporated by reference in its entirety for all purposes. By incorporating process P in the watchful bridge, it may be possible to, for example, tie a token to being transacted on a given level-2 chain, e.g., by one or more marketplaces that are configured to transact on the specified level-2 chain, where the process P is used to verify that terms of service associated with the transacted token are satisfied. By tying a token to be transacted onto the specified level-2 bridge, the watchful bridge can verify that terms of service and security constraints are satisfied, and to block transactions that are not allowed. Once this is verified, the token would be bridged onto the associated level-1 chain, where it would reside until the next ownership transfer transaction, which again would place the token onto the level-1 chain. To avoid private transfers and require the involvement of the watchful bridge, the process P used to verify the terms may possess part of the key used to transfer ownership, as disclosed in the co-pending application titled “Safeguarding Ownership Transfer Against Abuse” by Markus Jakobsson. The watchful bridge may include a collection of processes P1 . . . Pn, associated with originators O1 . . . On, each process Pi addressing security needs associated with the associated originator Oi. The watchful bridge may determine, from a token, what the originator was and based on this determine the appropriate process Pi. If the selected process Pi agrees to a transaction, then this transaction can be confirmed; otherwise it may be blocked or otherwise stopped from being recorded on the level-1 blockchain, e.g., by classifying it as “in violation”, causing the party requesting the transaction to have to remedy a problem associated with the identified violation.

In several embodiments of the security platforms, a level-1 blockchain can be operated to receive a signal that a token recorded on it has a problem, which can cause the automated transfer of the token to an associated level-2 blockchain. The level-2 blockchain can receive it and cause it to be rerouted back to the level-1 chain, via a watchful bridge, where the token can be filtered and optionally modified, blocked or delayed. Security platforms in accordance with several embodiments can perform filtering that is performed in the bridge from the level-1 chain to the level-2 chain. Non-limiting examples of modifications of a token include changing the terms of the token, changing the content associated with the token, changing the reference to content associated with the token, and/or changing access rights associated with the token. Here, examples of problems include but are not limited to an association of malware with a token, abusive use or transfer of the token including failure to pay royalties and circumvention of DRM mechanisms, loss of token in a scam, and identification of the token having malicious or illegal content. Tokens may also periodically be transferred from the level-1 chain to the level-2 chain in response to non-problem events, such as a transfer of ownership rights, and/or pending such transfer. As they are received on the level-2 chain, they may be evaluated from the perspective of whether a filter action should be taken. Some marketplaces may operate on the level-2 chain, therefore requiring the transfer of a token to be put up for sale from a level-1 chain where it resides to the level-2 chain on which the marketplace operates. In some jurisdictions, all marketplaces may be required to operate on a level-2 chain or to otherwise channel tokens through the watchful bridge as part of a transaction or the preparation ahead of a transaction. The modification of a token may result in response to the token being transacted in a jurisdiction where escrowing of content is required, where the modification may involve the adding to a token of references to an escrow database. Escrow techniques were disclosed in U.S. Provisional Patent Application Ser. No. 63/322,265 filed Mar. 22, 2022 entitled “Escrowed Wallet and Transaction Tracking Technology” by Markus Jakobsson which is herein incorporated by reference in its entirety. The modification of a token may also cause some content to be modified to be converted into ciphertext, to be converted into plaintext, to be modified to require tracking by DRM modules, and/or modified to not allow tracking by DRM modules.

In several embodiments of the security platforms, a proof of stake mining operation may operate on a level-2 chain, therefore requiring assets to be transferred to the level-2 chain to be used for staking. This can enable forfeiture of stakes in case of abuse by having the watchful bridge cancel tokens or modify their value in response to detections of abuse.

In several embodiments of the security platforms, a watchful bridge includes a multitude of entities and operates using a consensus mechanism. In several embodiments of the security platforms, the watchful bridge is a centralized party, and in yet another, it relies on a quorum of participants, each one which has a share of a private key used for bridging operations.

In several embodiments of the security platforms, a user may be able to view content that has been transferred away for a set period of time, (e.g., one week, among others). The content may be rendered at a lower quality than when the user/wallet owned the associated token, but may still be viewable, at least in part after it has been sold. The user may report that the sale was not legitimate, e.g., using a reporting button that is placed in, on, or next to the rendered content. The user's wallet may store a degraded version of the sold content, or may buffer the content of the sold token for a limited period of time and cause optional degradations of it at the time it is rendered, along with making modifications to cause an overlay of buttons for the user to report abuse, e.g., “I was scammed to sell this NFT”, “Malware caused me to sell this NFT”, “I did not know that this NFT was sold”, “This NFT was sold by somebody I know who had access to the wallet”, etc. By selecting one or more such buttons and clicking on the appropriate buttons, the user can cause a report, corresponding to a complaint of abuse, which then can be processed by the user's wallet and/or associated software agents, wherein the processing may collect evidence supporting the report, when applicable, and transmit information, assurances, evidence etc. to a adjudicating party. The adjudicating party may be part of the watchful bridge, or in communication with it, and make a determination of whether to undo the reported transaction, whether to destroy or degrade the token, whether to turn on tracking or toggle other functionality, etc.

Security platform in accordance with many embodiments can provide tokens that have content with more than one modes of presentation, where one mode of presentation may be a higher-quality mode than another mode. For example, at least one may have higher resolution and enhanced audio, or additional content not provided in the other mode. In many embodiments, the mode of presentation may be determined based on where the token resides. In many embodiments, different presentations can be provided for different levels of the blockchain. In certain embodiments, a presentation with a higher-quality mode of presentation can be associated with a token as it resides on a blockchain such as a level-2 blockchain, and associated with a lower-quality mode of operation as it resides on another blockchain, such as a level-1 blockchain. A switch between the presentation modes may be made by one or more watchful bridges with access to decryption keys that enables access to plaintext data that allows modification of content, e.g., inclusion of enhanced quality data with the token. Alternatively, the watchful bridge may simply toggle one or more data switches that are read by DRM modules that determine the manner in which to present the content associated with the token, such switches determining the quality level.

In several embodiments of the security platforms, the classification of an entry on a blockchain, by a watchful bridge, may result in the transfer of the entry to another blockchain, e.g., (which can be referred to as “bridging”), or by delaying the transfer, or by blocking the transfer. Security platforms in accordance with many embodiments can perform different actions as will be understood by a person of skill in the art. In many embodiments, a classification may be based on a characterization of a node associated with the entry, where the entry may include a token. Characterizations of nodes is disclosed in U.S. Patent Application Ser. No. 63/367,206 filed Jun. 28, 2022, titled “Node Characterization and Scoring Method” by Markus Jakobsson which is herein incorporated by reference in its entirety.

Watchful bridges may include or communicate with one or more processes P performing tasks as disclosed in U.S. Provisional Patent Application No. 63/365,464 entitled “Safeguarding Ownership Transfer Against Abuse” by Jakobsson, filed May 27, 2022, the disclosure of which is hereby incorporated by reference in its entirety for all purposes.

In several embodiments of the security platforms, transactions can be evaluated and selectively reversed using the techniques described herein, combined with the techniques disclosed in U.S. Provisional Patent Application Ser. No. 63/366,391 filed Jun. 14, 2022 entitled “Reversal of Blockchain Transactions” by Keir Finlow-Bates, Markus Jakobsson, Stephen C. Gerber and Stefan Dufva, which is herein incorporated by reference in its entirety, and which described technically distinct methods achieving related goals, some components of which are related with each other and which are compatible.

In several embodiments of the security platforms, watchful bridges can be one or more hardware components configured with instructions to perform the tasks disclosed herein. In many embodiments of the security platforms, this may be a distributed process involving a multiplicity of entities, each one of which is represented by a hardware entity that is configured with instructions. Some of the entities may use the same hardware, e.g., where the watchful bridge includes components that run in a cloud environment. In several embodiments of the security platforms, the watchful bridge is a software unit, such as an app, a DRM module or another program, which may run in a trusted execution environment (TEE), or an environment that is otherwise secured against malware attacks, e.g., using high-quality anti-virus software, software-based attestation technologies, and/or a combination of such elements.

### Safeguarding Ownership Transfer Against Abuse

Security platforms in accordance with many embodiments can be used for safeguarding ownership transfer against abuse, e.g., theft. Security processes may be referred to herein as “process P” or simply “P”. Processes in accordance with many embodiments may be an algorithm, e.g., a machine learning (ML) component, an artificial intelligence (AI) component, a heuristic process, a rule-based process, or a combination of such. It may include public components and/or secret components, where such components may be algorithmic and/or parameter choices governing the functionality of algorithmic components. P may be associated with at least one public key/private key pair, it may be a consensus mechanism, or both.

Security platforms in accordance with many embodiments can include an that is to change ownership, maybe referred to herein as an NFT as described, however, the object to change ownership for may be any digital asset, including fungible tokens, contracts, information, digital signatures, among others. Generally, an owner of an NFT owns, or is associated with, a wallet which in a sense can be said to “own” the NFT. The wallet can be generally referred to as the owner of the NFT, even though the wallet is not the legal owner of the NFT.

When the ownership of an NFT is to be transferred from a first user to a second user, or from a first wallet address to a second wallet address, the transfer may be intentional or unintentional by a first user, (e.g., original owner or seller). In case it is unintentional, the transfer of ownership may generally be unintentional or illegal (e.g., theft, scam, human error) of the NFT, but other forms of abuse may also be present in the case the first user wants to sell the NFT to the second user. In all such cases, processes of the security platforms in accordance with several embodiments may help safeguard a first user (e.g., seller/owner) from abuse and misfortune as described herein.

In several embodiments of the security platforms, an NFT can be “owned” by a first wallet associated with the legal owner of the NFT. If an ownership change is initiated for the NFT, which may be performed by a user of the wallet to which the NFT belongs, by malware infecting the wallet, or by a malicious contract, then that causes the wallet to agree to an ownership change. In many embodiments, this ownership change may not be completed until the security platforms P also agrees. Thus, the wallet and the security platforms P may be equal owners, both of which need to agree for a sale of the associated asset. In certain embodiments, security platforms P may be the only owner, receiving requests to transfer ownership from an associated wallet. There may be multiple wallets with the rights to issue such requests for a given asset. In several embodiments of the security platforms, the wallet is the one and only owner. Thus, in certain embodiments, security platforms processes may be implemented in many different ways as detailed herein. As the wallet initiates the ownership change, the security platforms may be notified of the transaction. Security platforms may execute in a safe environment on the same device as the wallet is executing, such as in TrustZone or another Trusted Execution Environment (TEE). Security platforms P may also be executing on another device, such as (but not limited to) a cold wallet, a cellular phone of the user to which the wallet belongs, on a cloud server, a web browser, a marketplace handling transfer of ownerships of tokens, or within an ethereum virtual machine, among others.

Security platforms in accordance with many embodiments can be able to perform verifications and based on these block a transfer of ownership, based on a result of the verifications. In particular, as the security platforms are notified of the change of ownership request from the wallet, the security platforms can initiate a verification which may include additional details normally not available within the wallet approval environment, and pending that verification, determine whether to agree to or refuse to agree to the ownership change initiated by the wallet. In many embodiments, if a security platforms agrees to a ownership change, the security platforms may copy the assignment of ownership change from the request initiated by the wallet, thereby causing the ownership change to take place, e.g., be recorded, or inform the marketplace that the transfer of ownership is granted so that the marketplace may perform the transfer of ownership. In many embodiments, if a security platform in accordance with many embodiments does not agree to the ownership change, an NFT can remain in the possession of the wallet and it does not belong to the proposed new owner. Thus, security platforms in accordance with many embodiments can be able to block a transfer of the ownership, based on a result of a verification.

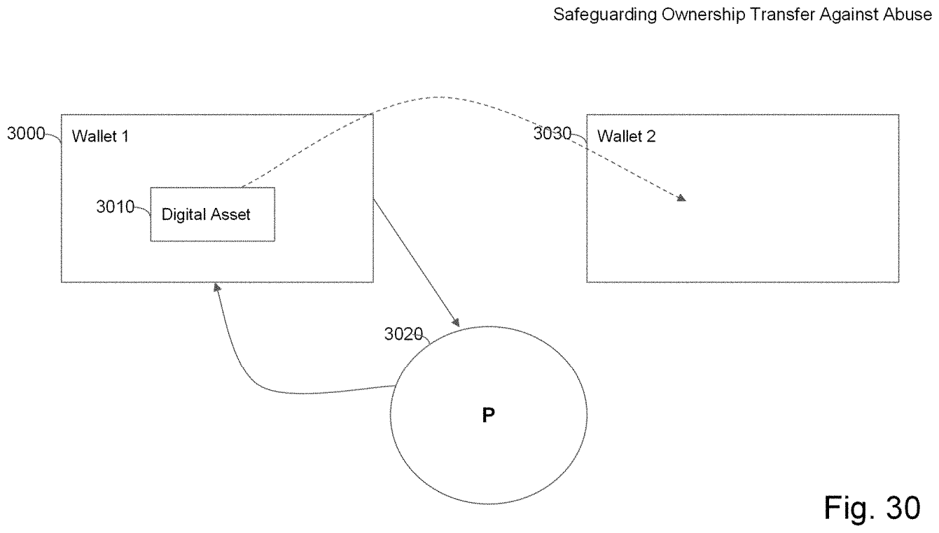

An illustration of a transfer of ownership of a token from different wallets in accordance with an embodiment of the invention is illustrated in FIG. 30. In particular, FIG. 30 illustrates a situation in which a wallet 1 (3000) wishes to transfer ownership of a token 3010, to a wallet 2 (3030). In order to execute the transfer of the token 3010 from wallet 1 to wallet 2, security platforms in accordance with several embodiments can perform one or more processes, (3020). Security platforms in accordance with many embodiments can perform at least one verification/approval task as described herein.

A verification can be deemed either successful or unsuccessful. If the verification is deemed successful, security platform can approve a transfer of ownership of a digital asset, and if the verification is deemed unsuccessful, it can disapprove a transfer of the digital asset. Approving a transfer may include actually performing the transfer or giving consent to perform the transfer as described. Likewise, disapproving the transfer may include actually blocking or aborting the transfer. Although FIG. 30 illustrates a particular architecture for transferring a digital asset between different wallets using a security platforms, any of a variety of transfer techniques using different architectures can be utilized as appropriate to the requirements of specific applications in accordance with embodiments of the invention. Processes of safeguarding transfer of assets between wallets are described in detail below.

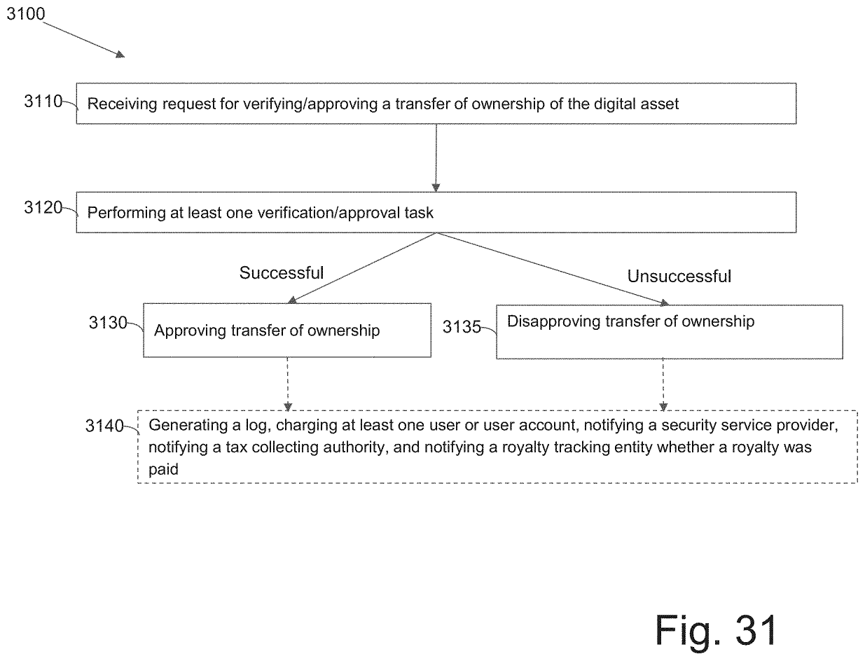

A process for safeguarding ownership transfer of a digital asset against abuse in accordance with an embodiment of the invention is illustrated in FIG. 31. In particular, FIG. 31 illustrates the process (3100) receiving (3110) a request for verifying/approving a transfer of ownership of the digital asset. Once an owner or a wallet initiates a transfer of ownership of the digital asset, which can be done e.g., by the owner or a smart contract associated with the digital asset, the user may actively request to ascertain the safety of the ownership transfer or the wallet, a script associated with the wallet and/or the digital asset may request to ascertain the safety of the ownership transfer. A process can perform (3120) at least one verification/approval task. This may include a variety of different steps or individual tasks as is also described and exemplified herein.

The performance of at least one verification/approval task results in the verification being deemed successful (3130) or unsuccessful (3135), such that a successful verification can be that the transfer of ownership is safe (or relatively safe) and that an unsuccessful verification can be the transfer of ownership is unsafe (or relatively unsafe). Depending upon the outcome of the at least one verification/approval task, the process can approve (3130) or disapprove (3135) the transfer of ownership. Approving the transfer may include actually performing the transfer or giving consent to perform the transfer as described. Likewise, disapproving the transfer may include actually blocking or aborting the transfer. In many embodiments, the process can include optionally generating (3140) a log, charging at least one user or user account, notifying a security service provider, notifying a tax collecting authority, and/or notifying a royalty tracking entity whether a royalty was paid. While specific processes for safeguarding the transfer of digital assets are described above with reference to FIG. 31, any of a variety of processes that can safeguard the transfer of assets can be utilized as appropriate to the requirements of specific applications in accordance with various embodiments of the invention. Additionally, the specific manner in which digital assets (e.g., NFTs) can be transferred within NFT platforms in accordance with various embodiments of the invention is largely dependent upon the requirements of a given application.

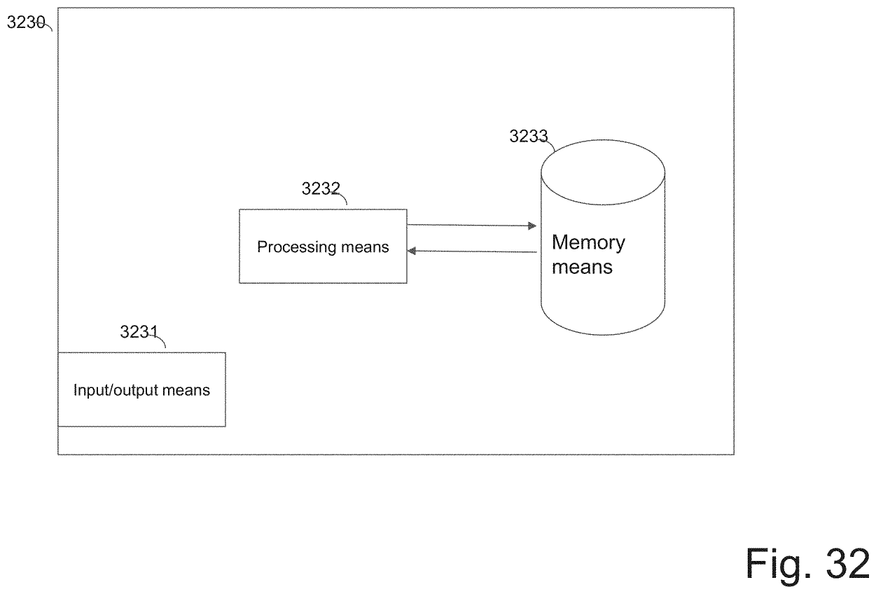

A circuit architecture of a device for safeguarding ownership transfer of a digital asset against abuse in accordance with an embodiment of the invention is illustrated in FIG. 32. The device 3230 can include input/output means 3231 by means of which the device 3230 may receive information and transmit or provide information to other units, devices and/or entities. FIG. 32 also illustrates the device 3230 can include processing means 3232 and memory means 3233, the memory means 3233 including instructions, which when executed by the processing means 3232 causes the device 3230 to perform one or more processes. Although FIG. 32 illustrates a specific circuit architecture of a device for safeguarding ownership transfer of a digital asset, any of a variety of circuit architectures may be utilized as appropriate to the requirements of specific applications in accordance with embodiments of the invention.

Security platforms in accordance with many embodiments can perform verifications which can take many forms. In certain embodiments, a verification may use user interaction and it may be fully automated without user interaction. Security platforms may scan blockchains for transactions, by obtaining complaints from bounty hunters, and/or by detecting inconsistencies, such as an offer of a token for sale by a first party different from a second party that the content service understands to be the proper owner.

Security platforms in accordance with many embodiments may also query at least one database in order to determine whether or not a smart contract is listed in a database as being malicious and/or “legitimate”. Security platforms may cause a message to be displayed to a first user, where a message identifies a transfer request and at least some of the terms of the transfer. For example, a message may state that a token with an identified name and icon is requested to be transferred to a user with an identified name and icon; the message may state whether the proposed recipient user is a party that the wallet has previously interacted with; what the reputation is of the proposed recipient user; among others. The message may also specify a terms of the transfer, e.g., 1 ETH is being transferred out, or an NFT believed to be worth $1000 is being sold for $0.10. Any great discrepancy may be highlighted and require the user receiving the message to perform an action to approve the transfer, e.g., confirm that he understands that the exchange is below market rates. Users may set the thresholds that govern what is considered an anomaly, or the system in accordance with many embodiments may learn from past actions of the user, e.g., what the user agrees to, what the user considers the proper threshold. The user receiving the message may have to approve the transaction for the security platforms P to complete the transfer.

In security platforms in accordance with certain embodiments, a user receiving a message may have to not block the transaction within a set time period, such as 48 h, for the security platforms P to complete the transfer. In several embodiments, the user receiving the message may have to approve a transaction within a set time period, (e.g., within 36 h), for the security platforms to complete the verification/transaction/giving consent to a marketplace to transfer the ownership. Security platforms in accordance with many embodiments may generate multiple messages, each one of which, or some threshold number of which may need to be responded to in a pre-specified manner, for the security platforms to complete the verification/transfer/giving consent to a marketplace to transfer the ownership. Security platforms in accordance with many embodiments may cause a message to be sent to a number (e.g., 5 users), and require that at least a certain number (e.g., 3) of these respond positively for the transfer to be completed. In certain embodiments, if only one recipient of the message is available to approve the transfer, this may be sufficient, but may require an escalation verification in which this available user has to perform additional actions in order for the transfer to be effectuated by a security platform.

Security platforms in accordance with several embodiments can perform user interaction as part of a verification process, e.g., using the user interaction approach disclosed in U.S. Provisional Patent Application Ser. No. 63/314,293 entitled “Second Factor Improvement Technology” by Markus Jakobsson and Keir Finlow-Bates, which is herein incorporated by reference in its entirety.

Security platforms in accordance with several embodiments can perform a verification that can include a determination of whether a pending transaction is safe, unsafe and/or undetermined in terms of safety. In many embodiments, a safe transaction may be automatically approved by a security platform, (e.g., without the use of a user-facing verification, among others). An unsafe transaction may be automatically blocked by a security platform, (e.g., also without the use of a user-facing verification). Security platforms in accordance with many embodiments may perform at least one user-facing verification if an automated verification results in an assessment that corresponds to being undetermined in terms of safety. This may correspond to having a risk score/level that exceeds a threshold value e.g., threshold of n (below which a transaction is considered safe) but below a different threshold e.g., n+1 (above which the transaction is considered unsafe). The scores/levels may be generated using one or more and/or combination of methods, including heuristic methods, rule-based methods, Artificial Intelligence (AI) methods and Machine Learning (ML) methods as appropriate to the requirements of specific applications in accordance with embodiments of the invention. Examples of such methods are disclosed in U.S. Provisional Patent Application Ser. No. 63/365,186 entitled “Detection of Malicious Code within Blockchain Smart Contracts” by Keir Finlow-Bates and Markus Jakobsson, which is herein incorporated by reference in its entirety.

Security platforms in accordance with many embodiments may perform different processes and/or types of automated verification procedures, portions of which may be performed by third parties, such as cloud-hosted security services receiving requests from the security platforms to determine the safety of a given pending transaction, e.g., based on information about recent trends in payment requests by other wallets.

In several embodiments of the security platforms, the verification of an ownership change by the security platforms can employ machine learning (ML) or artificial intelligence (AI) techniques. In certain embodiments, as described, a machine learning model may be used to predict whether a pending transaction is safe, unsafe, or undetermined, and the prediction outcome may influence the subsequent verification process. In several embodiments of the security platforms, the machine learning used for a prediction may employ a pre-trained model, for instance trained before the creation of a token to predict risk based on properties of the transaction, associated wallets and their histories, among various other factors. In many embodiments of the security platforms may additionally employ a model trained, refined, or updated to reflect the activities of the owning wallet and/or user, for instance reflecting a history of transactions that are typical or atypical for this user in its computation of risk. A machine learning model component of the security platforms may be embodied as a script or parameters stored within the NFT metadata itself and/or on a server or cloud computing service referenced by the NFT metadata.

In several embodiments, security platforms P may employ differential verification procedures based on properties or phenomena that do not explicitly pertain to risk. In certain embodiments, security platforms P may also employ ML or AI techniques to accomplish this. For instance, an ML classifier may be used to characterize a proposed transaction as one of several transaction classes, based on the type of asset being potentially sold, the price of the asset, the asset's history, or properties of the asset metadata and/or of media or other data linked to the asset metadata. The security platforms may then employ different verification processes for different classes. For example, security platforms may employ different verification user interfaces for the transfer of tokens associated with different types of data, for instance employing a user interface that presents an image thumbnail to ask for approval to transfer an NFT associated with an image, while employing an audio playback interface to ask for approval for transferring an NFT associated with an audio file. Security platforms P may employ a machine learning image classifier to determine whether an image NFT is of class “NFT artwork” or “personal/family photo”, and may employ one user verification process for all NFT artworks, for which fraudulent transactions may be the primary concern, and a different process for personal/family photos, for which ease of sharing with certain known contacts and preservation of privacy beyond those trusted contacts are primary concerns.

In many embodiments, the use of the security platforms can protect against unwanted transfers, e.g., transfers initiated by malware and/or malicious contracts. It may also help protect against unwanted transfers that are based on social engineering of a user authorized to initiate transfers, where one example social engineering attack may involve the theft of access credentials used by such an authorized user, e.g., by a criminal, and another example social engineering attack may involve the criminal posing as a trusted party and requesting the user authorized to initiate transfers to perform an action. In many embodiments, security platforms P may also help protect children against hasty decisions, e.g., by requiring a parent to be the party approving a transfer request. The security platforms may also be used to govern other actions, such as changes of access control, and is therefore not limited to protecting against undesirable ownership changes only. This can be achieved in contexts where changes of access control may need to be approved by an owner of a token, and the token can be assigned to a security platform as at least one of its owners.

In many embodiments, security platforms may run processes that operate on-chain, on another chain layer (such as an L2 layer), and/or from an oracle. The security platforms may include processes that are fully automated and work to detect risk of fraudulent activity based upon characteristics of a market(s), an origination wallet(s), a destination wallet(s), previous transaction(s), among various others. For example, an artificial intelligence (AI) may identify a relatively fresh and non-doxxed destination wallet as having received assets from a variety of wallets without appropriate level of reimbursement, such as a wallet associated with widespread phishing attacks.

In several embodiments, security platforms P can be third-party services, e.g., implemented using a web server, receiving requests from a wallet to transfer ownership of one or more tokens; performing a verification and conditional on the outcome of the verification, determining whether to approve the ownership transfer. The security platforms may perform an automated verification, and then optionally contact one or more parties in order to perform an interactive component of the verification. Based on the responses from the one or more parties contacted, a second automated verification may be performed, and optional additional interactive verifications. After completing the verifications, third-party service can provide information used the security platform to perform an action, which may include one or more of approving the transfer, not approving the transfer, generating a log, charging at least one user or user account, notifying a security service provider, notifying a tax collecting authority, and/or notifying a royalty tracking entity whether a royalty was paid, among various other actions.

Security platforms in accordance with several embodiments can be implemented as being part-owner of an NFT, where the security platforms P and/or a wallet conjunctively may need to approve a transfer of ownership of an NFT. Security platforms may perform processes on behalf of users as a sole owner, but one that has a fiduciary role relative to a specified wallet owner, whom the security platforms process represents. Thus, security platforms P may agree to transfers that a wallet owner instructs the wallet to take, provided they are determined to be safe; security platforms may block transactions that can be determined to be unsafe (e.g., correspond to a known scam); and to request additional user authorization for transactions that are neither known to be safe nor unsafe. Different types of user authorizations may depend on different risk scores, user configurations; machine learning processes (e.g., machine learning that has been trained on user preferences), among various other types of authorizations. Security platforms in accordance with many embodiments may be part of a wallet of a user. Security platforms may also represent multiple associated wallets, e.g., all the wallets of a family or an enterprise, and/or control transactions to make sure they are aligned with a policy stated by an admin.

In many embodiments, security platforms may be implemented or realized in various different ways. In certain embodiments, security platforms can be implemented as a functionality of a wallet. In several embodiments, security platforms can be implemented in a browser by means of which a user interacts with his/her wallet and/or a marketplace for trading NFTs. In certain embodiments security platforms can be implemented at a marketplace and where a user may choose to use the security platforms for an intended transaction.

In several embodiments, security platforms may be implemented at a third party wherein a user may choose to make use of the security platforms and optionally paying a fee for using the security platforms when the user wants to sell or buy an NFT. In many embodiments, security platforms may be implemented in a user's PC or laptop e.g., in a similar manner as a firewall or antivirus program. In the certain embodiments where the security platforms is being implemented e.g., at/in a marketplace or a third party, a user may make use of the security platforms by paying a fee. The fee may be per transaction or by means of different subscriptions, where the user may get different amounts of usage for different subscriptions.

A user may select a use for the security platforms for one or more types of transactions, such as (but not limited to) transactions that involve assets with individual value (e.g., value over $250), transactions originated by a particular user, transactions originated from a particular wallet, transactions that are in response to requests from parties that are not whitelisted with the security platforms, and/or with a wallet, any series of transactions that are performed in a rapid sequence, (e.g., at least 5 transactions being initiated within one minute), among others. A wallet may determine whether a given wallet should be routed via security platforms P, or the security platforms may scrutinize all transactions requested and determine which ones it should consider blocking.

Security platforms in accordance with many embodiments of the invention to perform the verification of a transfer of ownership. In many embodiments, one or more processes may perform a verification. For example, security platforms may query a database including examples and/or lists of malicious smart contracts and/or user identities and find out that the imminent transfer is associated with a malicious smart contract and/or a user identity being known for criminal actions. If so, the verification may quickly return a reliable result of the verification, wherein a user may rest assured that they should not go ahead with the transfer of ownership e.g., by means of getting notified about the result of the verification and optionally having to disapprove or stop the transaction.

Security platforms may abort a transaction and optionally inform a first user, (e.g., a seller, among others) about a result of the verification. In another example, the security platforms P may have to perform several verifications in order to ascertain a level of safety or risk associated with the transaction. In some cases a verification may result in very strong certainty of an imminent transfer being benign or malicious. In other cases, a verification may not be able to give a satisfactory indication of a level of safety and/or risk associated with a transaction. For example, a smart contract associated with an NFT may be a new one not being listed in any database and no information can be found on any blockchain. Then a result of a verification may result in “undeterminable”. a verification may result in a “risk level” or a corresponding “safety level”. For example, a verification may give a result on a scale from high risk, medium risk, low risk, undeterminable, and/or no risk; or alternatively safe, relatively safe, undetermined, low risk, medium risk, and/or high risk.

There may also be different levels of malice, and thus security platforms in accordance with several embodiments may also as a result of the verification, provide the user with a malice level, e.g., very malicious, malicious, undeterminable, not malicious, among other. In certain embodiments of the security platforms, a verification process may result in one or more a risk level and a malice level.

In several embodiments, security platforms P may halt a transfer of ownership until a verification process is performed. Then the security platforms P may be implemented with several options. For example, in case the verification provides the result of no risk and/or not malicious, the security platforms P may discontinue the halting of the transfer of ownership and either perform the transfer itself or instruct/inform a marketplace involved in the transfer to go ahead. In another example, the security platforms P may always provide the result of the verification to the first user and wait for the first user to either give his/her consent to continue or to abort the ownership transfer. In still another example, only some levels of risk/safety and/or malice may result in the security platforms P providing the result of the verification to the first user and wait for the first user to either give his/her consent to continue or to abort the ownership transfer.

In several embodiments of the security platforms, an NFT can be associated with a compliance statement, thereby associating a requirement with the NFT. This requirement may be identified in a policy that may be referenced by the NFT, or which may be included in the NFT.

Security platforms in accordance with several embodiments can express a policy by encoding it in contract data of an NFT, encoding requirements in metadata, among others. An example of a requirement is a royalty requirement that indicates that only marketplaces that are in compliance may transfer ownership of the NFT. Another example of a requirement is a ToS requirement that indicates that only marketplaces that are in compliance may transfer ownership of the NFT, and that this may only be performed after such parties have verified that the prior use of the token has respected the terms of service. Yet another example of a requirement is a tax collecting requirement that indicates that only marketplaces that collect and/or report appropriate taxes, such as sales taxes, may transfer the ownership of the NFT after collecting any current and prior taxes due. An example of prior taxes due are taxes, and associated penalties, that were not paid in previous transfers, or for which an incorrect amount was paid. The usage of the certificates may be issued in conjunction with an industry standard, a standards body, or via smart contract. In various embodiments, assertion of the compliance policy may depend upon the jurisdiction of the buyer, seller, and, or marketplace. In certain embodiments, security platforms can be designed to evaluate that such requirements have previously been fulfilled so that an NFT to be purchased is not associated with any deficiencies due to previous nonfulfillment of requirements. An evaluation may be implemented as a separate process and/or as part of a verification process. Security platforms may be employed by either or both of a first user (e.g., seller) and a second user (e.g., buyer) An evaluation of whether or not previous requirements have been fulfilled may be done in a similar manner as the described verifications, e.g., by scanning one or more blockchains, querying one or more databases, among others.

Security platforms in accordance with several embodiments can use public and private keys to facilitate “signed” transfer requests. Security platforms can include a cold wallet that can be associated with a first public key and a first associated private key. The cold wallet may assign to an associated hot wallet the first public key and a second private key, and to the security platforms the first public key and a third private key, so that the second private key combined with the third private key corresponds to the first private key. This may enable the hot wallet to generate a signed transfer request, by signing a message M using the second private key, and to send the associated first digital signature to a security platform, along with M. A security platforms can determine whether a transfer is safe. If it is, security platforms can generate a second digital signature on M, using the third private key, where the first digital signature combined with the second digital signature results in a third digital signature, and where the third digital signature is a digital signature on M, which can be verified using the first public key. If the security platforms P fails to cooperate, the cold wallet can appoint new security platforms and generate two new private key components such that these, when combined, correspond to the first public key. This way, a verifier of a transaction does not need to know that security platforms were involved in the processing of the transfer; security platforms cannot perform the transfer on its own; but also, the hot wallet cannot either. Therefore, if the hot wallet is affected by malware or a scam, then security platforms can block such abuse by identifying the risk and refusing to sign a message. In several embodiments, security platforms may also refuse to sign a message that is not correctly signed using the hot wallet, using the second private key. Thus, security platforms P can determine that the hot wallet is intent on performing a given transaction before determining whether a transaction is safe. In several embodiments, a first digital signature and a second digital signature are not combined to become a third digital signature, but are verified independently of each other.

In several embodiments of the security platforms P, a cold wallet generates a multiplicity of private keys and assigns these to a multiplicity of entities Pi, (e.g., P1, P2, . . . Pn,) where some quorum of these have to collaborate with the hot wallet to generate a valid signature. Methods to do so are well understood in the art of public key cryptography, and may utilize polynomial secret sharing, for example.

Security platforms in accordance with several embodiments can take actions based on consensus mechanisms, and security platforms may be part of a proof of stake blockchain processing unit, where this processing unit both closes ledgers and determines what transfers to approve.

Security platforms in accordance with several embodiments can implement an escrow authority, as disclosed in U.S. Provisional Patent Application Ser. No. 63/366,391 filed Jun. 14, 2022 entitled “Reversal of Blockchain Transactions” by Keir Finlow-Bates, Markus Jakobsson, Stephen C. Gerber and Stefan Dufva, which is herein incorporated by reference in its entirety.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A method for bridging between blockchains, comprising:
bridging at least one entry from a plurality of entries from a first blockchain to a second blockchain, wherein the at least one entry is associated with an event;
determining a classification of the at least one entry, wherein the classification comprises at least one of confirmed, delayed, and blocked; and
performing an action based on the classification of the entry;
wherein the action comprises at least one action selected from a group comprising:
determining the classification is confirmed and recording (130) on the second blockchain the at least one entry and removing the at least one entry from the plurality of entries, determining the classification is blocked and removing the at least one entry from the plurality of entries, and determining the classification is delayed and keeping the at least one entry for an additional time period.

2. The method of claim 1, further comprising determining the classification indicates that the at least one entry is blocked and setting a flag associated with the entry to a value representing that the at least one entry is blocked.

3. The method of claim 1, further comprising determining the classification indicates that the at least one entry is blocked and logging data related to a reason for determining the classification of the at least one entry is blocked.

4. The method of claim 1, further comprising determining the classification indicates that the at least one entry is delayed and transferring the at least one entry to a third blockchain, the third blockchain being of a same level as the first blockchain.

5. The method of claim 1, further comprising determining the classification indicates that the at least one entry is delayed and identifying the at least one entry and an entry that is to remain on the first blockchain and to be bridged to the second blockchain at a later point in time.

6. The method of claim 1, wherein the determining of the classification is based information received from the second blockchain.

7. The method of claim 1, further comprising determining the classification indicates that the at least one entry is confirmed after a predetermined amount of time has elapsed since the entry was recorded on the first blockchain.

8. The method of claim 1, further comprising obtaining a vote between a plurality of entities regarding the classification of the at least one entry.

9. The method of claim 1, wherein the second block chain has a different security protections that provide greater security than the first block chain.

10. The method of claim 1, wherein the action comprises determining the classification is delayed and re-recording the at least one entry on the first block chain with a time stamp associated with an original time that the at least one entry was record on the first blockchain.

11. The method of claim 1, wherein the action comprises determining the classification is delayed and recording the at least one entry on a new third block chain.

12. The method of claim 1, further comprising setting, for each entry of the plurality of entries of the first blockchain, a flag to generate a flag array that determines entries that are bridged on the first blockchain and entries that are bridged on the second blockchain.

13. The method claim 1, further comprising concatenating the plurality of entries together;
appending the flag array to the concatenated plurality of entries to generate a string;
hashing the string; and
recording the hash on the second blockchain.

14. A security platform, comprising:
a network interface;
memory; and
a processor, the processor configured to:
bridge at least one entry from a plurality of entries from a first blockchain to a second blockchain, wherein the at least one entry is associated with an event;
determine a classification of the at least one entry, wherein the classification comprises at least one of confirmed, delayed, and blocked; and
perform an action based on the classification of the entry;
where the action comprises at least one action selected from a group comprising:
determining the classification is confirmed and recording (130) on the second blockchain the at least one entry and removing the at least one entry from the plurality of entries, determining the classification is blocked and removing the at least one entry from the plurality of entries, and determining the classification is delayed and keeping the at least one entry for an additional time period.

15. The security platform of claim 14, wherein the process is further configured to determine the classification indicates that the at least one entry is blocked and set a flag associated with the entry to a value representing that the at least one entry is blocked.

16. The security platform of claim 14, wherein the process is further configured determine the classification indicates that the at least one entry is blocked and log data related to a reason for determining the classification of the at least one entry is blocked.

17. The security platform of claim 14, wherein the process is further configured comprising determine the classification indicates that the at least one entry is delayed and transfer the at least one entry to a third blockchain, the third blockchain being of a same level as the first blockchain.

18. The security platform of claim 14, wherein the process is further configured to determine the classification indicates that the at least one entry is delayed and identify the at least one entry and an entry that is to remain on the first blockchain and to be bridged to the second blockchain at a later point in time.

19. The security platform of claim 14, wherein the process is further configured to determine the classification based on information received from the second blockchain.

20. The security platform of claim 14, wherein the process is further configured to determine the classification indicates that the at least one entry is confirmed after a predetermined amount of time has elapsed since the entry was recorded on the first blockchain.
